(19) United States
(12) Patent Application Publication
(10) Pub. No.: US 2026/0070342 A1
(43) Pub. Date: Mar. 12, 2026

(54) PRINTING APPARATUS

(71) Applicant: CANON KABUSHIKI KAISHA, Tokyo (JP)

(72) Inventors: YURI MORI, Tokyo (JP); NORIKO SATO, Kanagawa (JP); SHOTA ASADA, Tokyo (JP); MINEYOSHI TOMIE, Saitama (JP); TETSUYO OHASHI, Kanagawa (JP)

(21) Appl. No.: 19/324,323

(22) Filed: Sep. 10, 2025

(30) Foreign Application Priority Data
Sep. 11, 2024 (JP) 2024-157736
Jun. 19, 2025 (JP) 2025-104036

(51) Int. Cl. B41J 2/175; B41J 29/00

(52) U.S. Cl. CPC B41J 2/17523; B41J 2/17526; B41J 2/17553; B41J 29/00

(57) ABSTRACT

A printing apparatus includes first and second storage portions configured to store first and second containers that store a liquid to be supplied to a printhead that discharges the liquid to a print medium, a first intermediate tank configured to, between the printhead and the first container, store the liquid to be supplied from the first container to the printhead, and a second intermediate tank configured to, between the printhead and the second container, store the liquid to be supplied from the second container to the printhead The first and second storage portions are arranged in a height direction of the printing apparatus. The first and second intermediate tanks are arranged in a first direction crossing the height direction. The first and second storage portions, and the first and second intermediate tanks arranged in a second direction crossing the height direction and the first direction.

### BACKGROUND

### Field of the Technology

The present disclosure relates to a printing apparatus.

### Description of the Related Art

A printing apparatus that performs printing by discharging a liquid to a print medium uses a plurality of types of liquids in some cases. In this case, a container is provided in the printing apparatus for each liquid type. As an example of the layout of the plurality of containers, arranging these in the widthwise direction of the printing apparatus has been proposed (for example, Japanese Patent Laid-Open No. 2018-65374).

In the printing apparatus, an intermediate tank is sometimes provided between a printhead and a container to adjust a liquid supply pressure to the printhead or stabilize the amount. It is advantageous in terms of the number of sheets to be printed or the print time if the capacity of the container or the intermediate tank is large. However, the increase of the capacity may lead to a bulky apparatus, and it is desirable to efficiently use the space in the apparatus.

### SUMMARY

The present disclosure provides a technique for efficiently using a space in an apparatus and contributing to an increase in the capacity of a container or an intermediate tank.

According to an aspect of the present disclosure, there is provided a printing apparatus comprising: a first storage portion configured to store a first container that stores a liquid to be supplied to a printhead that discharges the liquid to a print medium; a second storage portion configured to store a second container that stores a liquid to be supplied to the printhead; a first intermediate tank configured to, between the printhead and the first container, store the liquid to be supplied from the first container to the printhead; and a second intermediate tank configured to, between the printhead and the second container, store the liquid to be supplied from the second container to the printhead, wherein the first storage portion and the second storage portion are arranged in a height direction of the printing apparatus, the first intermediate tank and the second intermediate tank are arranged in a first direction crossing the height direction, and the first storage portion and the second storage portion, and the first intermediate tank and the second intermediate tank are arranged in a second direction crossing the height direction and the first direction.

Features of the present disclosure will become apparent from the following description of embodiments with reference to the attached drawings. The following description of embodiments are described by way of example.

### BRIEF DESCRIPTION OF THE DRAWINGS

FIG. 1 is a view showing the outer appearance of a printing apparatus according to an embodiment;

FIG. 2 is a schematic view of the internal structure of the printing apparatus shown in FIG. 1;

FIG. 3 is a view showing an exchange mode of a container;

FIG. 4 is a perspective view of a printing unit and an ink supplying system;

FIG. 5 is a perspective view of a storage unit and a replenishing unit;

FIG. 6A is a front view of the storage unit in a mode in which containers and trays are not stored;

FIG. 6B is a front view of the storage unit in a mode in which containers and trays are stored;

FIG. 7 is a plan view of the storage unit and the replenishing unit;

FIG. 8 is a sectional view taken along a line A-A in FIG. 7;

FIG. 9 is a sectional view taken along a line B-B in FIG. 7;

FIG. 10 is a sectional view taken along a line C-C in FIG. 7;

FIGS. 11A and 11B are views showing an example of assembling of the storage unit;

FIGS. 12A and 12B are views showing an example of assembling of the storage unit;

FIG. 13 is a sectional view of the vicinity of a partition wall;

FIG. 14 is an explanatory view of a supplying unit for a liquid from the container to a printhead;

FIG. 15 is an explanatory view showing the structure of an intermediate tank;

FIG. 16 is a view for explaining the operation of the intermediate tank;

FIG. 17 is a view for explaining the operation of the intermediate tank;

FIG. 18 is a view for explaining the structure and operation of a negative pressure maintaining unit;

FIG. 19 is an explanatory view of a pressure adjusting unit;

FIG. 20 is a view for explaining the operation of each control valve of the pressure adjusting unit;

FIG. 21A is a sectional view showing an example in which a bottle-type container is attached to a storage portion;

FIG. 21B is a view showing another example of the configuration of an opening/closing member;

FIG. 22 is a view showing the outer appearance of a printing apparatus according to another embodiment;

FIG. 23 is a view showing the outer appearance of the printing apparatus shown in FIG. 22 to which a plurality of optional devices are attached;

FIG. 24 is a view showing a mode in which a storage cassette is detached in the printing apparatus shown in FIG. 22;

FIG. 25 is a view showing a mode in which a detachable unit is detached in the printing apparatus shown in FIG. 22;

FIG. 26 is a view showing a mode in which an opening/closing member is in an open state in the printing apparatus shown in FIG. 22;

FIG. 27 is a view showing a mode in which the opening/closing member is in an open state in the printing apparatus shown in FIG. 22;

FIG. 28 is a schematic view of the internal structures of the printing apparatus and the optional devices shown in FIG. 23;

FIG. 29 is a perspective view of a printing unit;

FIG. 30 is a sectional view taken along a line D-D in FIG. 29;

FIG. 31 is a view showing a state in which a cover and a feeding tray are extracted in the printing apparatus shown in FIG. 23;

FIG. 32 is a schematic view of the internal structure of the printing apparatus shown in FIG. 31;

FIG. 33 is a view showing the outer appearance of a printing apparatus 1A shown in FIG. 23 in which the opening/closing member is in the open state;

FIG. 34 is a plan view of the printing apparatus 1A shown in FIG. 23 in which the opening/closing member is in the open state;

FIG. 35 is a perspective view of a container;

FIG. 36 shows a sectional view taken along a line E-E in FIG. 7 and a partially enlarged view;

FIG. 37 shows a sectional view taken along a line F-F in FIG. 7 and a partially enlarged view;

FIG. 38 shows a sectional view taken along a line G-G in FIG. 7 and a partially enlarged view;

FIG. 39 is a perspective view showing the schematic configuration of a container according to another embodiment;

FIG. 40 is a sectional view of the container shown in FIG. 39;

FIG. 41 is an exploded perspective view of the container shown in FIG. 39;

FIG. 42 is a perspective view showing a halfway state in which the container in FIG. 39 is being attached to the storage portion;

FIG. 43 is a perspective view showing a state in which the container in FIG. 39 is attached to the storage portion;

FIGS. 44A to 44E are perspective views showing the operation of an opening/closing door when attaching the container to the storage portion;

FIGS. 45A to 45E are side views showing the operation of the opening/closing door when attaching the container to the storage portion;

FIG. 46 is a perspective view showing the schematic configuration of a container according to another embodiment;

FIG. 47 is a sectional view of the container in FIG. 46;

FIGS. 48A to 48C are sectional views of the container in FIG. 46;

FIG. 49 is an exploded perspective view of the container in FIG. 46;

FIG. 50 is a perspective view showing a state before the container is attached to the storage portion;

FIG. 51 is a perspective view showing a halfway state in which the container is being attached to the storage portion;

FIG. 52 is a perspective view showing a state in which the container is attached to the storage portion;

FIGS. 53A and 53B are perspective views showing the operation of the opening/closing door when attaching the container to the storage portion;

FIGS. 54A to 54C are perspective views showing the operation of the opening/closing door when attaching the container to the storage portion; and

FIGS. 55A to 55E are side views showing the operation of the opening/closing door when attaching the container to the storage portion.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### <Outline of Printing Apparatus>

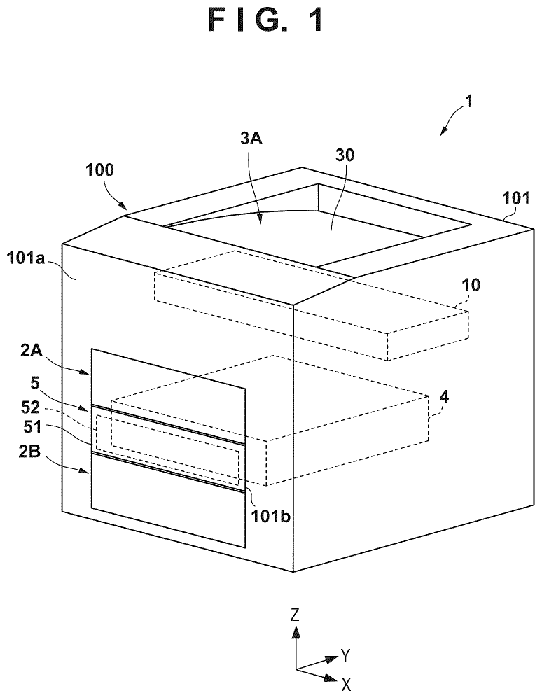

FIG. 1 is a view showing the outer appearance of a printing apparatus 1 according to an embodiment of the present disclosure. The printing apparatus according to this embodiment is an inkjet printing apparatus that discharges liquid ink to a print medium, thereby performing printing.

Note that “print” includes not only forming significant information such as characters and graphics but also forming images, figures, patterns, and the like on print media in a broad sense, or processing media, regardless of whether the information is significant or insignificant or whether the information is visualized so that a human can visually perceive it. In addition, although in this embodiment, sheet-like paper is assumed as a “print medium”, cloth, a plastic film, and the like may also be used.

In the drawings, arrows X, Y, and Z indicate directions crossing each other. The arrows X and Y indicate horizontal directions that are orthogonal to each other, and the arrow Z indicates the up/down direction. The X direction corresponds to the left/right direction (the lateral direction or the widthwise direction) of the printing apparatus 1, and the Y direction corresponds to the front/rear direction (the depth direction) of the printing apparatus 1. The Z direction corresponds to the height direction (up/down direction) of the printing apparatus 1. Also, the downstream side and the upstream side are defined based on the conveyance direction of a print medium as a reference.

The printing apparatus 1 includes a main body 100, and storage cassettes 2A and 2B detachably attached to the main body 100. The main body 100 includes a housing 101 having a substantially rectangular parallelepiped shape, and the housing 101 forms the outer wall of the printing apparatus 1. Slots that allow the storage cassettes 2A and 2B storing print media to be detachably attached to the main body 100 are formed in a front surface 101a of the housing 101, which forms the front portion of the printing apparatus 1. The storage cassettes 2A and 2B are inserted/removed in the Y direction.

In the main body 100, a storage unit 4 (storage portions) is provided between the storage cassette 2A and the storage cassette 2B in the Z direction. The storage unit 4 forms a space to store a container that stores a liquid. An opening/closing member 5 that allows a user to access the storage unit 4 is provided on the front surface 101a of the housing 101.

A stacking portion 3A on which print media printed by a printing unit 10 in the main body 100 are stacked is provided on the upper surface of the main body 100. The stacking portion 3A includes a tray 30. A printed print medium is stacked on the tray 30.

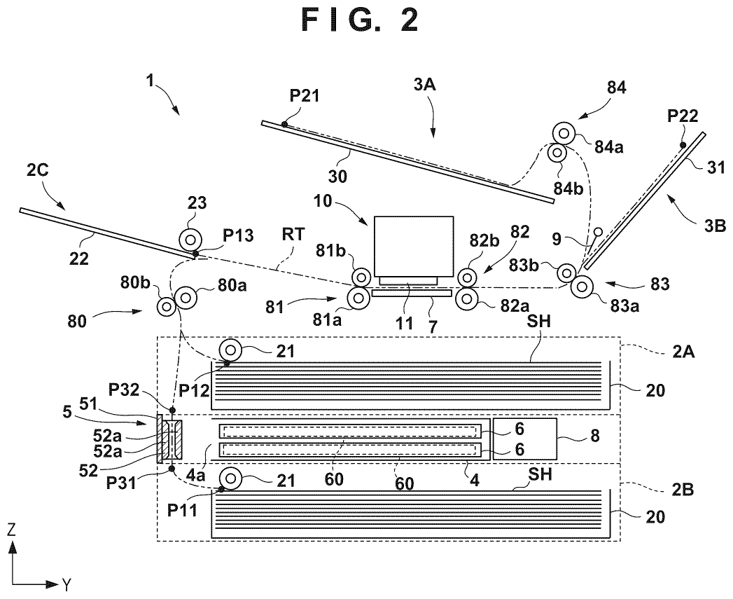

FIG. 2 will be referred to in addition to FIG. 1. FIG. 2 is a schematic view of the internal structure of the printing apparatus 1. The printing apparatus 1 performs printing by the printing unit 10 on sheets SH that are print media before printing stacked on stacking portions 20 of the storage cassettes 2A and 2B. The stacking portions 20 are trays on which many sheets SH are stacked.

In this embodiment, the sheet SH before printing can be stacked on a stacking portion 2C as well. The stacking portion 2C includes a folding-type tray 22. FIG. 1 shows a mode in which the tray 22 is stored, and FIG. 2 shows a mode in which the tray 22 is extended. The tray 22 is used when, for example, a user manually supplies the sheet SH to the printing unit 10.

Also, in this embodiment, the printed sheet SH can be stacked on a stacking portion 3B as well. The stacking portion 3B includes a folding-type tray 31. FIG. 2 shows a mode in which the tray 31 is extended. The printing apparatus 1 discharges the printed sheet SH to the tray 30 or the tray 31.

In the main body 100, a conveyance path RT that guides conveyance of the sheet SH is formed. The conveyance path RT is a path that guides the sheet SH from the stacking portions 20 of the storage cassettes 2A and 2B or the stacking portion 2C to the tray 30 or the tray 31 via the printing unit 10. The conveyance path RT includes three start points P11 to P13 and two end points P21 and P22. In this embodiment, the conveyance path RT extends substantially horizontally on the front and rear sides of the printing unit 10 so as to divide the printing apparatus 1 into upper and lower sections. The conveyance path RT extends in a substantially S shape as a whole so as to cover the portion on the front side of the printing unit 10 and the portion on the rear side of the printing unit 10.

Sorting of the printed sheet SH to the stacking portion 3A or 3B can be performed by a flapper 9 arranged at the branch point of the conveyance path RT. The flapper 9 switches the conveyance destination of the sheet SH that has passed through the printing unit 10 to the stacking portion 3A or 3B. The flapper 9 is rotatably provided and rotated by an actuator such as an electromagnetic solenoid, thereby switching the path.

Note that the conveyance path RT is formed by a path forming member. As an example of the path forming member, FIG. 2 shows a path forming portion 52 provided on the opening/closing member 5. The path forming portion 52 includes path forming members 52a on the front and rear sides, which are apart in the Y direction. The path forming portion 52 forms a partial section on the halfway of the conveyance path RT. More specifically, the path forming portion 52 forms a section extending the Z direction between an intermediate point P31 and an intermediate point P32. The conveyance path RT is defined by such path forming members.

A conveyance mechanism that conveys the sheet SH along the conveyance path RT will be described. The storage cassettes 2A and 2B each include a feeding unit (pickup roller) 21. The sheet SH on the stacking portion 20 is introduced into the conveyance path RT by the feeding unit 21. The feeding unit 21 rotates in a state in which it is in contact with the uppermost surface of the sheets SH stacked on the stacking portion 20 and thus starts feeding the sheet SH. The sheet SH is conveyed to a feeding unit 80.

In this embodiment, the storage unit 4 is arranged between the stacking portions 20 of the storage cassettes 2A and 2B in the Z direction, and the stacking portion 20 of the storage cassette 2A is arranged between the printing unit 10 and the storage unit 4. The stacking portion 20 of the storage cassette 2B is not arranged between the printing unit 10 and the storage unit 4 in the Z direction. The sheet SH conveyed from the stacking portion 20 of the storage cassette 2B passes through the path forming portion 52, but the sheet SH conveyed from the stacking portion 20 of the storage cassette 2A does not pass through the path forming portion 52. Note that the stacking portions 20 of a plurality of storage cassettes 2A may be arranged between the printing unit 10 and the storage unit 4 in the Z direction.

The sheet on the stacking portion 2C is introduced into the conveyance path RT by a feeding unit (pickup roller) 23. The feeding unit 23 rotates in a state in which it is in contact with the sheet SH on the uppermost surface stacked on the stacking portion 2C and thus starts feeding the sheet SH. The sheet SH is conveyed to a conveyance unit 81.

The conveyance mechanism of the sheet SH further includes the feeding unit 80 and a plurality of conveyance units 81 to 84. In the conveyance direction of the sheet SH through the conveyance path RT, the feeding unit 80, the conveyance unit 81, the conveyance unit 82, the conveyance unit 83, and the conveyance unit 84 are arranged in this order from the upstream side to the downstream side. Note that in the following explanation, the leading edge and the trailing edge of the sheet SH mean the downstream end and the upstream end of the sheet SH, unless specified otherwise.

The feeding unit 80 conveys the sheet SH introduced into the conveyance path RT by the feeding unit 21 to the conveyance unit 81. The feeding unit 80 includes a feeding roller 80a and a driven roller 80b that is in pressure contact with the feeding roller 80a. The feeding roller 80a is a driving roller, and the driven roller 80b rotates following the rotation of the feeding roller 80a.

The sheet SH is clamped in the nip portion between the feeding roller 80a and the driven roller 80b, and conveyed by the rotation of the feeding roller 80a and the driven roller 80b. Note that the feeding unit 21 is a one-way roller, and after the sheet SH is conveyed to a position beyond the nip portion of the feeding unit 80, the conveyance can be continued by the feeding unit 80 even if the driving of the feeding unit 21 is stopped.

The conveyance unit 81 is arranged on the upstream side in the conveyance direction with respect to the printhead 11 provided in the printing unit 10, and the sheet SH is conveyed by the conveyance unit 81 to the downstream side between the printhead 11 and the platen 7 facing the printhead 11. The conveyance unit 81 includes a conveyance roller 81a and a driven roller (pinch roller) 81b that is brought into pressure contact with the conveyance roller 81a by a spring (not shown) or the like. The conveyance roller 81a is a driving roller, and the driven roller 81b rotates following the rotation of the conveyance roller 81a. The sheet SH is clamped in the nip portion between the conveyance roller 81a and the driven roller 81b, and conveyed by the rotation of the conveyance roller 81a and the driven roller 81b.

The conveyance unit 82 is arranged on the downstream side in the conveyance direction with respect to the printhead 11, and conveys the sheet SH conveyed by the conveyance unit 81 to the conveyance unit 83 on the downstream side. The conveyance unit 82 includes a conveyance roller 82a and a spur 82b that is brought into pressure contact with the conveyance roller 82a by a spring (not shown) or the like. The conveyance roller 82a is a driving roller, and the spur 82b rotates following the rotation of the conveyance roller 82a.

The conveyance unit 83 is a discharging unit that is arranged on the downstream side in the conveyance direction with respect to the printhead 11 and the conveyance unit 82 and discharges the sheet SH conveyed by the conveyance unit 82 to the tray 31 of the stacking portion 3B or the conveyance unit 84 in accordance with the position of the flapper 9. The conveyance unit 83 includes a conveyance roller 83a and a driven roller 83b that is brought into pressure contact with the conveyance roller 83a by a spring (not shown) or the like. The conveyance roller 83a is a driving roller, and the driven roller 83b rotates following the rotation of the conveyance roller 83a. The sheet SH is clamped in the nip portion between the conveyance roller 83a and the driven roller 83b, and conveyed by the rotation of the conveyance roller 83a and the driven roller 83b.

The conveyance unit 84 is a discharging unit that is arranged on the downstream side in the conveyance direction with respect to the conveyance unit 83 and discharges the sheet SH conveyed by the conveyance unit 83 to the tray 30 of the stacking portion 3A. The sheet SH discharged to the tray 30 is “face-down discharge” in which an image printed surface faces down. The conveyance unit 84 includes a conveyance roller 84a and a driven roller 84b that is brought into pressure contact with the conveyance roller 84a by a spring (not shown) or the like. The conveyance roller 84a is a driving roller, and the driven roller 84b rotates following the rotation of the conveyance roller 84a. The sheet SH is clamped in the nip portion between the conveyance roller 84a and the driven roller 84b, and conveyed by the rotation of the conveyance roller 84a and the driven roller 84b.

The printing unit 10 discharges ink to the sheet SH, thereby printing an image. The lower surface of the printhead 11 forms a discharge surface in which a plurality of nozzles for discharging ink are formed.

The ink to be supplied to the printhead 11 is stored in a container 60. The ink stored in the container 60 is supplied to the printhead 11 via a replenishing unit 8. The container 60 is a bag-shaped container formed by a flexible material and is supported by a tray 6 and stored in the storage unit 4. A plurality of sets of containers 60 and trays 6 are stored in the storage unit 4. The storage unit 4 has an inlet 4a on the front side of the printing apparatus 1, and the tray 6 with the container 60 mounted thereon can be inserted/removed from the inlet 4a in the Y direction. If the ink stored in the container 60 is consumed, the user can replenish the ink by exchanging the container 60 with a new one. In this case, the user needs to access the storage unit 4 (in other words, access the container 60).

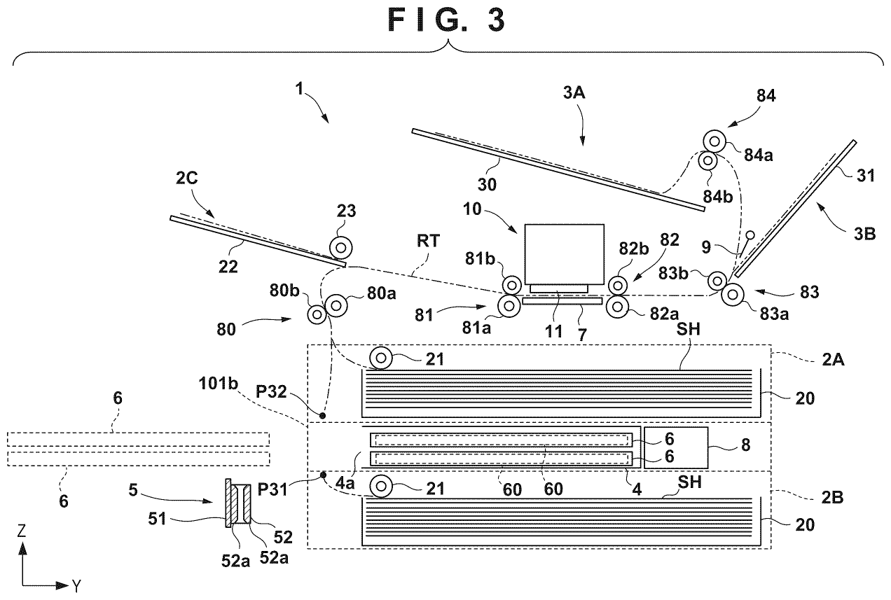

The opening/closing member 5 is a member that opens/closes an access path that enables access to the storage unit 4. FIG. 2 shows a case where the opening/closing member 5 is in a closed state, and FIG. 3 shows a case where the opening/closing member 5 is in an open state. In this embodiment, the opening/closing member 5 is detachably attached to the main body 100, and in attachment, positioned and locked to the main body 100 by an appropriate method. On the front surface 101a, an opening portion 101b is formed in the housing 101. As shown in FIG. 3, when the opening/closing member 5 is detached from the main body 100, the opening portion 101b is opened, and the access path is opened. The access path according to this embodiment is a space extending from the inlet 4a of the storage unit 4 to the front side of the printing apparatus 1 in the Y direction. In the open state of the access path shown in FIG. 3, the inlet 4a is exposed to the outside of the printing apparatus 1, and the user can access from the outside of the printing apparatus 1 to the storage unit 4. The user can extract the container 60 together with the tray 6 and exchange the container 60.

The opening/closing member 5 includes a panel portion 51 and the path forming portion 52. The panel portion 51 closes the opening portion 101b when closing the access path, and forms the outer wall, particularly, the front surface 101a of the printing apparatus 1 together with the housing 101. The path forming portion 52 is fixed to the back surface of the panel portion 51 and forms a partial section of the conveyance path RT extending in the Z direction between the intermediate point P31 and the intermediate point P32, as described above. The access path is a path traversing between the intermediate point P31 and the intermediate point P32 in the Y direction, and the section of the conveyance path RT between the intermediate point P31 and the intermediate point P32 crosses the access path.

As described above, in this embodiment, since the opening/closing member 5 forms a partial section of the conveyance path RT, a layout in which the access path crosses the partial section of the conveyance path RT can be employed. As compared to a layout in which the access path avoids the conveyance path RT, the degree of freedom of arrangement of the storage unit 4 can be improved. Particularly in recent years, there is a demand for a printing apparatus including a plurality of feeding units/discharging units capable of feeding/discharging enormous quantities of various print media, and the space occupied by the conveyance path of the print media in the printing apparatus is increasing. To increase the capacity of printing material storage portion in such a printing apparatus, the apparatus size may be large. According to this embodiment, it is possible to make the space for the storage unit 4 large while suppressing an increase of the apparatus size and also increase the capacity of the container 60.

Also, in this embodiment, the attaching/detaching operation of the storage cassettes 2A and 2B or the exchange operation of the container 60 can be performed from the side of the front surface 101a of the printing apparatus 1. It is possible to provide the printing apparatus 1 with excellent operability, for which a user operation is performed from one direction.

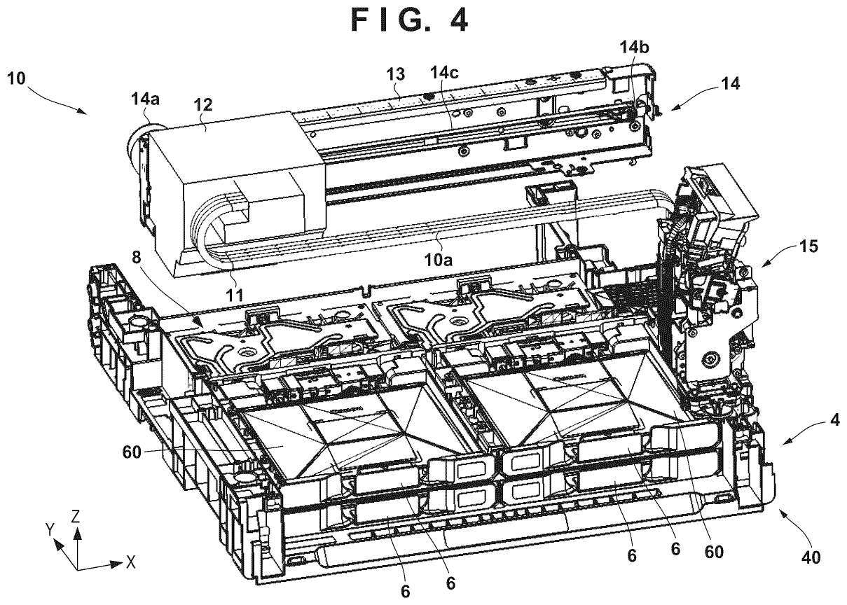

The configuration of the printing unit 10 and the outline of an ink supplying system will be described next with reference to FIG. 4. FIG. 4 is a perspective view of the printing unit 10 and the ink supplying system, in which some components (an upper wall portion 45 to be described later) of the storage unit 4 are not illustrated. First, the configuration of the printing unit 10 will be described.

The printing unit 10 includes the printhead 11, a carriage 12, and a driving unit 14. The printhead 11 is mounted on the carriage 12. The driving unit 14 includes a support member 13 extended in the X direction. The support member 13 is a base member that supports the carriage 12 such that it can move in the X direction, and supports the components of the driving unit 14.

The driving unit 14 is a belt transmission mechanism using a carriage motor 14a as a driving source. The carriage motor 14a is arranged on the opposite side of the carriage 12 in the front/rear (Y) direction across the support member 13. The driving unit 14 includes a driving pulley (located behind the carriage 12) and a driven pulley 14b, which are apart in the X direction, and an endless belt 14c wound around these pulleys.

The carriage 12 is fixed to the endless belt 14c. When the carriage motor 14a rotates the driving pulley, the endless belt 14c travels, and the carriage 12 moves.

An image printing operation will be described next. In the process of reciprocal movement of the carriage 12 in the X-axis direction, ink is discharged from the printhead 11 to the sheet SH, thereby printing an image. This operation is called print scanning. The printing operation is performed by alternately repeating a conveyance operation of intermittently conveying the sheet SH in the +Y direction and print scanning.

The ink is supplied from the container 60 to the printhead 11 via the replenishing unit 8 and a pipe 10a. A pressure adjusting unit 15 controls the operation of each intermediate tank (to be described later) provided in the replenishing unit 8.

### <Configurations of Storage Unit and Replenishing Unit>

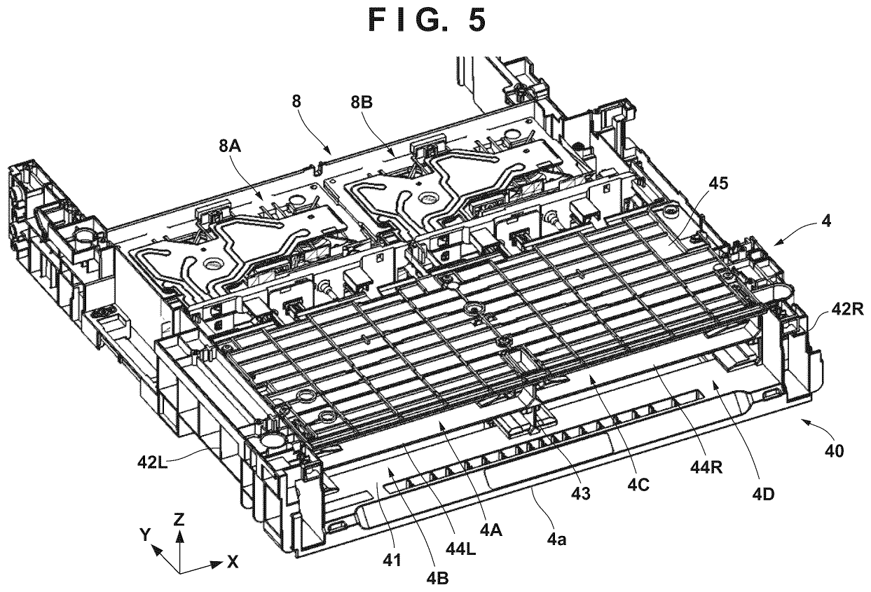

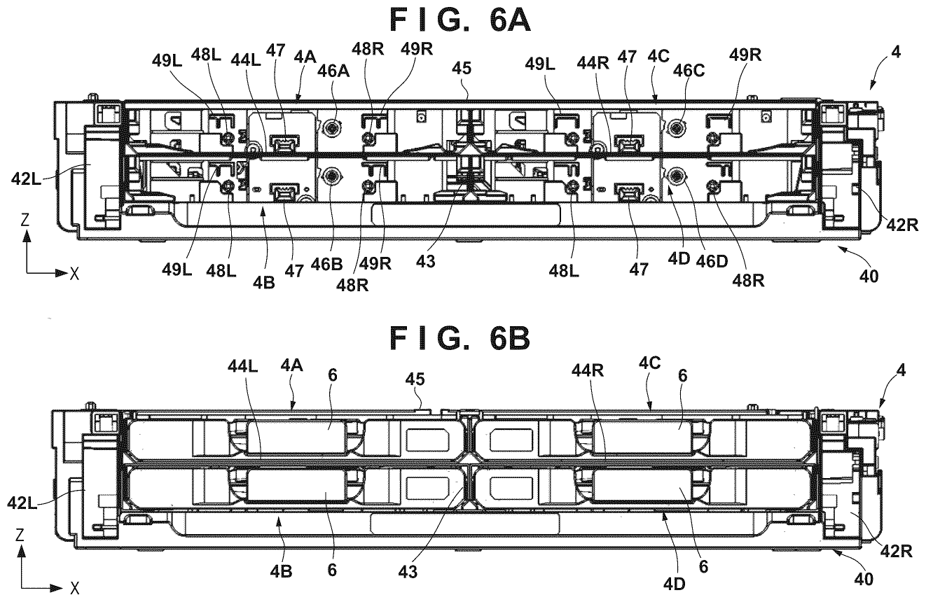

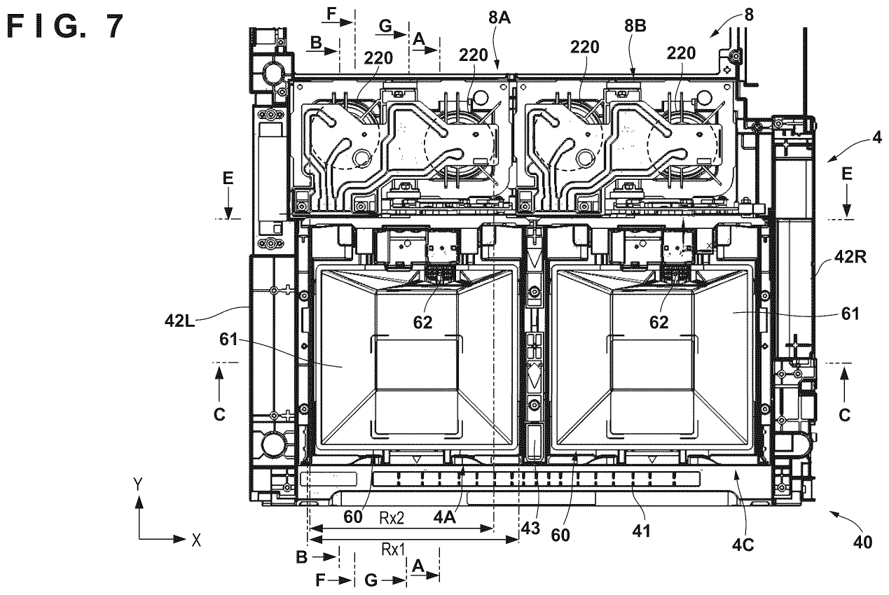

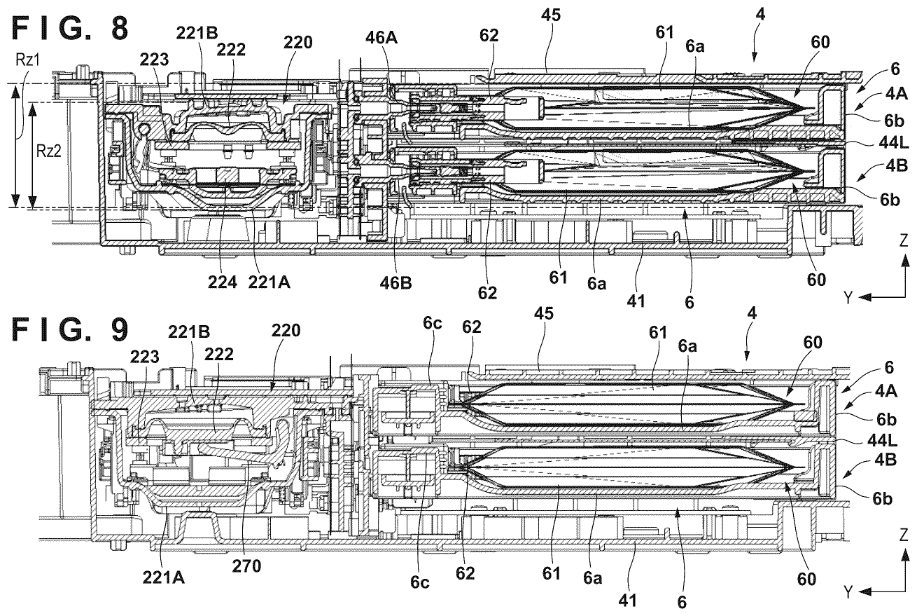

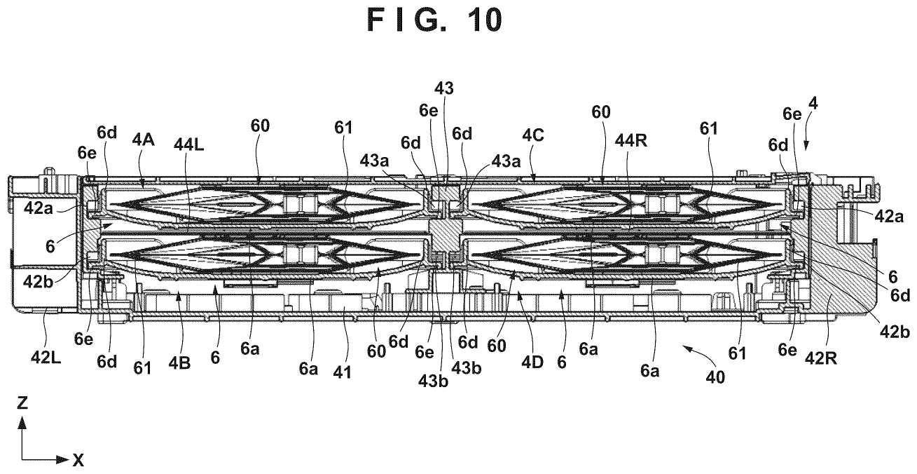

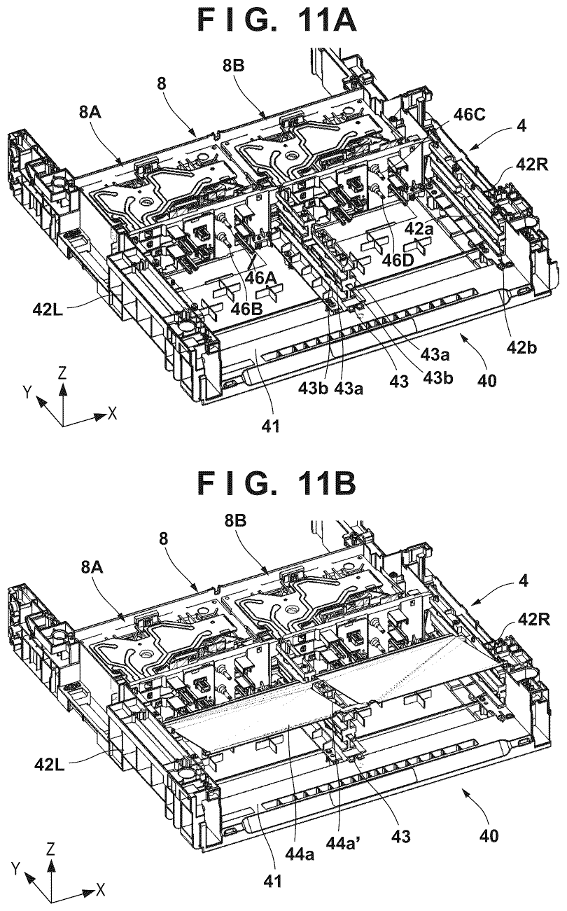

The configurations of the storage unit 4 and the replenishing unit 8 will be described with reference to FIGS. 5 to 10 in addition to FIG. 4. FIG. 5 is a perspective view of the storage unit 4 and the replenishing unit 8 and shows a mode in which the containers 60 and the trays 6 are not stored. FIGS. 6A and 6B are front views of the storage unit 4. FIG. 6A shows a mode in which the containers 60 and the trays 6 are not stored, and FIG. 6B shows a mode in which the containers 60 and the trays 6 are stored. FIG. 7 is a plan view of the storage unit 4 and the replenishing unit 8, in which the upper wall portion 45 is not illustrated. FIGS. 8 to 10 are a sectional view taken along a line A-A in FIG. 7, a sectional view taken along a line B-B, and a sectional view taken along a line C-C, respectively.

The storage unit 4 is a hollow member having a flat rectangular tubular shape including a bottom wall portion 41, left and right side wall portions 42L and 42R, and the upper wall portion 45. The storage unit 4 includes a partition wall 43 that divides the internal space into two parts in the X direction, and partition walls 44L and 44R that divide the internal space into two parts in the Z direction. With these partition walls, the internal space of the storage unit 4 includes four storage portions 4A to 4D. Each of the storage portions 4A to 4D may be referred as storage portion 4. One set of a container 60 and a tray 6 is stored in each storage portion. Hence, in this embodiment, the storage unit 4 can store four sets of container 60 and trays 6.

The four storage portions 4A to 4D are arranged in two stages in the vertical direction and two columns in the left/right direction. Each of the storage portions 4A to 4D is a space having a flat rectangular parallelepiped shape whose lengths in the X and Y directions are longer than the length in the Z direction. Note that in this embodiment, in each of the storage portions 4A to 4D, the length in the X direction is longer than the length in the Y direction.

The two storage portions 4A and 4B are located on the left side in the X direction, and the storage portion 4A and the storage portion 4B are arranged adjacent in the Z direction with the storage portion 4A located on the upper side. The two storage portions 4C and 4D are located on the right side in the X direction, and the storage portion 4C and the storage portion 4D are arranged adjacent in the Z direction with the storage portion 4C located on the upper side. The storage portion 4A and the storage portion 4C are arranged adjacent in the X direction, and the storage portion 4B and the storage portion 4D are arranged adjacent in the X direction.

A connecting portion 46A is provided at an end portion of the storage portion 4A on the far side. The connecting portion 46A is inserted into the container 60 to form a channel that flows ink from the container 60 to the replenishing unit 8. Similarly, the storage portions 4B to 4D are provided with connecting portions 46B to 46D, respectively. When referring to the connecting portions 46A to 46D collectively or to any one of these, it will simply be referred to as a connecting portion 46.

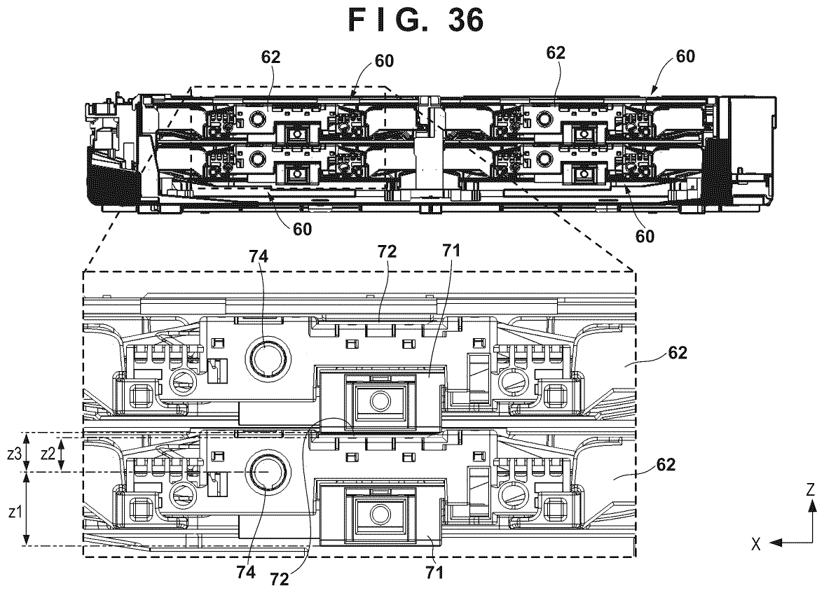

In addition, an electrical connecting portion 47 on the apparatus side is provided at the end portion of each of the storage portions 4A to 4D on the far side. The electrical connecting portion 47 is a connector electrically connected to the container 60. The electrical connecting portion 47 includes a plurality of terminal portions. Each terminal portion projects from the surface of the electrical connecting portion 47, comes into contact with a container-side electrical connecting portion 73 (FIG. 35) of the container 60, and is electrically connected to it. When the electrical connecting portion 47 and the electrical connecting portion 73 are electrically connected, the apparatus side can acquire information about the liquid stored in the container 60. The information about the liquid is, for example, the color and type of ink and its storage amount in the container 60.

Also, positioning portions 48L and 48R are provided at the end portion of each of the storage portions 4A to 4D on the far side. The positioning portions 48L and 48R are shaft-like members that are arranged apart in the X direction and extend in the Y direction. The positioning portions 48L and 48R define the arrangement position of the container 60 in the X direction and the arrangement angle with respect to the horizontal direction.

Fitting portions 49L and 49R are provided at the end portion of each of the storage portions 4A to 4D on the far side. The fitting portion 49L is located above the positioning portion 48L, and the fitting portion 49R is located above the positioning portion 48R. The fitting portions 49L and 49R are arranged apart in the X direction and each have a concave-convex structure. The concave-convex structure has a plurality of projecting portions parallelly arrayed in the Y direction and having a substantially rectangular shape. The array pattern of the projecting portions in the concave-convex structure changes between the storage portions 4A to 4D. The container 60 corresponding to each of the storage portions 4A to 4D is provided with receiving portions (or fitting portions) 76L and 76R (FIG. 35) having a concave-convex structure that corresponds to the array pattern of the concave-convex structure and can be fitted in the concave-convex structure. This suppresses connecting a wrong noncorresponding container 60 to the connecting portion 46.

The replenishing unit 8 is formed by arranging two intermediate tank units 8A and 8B having identical configurations in the X direction. The intermediate tank units 8A and 8B each include intermediate tanks 220 arranged adjacent in the X direction. That is, the replenishing unit 8 includes four intermediate tanks 220 arranged in line in the X direction. The four storage portions 4A to 4D and the four intermediate tanks 220 are arranged adjacent in the Y direction, and the storage portions 4A to 4D are arranged on the front side of the printing apparatus 1.

Each intermediate tank 220 stores, between the printhead 11 and the container 60, the liquid to be supplied from the container 60 to the printhead 11. If the ink is temporarily stored in the intermediate tank 220, the ink can more stably be supplied to the printhead 11, and the ink can be supplied to the printhead 11 even at the time of exchange of the container 60. That is, the container 60 can be exchanged during the printing operation by the printhead 11.

Of the two intermediate tanks 220 of the intermediate tank unit 8A, one corresponds to the container 60 stored in the storage portion 4A, and the other corresponds to the container 60 stored in the storage portion 4B. Similarly, of the two intermediate tanks 220 of the intermediate tank unit 8B, one corresponds to the container 60 stored in the storage portion 4C, and the other corresponds to the container 60 stored in the storage portion 4D. Since each container 60 corresponds to the intermediate tank 220 adjacent in the Y direction, pipes can be made short.

Note that the correspondence relationship between the intermediate tanks 220 and the containers 60 is not limited to this. For example, the two intermediate tanks 220 of the intermediate tank unit 8A may correspond to the containers 60 in the storage portions 4C and 4D, and the two intermediate tanks 220 of the intermediate tank unit 8B may correspond to the containers 60 in the storage portions 4A and 4B.

In this embodiment, the storage portions 4A to 4D are arranged in a plurality of stages in the Z direction, and the intermediate tanks 220 are arranged in line in the X direction. In general, a printing apparatus whose apparatus width (the width in the X direction) is small is advantageous in terms of installation space. In this embodiment, since the storage portions 4A to 4D are arranged in a plurality of stages in the Z direction, the apparatus width can be made small as compared to a layout in which these are arranged in line in the X direction. In addition, since the X-direction width of each of the storage portions 4A to 4D can be made large, a container having a large width in the X direction can be used as the container 60, and the capacity can be increased.

In general, concerning a bag-shaped container having flexibility, if the length in the Z direction is long and the length in the X direction is short, the container tends to have a round rod shape extending in the Y direction in a state in which the container is full of liquid. Then, free spaces are formed at the four corners of the storage portion having a rectangular shape. Since the capacity of the container is smaller than the capacity of the storage portion, the capacity of the storage portion is wasted. To the contrary, in this embodiment, the container 60 tends to have a flat rectangular parallelepiped shape in a state in which the container is full of liquid because the length in the Z direction is short and the length in the X direction is long. For this reason, the containers are well fitted in the storage portions 4A to 4D having a rectangular shape, and no space is wasted.

In addition, since the storage portions 4A to 4D are arranged in a plurality of stages in the Z direction, an arrangement space corresponding to the height is generated in the Z direction for the intermediate tanks 220 adjacent to the storage portions 4A to 4D in the Y direction. In this embodiment, the four intermediate tanks 220 are arranged not in a plurality of stages in the Z direction, but in line in the X direction and, therefore, the height of each intermediate tank 220 in the Z direction can be increased. This can increase the capacity of the intermediate tank 220.

Thus, it is possible to provide a technique of efficiently using the space in the printing apparatus 1 and contributing to an increase in the capacity of the container 60 or the intermediate tank 220.

Note that in this embodiment, the storage portions are arranged in two stages in the Z direction. However, the number of stages may be three or more. Although two storage portions are arranged in one stage, one storage portion may be arranged in one stage, three or more storage portions may be arranged, or the number of storage portions may be changed between the stages.

The positional relationship between the storage portions 4A and 4B and the two intermediate tanks 220 of the intermediate tank unit 8A will be described. As shown in FIG. 7, concerning positions in the X direction, the storage portions 4A and 4B are located in a width range Rx1, and the two intermediate tanks 220 are located in a width range Rx2. The width ranges Rx1 and Rx2 at least partially overlap. In this embodiment, the width range Rx2 falls within the width range Rx1. As shown in FIG. 8, concerning positions in the Z direction, the storage portions 4A and 4B are located in a height range Rz1, and the two intermediate tanks 220 are located in a height range Rz2. The height ranges Rz1 and Rz2 at least partially overlap. In this embodiment, the lower limit positions of the two ranges substantially match, and the upper limit position is higher in the height range Rz1 of the storage portions 4A and 4B. This also applies to the positional relationship between the storage portions 4C and 4D and the two intermediate tanks 220 of the intermediate tank unit 8B.

Concerning the positions in the X and Z directions, since the arrangement region of the storage portions 4A to 4D and the arrangement region of the four intermediate tanks 220 overlap, the size of the printing apparatus I can be reduced in the X and Z directions.

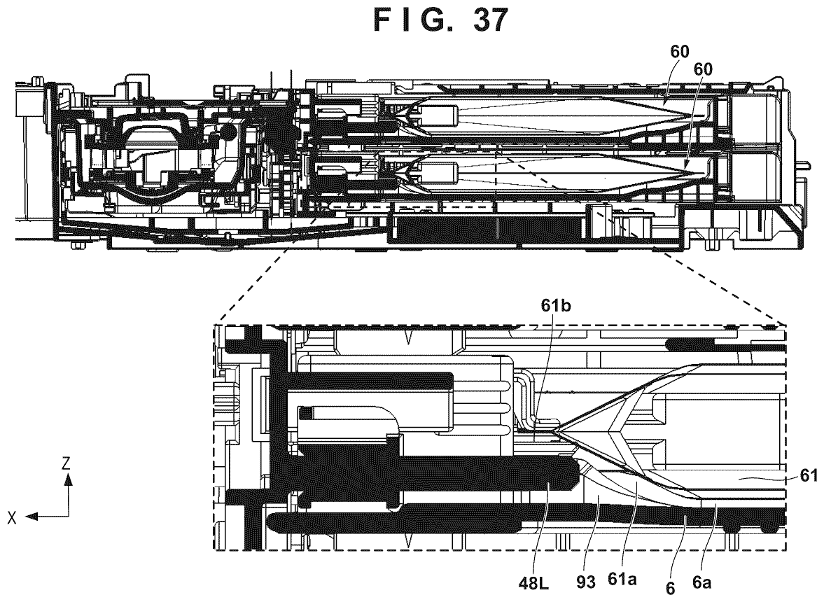

The configurations of the container 60 and the tray 6 will be described next with reference to FIGS. 35 to 38 as well. FIG. 35 is the perspective view of the container 60. FIGS. 36 to 38 show a sectional view taken along a line E-E in FIG. 7 and a partially enlarged view, a sectional view taken along a line F-F and a partially enlarged view, and a sectional view taken along a line G-G and a partially enlarged view, respectively.

The container 60 includes a bag 61 made of a flexible material, and a connecting portion (adapter) 62 provided at an end portion of the bag 61. The bag 61 is formed into a bag shape by, for example, welding sheets forming the upper and lower surfaces and sheets forming gusset portions to each other, thereby forming a flexible tank for storing a liquid. The connecting portion 62 is connected to a connecting portion 46 to form a channel that causes the inside of the bag 61 to communicate with the connecting portion 46. The container 60 is short in the Z direction and long in the X direction. That is, the relationship is length in Z direction<length in X direction.

The connecting portion 62 is a portion projecting from the Y-direction end portion of the bag 61 of the container 60. The connecting portion 62 is made of a material different from that of the bag 61 and has a function of causing the inside of the bag 61 to communicate with the apparatus main body. A face portion 70 is formed at the Y-direction end portion of the connecting portion 62. The face portion 70 is directed in the Y direction and forms a distal end face in the attachment direction of the container 60. Constituent elements configured to connect to the apparatus main body are put together on the face portion 70 of the connecting portion 62.

As the constituent elements configured to connect to the apparatus main body, a communicating portion 74, the electrical connecting portion 73, positioning portions 75L and 75R, and fitting portions 76L and 76R are provided on the face portion 70. The connecting portion 46 is inserted into the communicating portion 74 to form a channel to flow out the ink from the container 60 to the replenishing unit 8. The electrical connecting portion 73 is connected to the electrical connecting portion 47. The electrical connecting portion 73 is provided with a board portion 73a having a plurality of terminals that comes into contact with the terminal portions of the electrical connecting portion 47 and are electrically connected to these.

The positioning portions 75L and 75R are hole portions extending in the Y direction, and the positioning portions 48L and 48R are inserted into these. The X-direction position of the container 60 and its attachment position in the horizontal direction are appropriately defined.

The fitting portions 76L and 76R are located on the upper side of the positioning portions 75L and 75R, respectively, and are fitted on the fitting portions 49L and 49R. The fitting portions 76L and 76R are arranged apart in the X direction and each have a concave-convex structure. The concave-convex structure has a plurality of projecting portions parallelly arrayed in the Y direction and having a substantially rectangular shape. The array pattern of the projecting portions in the fitting portions 76L and 76R and concave portions (valley portions) formed therebetween has a concave-convex pattern reverse to that of the array pattern in the concave-convex structure of the fitting portions 49L and 49R on the side of the apparatus that is the connection target.

When the container 60 is moved in the Y direction to connect to the connecting portion 47 on the corresponding apparatus size, if the type of the container 60 is appropriate, the fitting portions 76L and 76R and the fitting portions 49L and 49R are fitted on each other. If the type of the container 60 is not appropriate, the fitting portions 76L and 76R and the fitting portions 49L and 49R are not fitted on each other. This suppresses connection of a wrong container 60 of, for example, a different color to the connecting portion 47.

The electrical connecting portion 73 is arranged in a projecting portion 71 projecting from the connecting portion 62 downward in the Z direction. Also, a concave portion 72 is formed on the upper side of the electrical connecting portion 73 in the Z direction. As shown in FIG. 36, in a state in which the plurality of containers 60 are stored, the projecting portion 71 of the container 60 of the upper stage is fitted in the concave portion 72 of the connecting portion 62 of the lower stage. This makes it possible to avoid interference of the electrical connecting portion 73 between adjacent connecting portions 62 on the upper and lower sides and minimize the overlap between the connecting portions 62. As a result, the overall height of the plurality of connecting portions 62 overlaid can be reduced, contributing to size reduction of the overall apparatus.

Note that as the form of the container 60, another form can also the employed. That is, as the container 60, a hard container that does not have flexibility may be used in place of the flexible bag 61, and a component corresponding to the connecting portion 62 may be provided at its distal end portion. In this case as well, components corresponding to the projecting portion 71 and the concave portion 72 are provided on the connecting portion, thereby minimizing the overlap between the connecting portions.

Note that the X-direction width of the concave portion 72 may not equal the X-direction width of the electrical connecting portion 73, and the whole upper surface of the connecting portion 62 may be formed at the same height as the concave portion 72.

More specifically, as shown in FIG. 36, let z1 be the distance between the communicating portion 74 provided in the connecting portion 62 of the lower stage and the electrical connecting portion 73, and z2 be the distance between the communicating portion 74 of the lower stage and the upper surface of the concave portion 72. Furthermore, let z3 be the distance between the communicating portion 74 of the lower stage and the projecting portion 71 of the connecting portion of the upper stage. In this case, the configuration is implemented such that a relationship z1>z3>z2 is satisfied. Even in a case where the whole upper surface of the connecting portion 62 is formed at the same height as the concave portion 72, satisfying the relationship suffices.

Thus, the electrical connecting portion 73 with the relationship of z3, which is most affected by ink scattering from the communicating portion 74 along the gravity direction, is arranged at the farthest position. This can further reduce the risk of an operation error and lowering of reliability caused by ink scattering at the time of removal of the container 60. On the other hand, when the distance z3 is made shorter than the distance z1, the height of the connecting portions 62 overlaid in the Z direction can be minimized.

Note that the arrangement of the containers 60 is not limited to horizontal placement/vertical arrangement, and vertical placement/horizontal arrangement is also possible.

Next, the tray 6 includes a bottom portion 6a on which the container 60 is placed, a front wall portion 6b standing at the front end portion of the bottom portion 6a, a rear wall portion 6c standing at the rear end portion of the bottom portion 6a, and left and right side wall portions 6d, and is open to the upper side (see FIGS. 8 to 10). A notch for passing the connecting portion 62 is formed in the rear wall portion 6c. In a state in which the container 60 is mounted, the tray 6 can detachably be attached to one of the storage portions 4A to 4D in the Y direction.

To stably store the trays 6 with the storage portions 4A to 4D, the storage portions 4A to 4D and the trays 6 are provided with engaging portions that engage with each other. In this embodiment, an engaging portion 6e is formed on each side wall portion 6d of each tray 6. The engaging portion 6e is a projecting portion projecting from the tray 6 in the X direction, and the projecting portion is extended in the Y direction. Engaging portions 42a and 42b are formed on the side wall portions 42L and 42R, and engaging portions 43a and 43b are formed on the left and right side surfaces of the partition wall 43. The engaging portions 42a, 42b, 43a, and 43b are grooves extended in the Y direction and engage with the engaging portions 6e. The engaging portions 42a and 43a correspond to the storage portions 4A and 4C of the upper stage and engage with the engaging portions 6e of the trays 6 attached to these storage portions. The engaging portions 42b and 43b correspond to the storage portions 4B and 4D of the lower stage and engage with the engaging portions 6e of the trays 6 attached to these storage portions.

By the engagement between the engaging portions 6e and the engaging portions 42a, 42b, 43a, and 43b, positioning of the trays 6 in the Z direction and maintaining of the posture of the trays 6 (maintaining of the horizontal posture) can be implemented. Furthermore, insertion/removal of the trays 6 to/from the storage portions 4A to 4D can be guided. Note that the engaging portions 6e may be grooves, and the engaging portions 42a, 42b, 43a, and 43b may be projecting portions. The structures of the engaging portions can appropriately be designed.

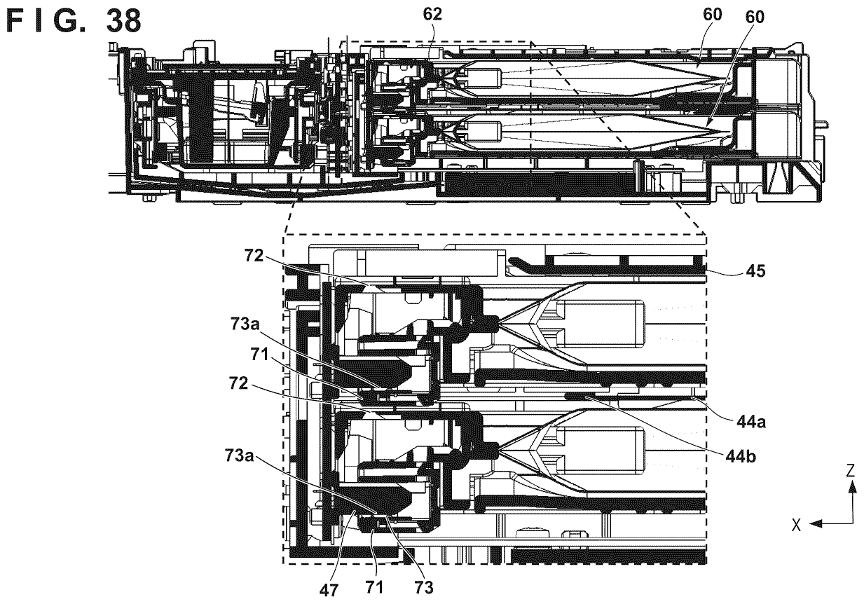

A structure in which the space efficiency when inserting the trays 6 with the containers 60 mounted thereon into the storage portions 4A to 4D will be described next with reference to FIG. 37. The bag 61 with flexibility includes an expansion portion 61a expanded by filling of the content (liquid), and a seal portion 61b that is a heat-welded portion formed on the outer periphery of the expansion portion 61a. If the bag 61 is arranged in the tray 6 in the horizontal direction in a state (filled state) in which the content is filled, the expansion portion 61a is supported by the bottom portion 6a of the tray 6, but the seal portion 61b is not supported by the bottom portion 6a. For this reason, a space portion 93 is formed between the expansion portion 61a and the lower portion of the seal portion 61b.

In this embodiment, at least a part of each of the positioning portions 48L and 48R (FIG. 37 shows only the positioning portion 48L) is arranged in the space portion 93. Thus, the space portion 93 generated by the structure of the bag 61 can be used without waste, and the space efficiency in the apparatus is improved.

Note that the positioning portions 48L and 48R may enter not the space portion 93 on the lower side of the seal portion 61b but the space on the upper side.

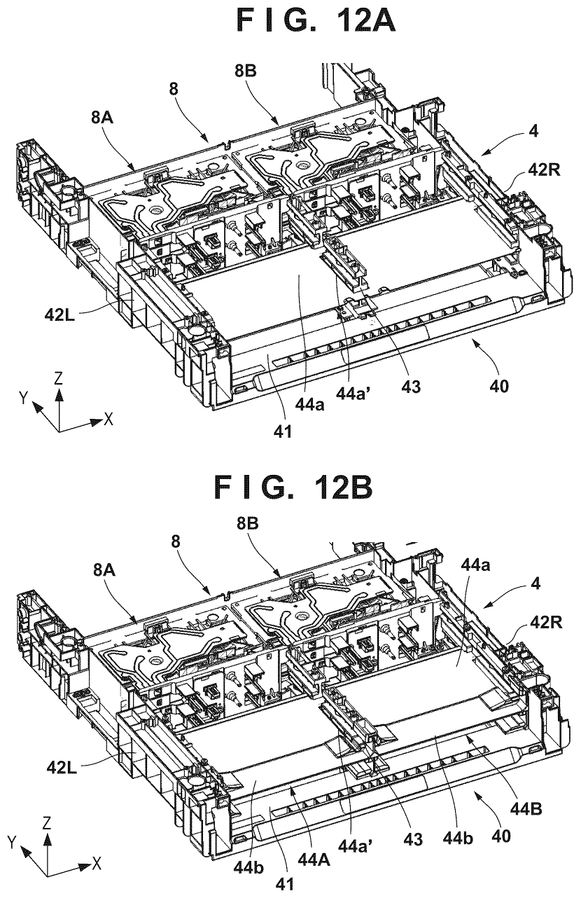

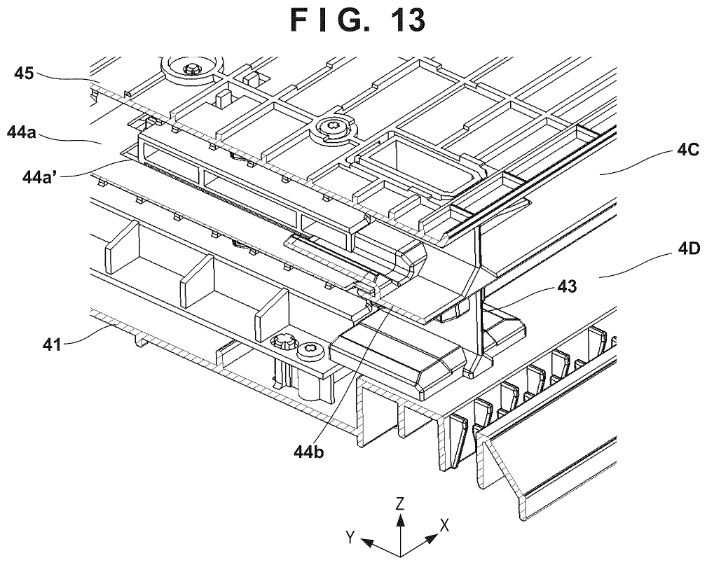

FIGS. 11A to 12B show the assembling structure of the storage unit 4. The storage unit 4 according to this embodiment has a configuration in which the bottom wall portion 41, the left and right side wall portions 42L and 42R, and the partition wall 43 are integrated to form one component, and the partition walls 44L and 44R and the upper wall portion 45 are assembled to this. FIG. 11A shows a state before assembly.

FIGS. 11B and 12A show a mode in which a partition plate 44a that is a metal plate forming the partition walls 44L and 44R is assembled. The partition plate 44a is one plate that forms the partition walls 44L and 44R, and an opening portion 44a′ is formed at the central portion. The partition plate 44a is assembled such that a part of the partition wall 43 is inserted into the opening portion 44a′, and the two end portions in the X direction are locked by locking portions formed on the side wall portions 42L and 42R, thereby obtaining the mode shown in FIG. 12A. The partition plate 44a is assembled by a fitting method, thereby simplifying the structure and reducing the apparatus size as compared to a case where a fastening structure is employed. Left and right front guides 44b are attached to the front end portion of the partition plate 44a, thereby completing the partition walls 44L and 44R. When the partition plate 44a is used as the bottom portions of the storage portions 4A and 4C, the support rigidity of the trays 6 and the containers 60 in the storage portions 4A and 4C can be improved.

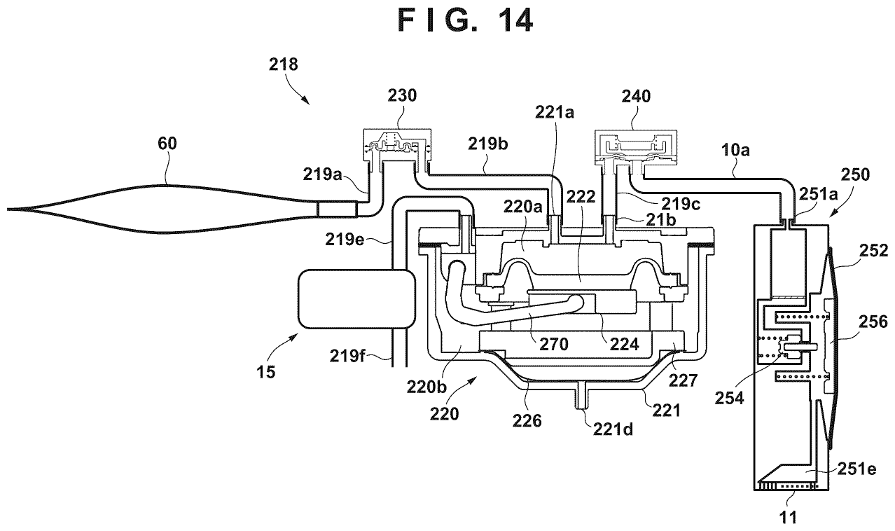

In the state shown in FIG. 12B, the upper wall portion 45 is assembled using screws, thereby completing the storage unit 4. FIG. 13 is a sectional view showing the vicinity of the partition wall 43 in a state in which the upper wall portion 45 is assembled.

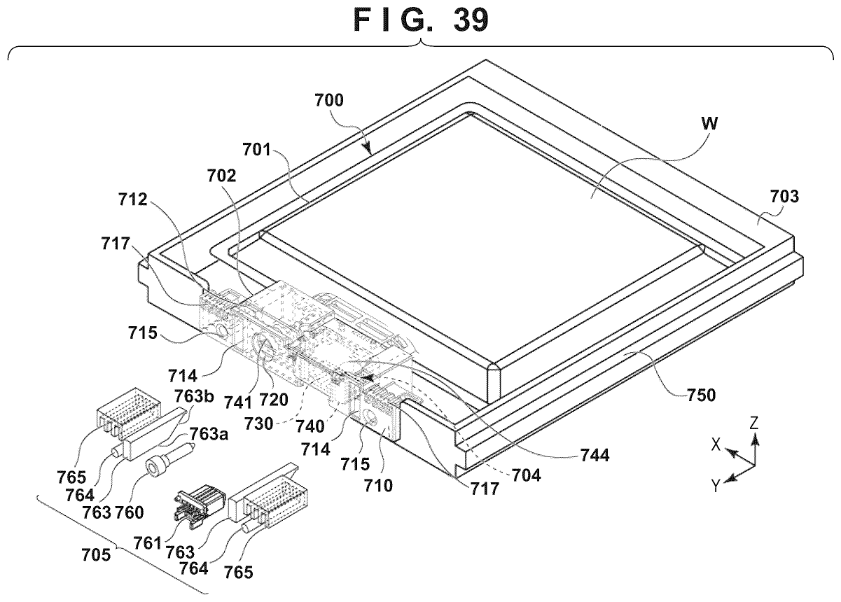

FIG. 38 will be referred to. The partition plate 44a and the upper wall portion 45 reinforce the structure of the apparatus main body. The partition plate 44a plays a role of holding the connecting portion 62 of the container 60 arranged on the lower stage from above. Also, the upper wall portion 45 plays a role of holding the connecting portion 62 of the container 60 arranged on the upper stage from above. That is, by pressing down the connecting portion 62 from above such that the container 60 is reliably supported with respect to the tray 6, the bag 61 can be prevented from lifting up.

It is also possible to prevent incorrect insertion of the positioning portions 48L and 48R into the positioning portions 75L and 75R, a connection failure of the connecting portion 46 to the communicating portion 74, or a contact failure between the electrical connecting portion 73 and the electrical connecting portion 47. Hence, this contributes to improvement of stability and reliability of the entire apparatus.

The partition plate 44a and the upper wall portion 45 need not always be provided up to the end portions of the storage portions 4A to 4D because lift-up of the connecting portions 62 is prevented after insertion of the positioning portions 48L and 48R into the positioning portions 75L and 75R is completed.

### <Liquid Supplying System>

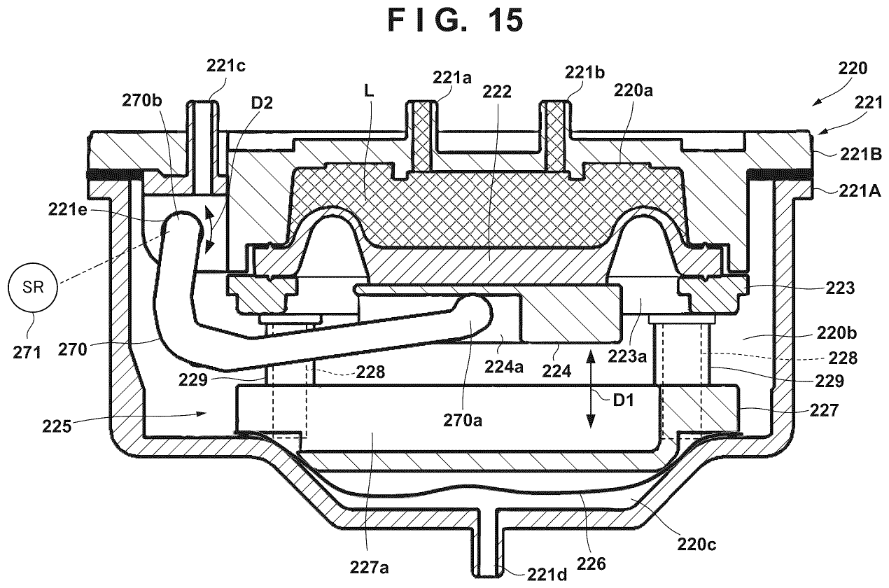

The structure of a supplying system for a liquid from the container 60 to the printhead 11 will be described next. FIG. 14 is an explanatory view of a supplying unit 218.

The supplying unit 218 is a supplying mechanism that supplies a liquid from the container 60 to the printhead 11. The supplying unit 218 is provided for each container 60. Hence, the printing apparatus 1 according to this embodiment includes four supplying units 218. FIG. 14 shows one of the four supplying units 218.

The supplying unit 218 includes the intermediate tank 220, check valves 230 and 240, a negative pressure maintaining unit 250, and the pressure adjusting unit 15. The intermediate tank 220 is connected to the container 60 via a pipe 219a, the check valve 230, and a pipe 219b. The negative pressure maintaining unit 250 is connected to the intermediate tank 220 via a pipe 219c, the check valve 240, and a pipe 10a.

The pressure adjusting unit 15 is connected to the intermediate tank 220 via a pipe 219e. The pipe 219e forms a channel of a fluid for pressure control. In this embodiment, the fluid is a gas and, particularly, air. A pipe 219f forms an air communicating path that communicates with the air. The pipes 219a to 219f are each formed by, for example, a flexible tube. The pipes 219a to 10a may be made of a material whose gas permeability or water vapor permeability is low such that the quality of the liquid flowing inside is not changed. The pipes 219a to 219f need not always be flexible tubes, and a metal tube may be used at least partially, or a channel may be formed by closely adhering and sealing a component to a groove formed in a plate-shaped component.

The liquid in the container 60 is introduced into the intermediate tank 220 via the pipe 219a, the check valve 230, and the pipe 219b. The container 60 is located on the upstream side in the liquid introducing direction, and the intermediate tank 220 is located on the downstream side. The check valve 230 is a one-way valve (check valve) that is provided on the upstream side of the intermediate tank 220 and prevents the liquid from flowing backward from the side of the intermediate tank 220 to the side of the container 60.

The liquid in the intermediate tank 220 is supplied to the printhead 11 via the pipe 219c, the check valve 240, the pipe 10a, and the negative pressure maintaining unit 250. The intermediate tank 220 is located on the upstream side in the liquid supplying direction, and the printhead 11 is located on the downstream side. The check valve 240 is a one-way valve (check valve) that is provided on the downstream side of the intermediate tank 220 and prevents the liquid from flowing backward from the side of the negative pressure maintaining unit 250 to the side of the intermediate tank 220.

In this embodiment, replenishment of the liquid from the container 60 to the intermediate tank 220 is done using a pressure generated by the pressure adjusting unit 15. Hence, making the liquid pressure in the container 60 close to the atmospheric pressure suffices, and there are little restrictions of layout. Also, since liquid supply to the printhead 11 is performed using a pressurization method, there are little restrictions concerning the installation place of each component, and installation in a place where a head difference exists between the intermediate tank 220 and the printhead 11 is also possible.

### (Intermediate Tank)

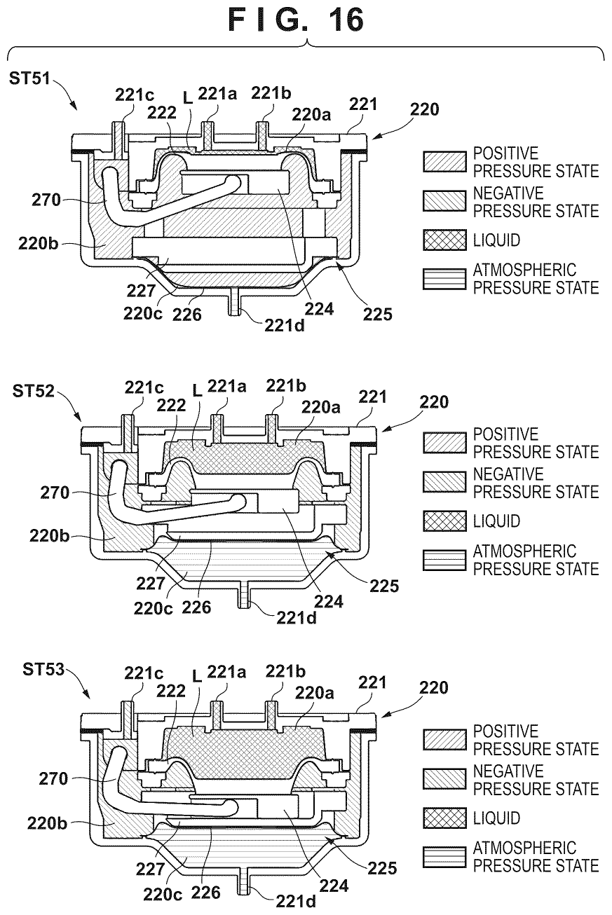

The configuration of the intermediate tank 220 will be described with reference to FIGS. 14 and 15. FIG. 15 is an explanatory view showing the structure of the intermediate tank 220. The intermediate tank 220 performs an introducing operation of introducing the liquid stored in the container 60 by suction and a supplying operation of supplying the introduced liquid to the printhead 11. The introducing operation can also be called a liquid replenishing operation. In terms of the two operations, the intermediate tank 220 plays a role of a pump.

The intermediate tank 220 includes a forming unit 221 that forms a liquid chamber 220a and a pressure chamber 220b. The forming unit 221 is a hollow member that forms an outer wall defining the liquid chamber 220a and the pressure chamber 220b. In this embodiment, the forming unit 221 includes a housing 221A having a cup shape, and a lid member 221B that closes an opening in the top portion of the housing 221A.

The liquid chamber 220a stores a liquid L to be supplied to the printhead 11. The liquid L is introduced from the container 60 into the liquid chamber 220a. The lid member 221B includes an inflow pipe 221a that forms an inlet communicating with the liquid chamber 220a, and an outflow pipe 221b that forms an outlet communicating with the liquid chamber 220a. The pipe 219b is connected to the inflow pipe 221a, and the pipe 219c is connected to the outflow pipe 221b.

The pressure chamber 220b is formed to be adjacent to the liquid chamber 220a via a wall member 222. The wall member 222 partitions between the liquid chamber 220a and the pressure chamber 220b. It can also be said that the wall member 222 is a part of a peripheral wall defining the liquid chamber 220a or the pressure chamber 220b. The wall member 222 is a diaphragm that is displaced in accordance with the pressure in the pressure chamber 220b, thereby changing the capacity of the liquid chamber 220a. The wall member 222 according to this embodiment is formed by a flexible sheet that is elastically deformed in accordance with the pressure difference between the liquid chamber 220a and the pressure chamber 220b, and has, on the peripheral edge portion, a convex-shaped portion formed into an annular shape.

The wall member 222 is hermetically sandwiched between the lid member 221B and a frame member 223. The frame member 223 is an annular member with an opening portion 23a at the central portion. The frame member 223 is supported by a plurality of shaft members 228 standing on the bottom portion of the housing 221A. The wall member 222 has its peripheral edge sandwiched between the lid member 221B and the frame member 223, and the central portion of the wall member 222 can be displaced to the lower side of the opening portion 23a.

The housing 221A includes a communicating pipe 221c that forms a communicating path communicating with the pressure adjusting unit 15 and the pressure chamber 220b. The pipe 219e is connected to the communicating pipe 221c. The pressure chamber 220b is provided with a restricting unit 225 that restricts the displacement of the wall member 222 in accordance with the pressure in the pressure chamber 220b. The restricting unit 225 restricts the maximum displacement position of the wall member 222 in the direction of expanding the liquid chamber 220a.

The restricting unit 225 includes a stopper 227 and a flexible member 226. The flexible member 226 forms, in the pressure chamber 220b, a partition wall to an air chamber 220c. In other words, the pressure chamber 220b is partitioned by the flexible member 226 into the portion of the air chamber 220c on the bottom side and a portion on the side of the liquid chamber 220a. The flexible member 226 is a diaphragm that is displaced in accordance with the pressure in the pressure chamber 220b, thereby changing the capacity of the air chamber 220c. The wall member 222 according to this embodiment is formed by a flexible film that is elastically deformed in accordance with the pressure difference between the liquid chamber 220a and the pressure chamber 220b, and its peripheral edge is hermetically fixed to the bottom portion of the housing 221A.

The housing 221A has, in its bottom portion, a communicating pipe 221d that forms an air communicating port. The communicating pipe 221d is always released, and the air chamber 220c is maintained at the atmospheric pressure. The stopper 227 is an elevating member that includes holes (not shown) for receiving the shaft members 228, is provided to freely move up/down in a direction D1 (the depth direction of the housing 221A) along the shaft members 228 serving as guide shafts, and is displaced by displacement of the flexible member 226. In this embodiment, the flexible member 226 is arranged between the stopper 227 and the bottom portion of the housing 221A. If the pressure chamber 220b is set in a negative pressure state, the flexible member 226 is displaced to the upper side, thereby increasing the capacity of the air chamber 220c. The stopper 227 thus rises to a restricting position to restrict the maximum displacement position. The stopper 227 includes a concave portion 227a in which an abutment member 224 enters.

The abutment member 224 is fixed to the central portion lower surface of the wall member 222. The abutment member 224 is displaced along with the displacement of the wall member 222. The abutment member 224 includes an engaging groove 224a with which an end portion 270a of a detection lever 270 engages. In this embodiment, the abutment member 224 abuts against the stopper 227, thereby restricting the displacement range of the wall member 222. It is also possible to employ a configuration in which the wall member 222 and the flexible member 226 are made to directly abut against each other to restrict the displacement range of the wall member 222. However, with the intervention of the abutment member 224 or the stopper 227, it is possible to prevent degradation of the wall member 222 and the flexible member 226 and more correctly restrict the displacement range.

A plurality of elastic members 229 are provided between the abutment member 224 and the stopper 227. The elastic member 229 according to this embodiment is a coil spring in which the shaft member 228 is inserted, and biases the abutment member 224 and the stopper 227 in a direction of separating these. In the state shown in FIG. 15, the abutment member 224 and the stopper 227 are apart, and the displacement range of the wall member 222 is not restricted.

The detection lever 270 is a movable member configured to detect the remaining amount of the liquid in the liquid chamber 220a. An intermediate portion 270b of the detection lever 270 passes through a shaft hole 221e and is rotatably supported by the shaft hole 221e. Depending on the remaining amount of the liquid in the liquid chamber 220a, the abutment member 224 is displaced in the direction D1. The detection lever 270 rotates in a direction D2 along with the displacement of the abutment member 224. The rotation amount of the detection lever 270 is detected by a remaining amount detection sensor 271 arranged inside the housing 221A. The remaining amount of the liquid in the liquid chamber 220a can be estimated based on the detection result of the remaining amount detection sensor 271. Note that the detection lever 270 is always biased counterclockwise in FIG. 15 by an elastic member (not shown). Also, the intermediate portion 270b of the detection lever 270 may pass through the shaft hole 221e formed in the housing 221A and extend to the outside of the housing 221A. In this case, the intermediate portion 270b may rotatably be supported by the shaft hole 221e that is hermetically sealed.

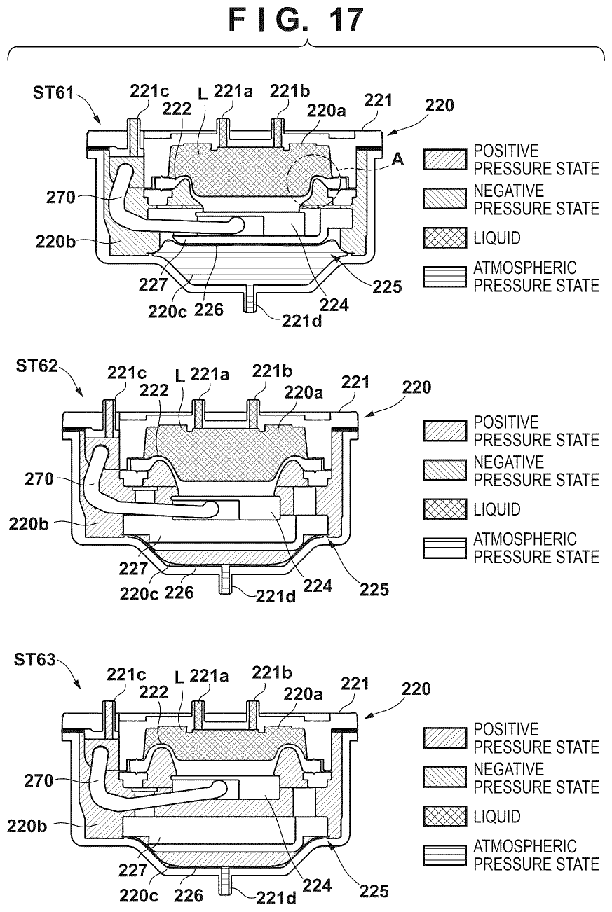

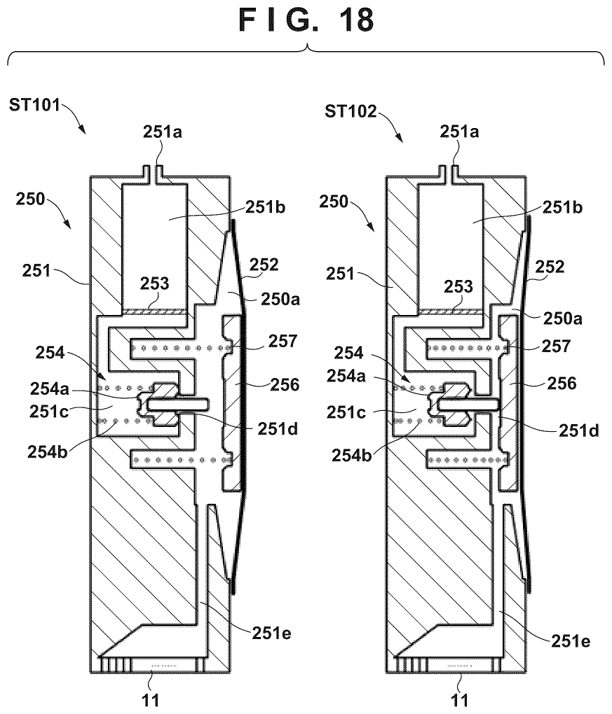

The operation of the intermediate tank 220 will be described with reference to FIGS. 16 and 17, in addition to FIG. 15. FIGS. 16 and 17 show the operation of each portion of the intermediate tank 220 together with the internal pressure state.

A state ST51 shown in FIG. 16 indicates a state in which the liquid L in the liquid chamber 220a nearly runs out by the supplying operation, and the capacity of the liquid chamber 220a is minimum. The pressure chamber 220b is set in a positive pressure state by the pressure adjusting unit 15. The capacity of the air chamber 220c is substantially zero, and the stopper 227 is located at a position closest to the bottom portion of the housing 221A. To the contrary, the abutment member 224 is located at a position closest to the liquid chamber 220a. The replenishing operation is performed from this state. Note that the replenishing operation need not always be performed after the remaining amount in the liquid chamber 220a decreases to the stage of the state ST51, and the replenishing operation may be performed when, for example, the remaining amount is about 50%.

A state ST52 in FIG. 16 indicates a stage in which the replenishing operation is started and the pressure chamber 220b is set in a negative pressure state by the pressure adjusting unit 15. Since the pressure chamber 220b is set to the negative pressure, the wall member 222 and the abutment member 224 are displaced to the side of the bottom portion of the housing 221A. The capacity of the liquid chamber 220a increases, and the liquid L is sucked from the container 60 into the liquid chamber 220a. In the state ST52, the liquid L about 50% of the maximum capacity of the liquid chamber 220a is introduced into the liquid chamber 220a.

In the state ST52 shown in FIG. 16, the flexible member 226 and the stopper 227 are displaced in the direction opposite to the wall member 222 (to the side of the lid member 221B), air is sucked into the air chamber 220c, and the capacity thereof increases. In this embodiment, if the pressure chamber 220b is set in the negative pressure state, the flexible member 226 is displaced before the wall member 222. It is a liquid with viscosity that flows into the liquid chamber 220a. On the other hand, it is air having a flow resistance lower than that of the liquid, which flows into the air chamber 220c. Also, the inner diameter or length of the communicating pipe 221d can be designed to provide little or no flow resistance. This makes it possible to quickly deform the flexible member 226. Thus, the displacement range of the wall member 222 can be restricted such that the flexible member 226 is displaced before the wall member 222.

The stopper 227 translates to the side of the liquid chamber 220a by the guidance of the plurality of shaft members 228. The stopper 227 moves against the biasing force of the elastic members 229. The stopper 227 moves until it abuts against projections (not shown) formed on the shaft members 228. That position is the restricting position for restricting the displacement range of the wall member 222. Note that the stopper 227 may be configured not to stop moving at a predetermined portion on the shaft member 228.

A state ST53 in FIG. 16 indicates a stage in which the liquid L further flows into the liquid chamber 220a. The pressure chamber 220b is continuously set in the negative pressure state, and the wall member 222 is displaced in the direction of increasing the capacity of the liquid chamber 220a and deformed to expand. The abutment member 224 abuts against the stopper 227, and the displacement of the wall member 222 is restricted.

Note that letting S1 and S2 be the projection areas of the wall member 222 and the flexible member 226 on a horizontal plane (a plane orthogonal to the direction D1 in FIG. 15), the shapes are designed such that

$$S 1 < S 2$$

holds. In a state in which the same negative pressure NP acts,

$$\vert NP \vert \times S 1 < \vert NP \vert \times S 2$$

holds. The force of expanding the flexible member 226 is larger than the force of expanding the wall member 222. Hence, when the abutment member 224 abuts against the stopper 227, the displacement of the wall member 222 is reliably restricted.

A state ST61 in FIG. 17 indicates a state in which the negative pressure continuously acts on the wall member 222 from the state ST53 in FIG. 16. Since the abutment member 224 cannot further move to the side of the stopper 227 due to the restriction of the stopper 227, further elastic deformation occurs in a part (a thin portion like a portion A in FIG. 17) of the wall member 222. The deformation stops when the force of the negative pressure in the pressure chamber 220b and the elastic deformation force of the portion A of the wall member 222 balance. A slightly extra amount of liquid L flows into the liquid chamber 220a in correspondence with the deformation of the portion A. In other words, it can be said that the capacity of the liquid chamber 220a at the stage of the state ST61 is the maximum capacity in the replenishing operation, and the maximum capacity is limited by the restricting unit 225.

A state ST62 in FIG. 17 indicates a state in which the replenishing operation is ended, and the supplying operation is started. The negative pressure state of the pressure chamber 220b is canceled by the pressure adjusting unit 15, and the state changes to the positive pressure state via the atmospheric pressure. Air is exhausted from the air chamber 220c via the communicating pipe 221d, and the flexible member 226 is crushed and displaced to the side of the communicating pipe 221d. Along with the displacement of the flexible member 226, the stopper 227 is also displaced to the side of the communicating pipe 221d by the bias of the elastic members 229, and the restriction of the displacement range of the wall member 222 is canceled.

When the restriction of the displacement range of the wall member 222 is canceled, the constraint of the portion A of the wall member 222 indicated by the state ST61 is released, and it is going to restore the original form. Since the slightly extra amount of liquid L corresponding the deformation of the portion A already flows into the liquid chamber 220a, the abutment member 224 is displaced to the side of the stopper 227 in correspondence with the amount. As a result, the pressure in the liquid chamber 220a substantially equals the pressure in the pressure chamber 220b, and the elastic deformation force corresponding to the deformation of the portion A of the wall member 222 does not act when pressurizing the liquid L in the liquid chamber 220a and supplying it to the printhead 11.

This point will be described in more detail. Assume a state in which the restricting unit 225 is not provided, the wall member 222 abuts against a portion (for example, the inner wall of the pressure chamber 220b) for which displacement restriction cannot be canceled in the replenishing operation, and elastic deformation further occurs in a part of the wall member 222, like the portion A. In this state, if the pressure chamber 220b is changed from the negative pressure state to the positive pressure state, the pressure of the liquid L in the liquid chamber 220a is increased by the restoring force of a partially elastically deformed portion, like the portion A of the wall member 222. As a result, the liquid L is supplied by a force stronger than a pressurizing force assumed for the control of the pressure adjusting unit 15, and the flow of the liquid L may be unstable on the side of the printhead 11.

To the contrary, in this embodiment, when the pressure chamber 220b is in the negative pressure state, the displacement of the wall member 222 is restricted by the restricting unit 225. When the negative pressure state is canceled, the restriction of the displacement of the wall member 222 is also canceled, and the partial elastic deformation of the wall member 222 is canceled. It is therefore possible to prevent the pressure of the liquid L in the liquid chamber 220a from increasing due to the elastic deformation of a part of the wall member 222. For this reason, the supply pressure of the liquid L supplied from the liquid chamber 220a to the printhead can be controlled more correctly by the pressure adjusting unit 15, and variations of the supply pressure can be reduced.

Note that if the excessive elastic deformation of a part of the wall member 222 is detected before it occurs, and the negative pressure in the pressure chamber 220b is canceled, the extra liquid L can be prevented from flowing into the liquid chamber 220a. However, it is not easy to detect the stage immediately before a part of the wall member 222 is excessively elastically deformed, and an additional sensor or the like is needed. On the other hand, this embodiment is advantageous in terms of cost and apparatus layout.

In the stage of the state ST62, the pressure state in the pressure chamber 220b is the positive pressure state, and the pressure of the liquid L in the liquid chamber 220a substantially equals the air pressure in the pressure chamber 220b. A state ST63 in FIG. 17 indicates a state in which the capacity of the liquid chamber 220a is reduced, and the liquid L is supplied from the liquid chamber 220a to the side of the printhead 11. The state ST63 indicates a state in which the liquid L about 50% of the maximum capacity of the liquid chamber 220a is supplied to the side of the printhead 11. Note that whether to actually supply the liquid depends on the state of the negative pressure maintaining unit 250, and this point will be described later. When the supply of the liquid L progresses, the state changes to the state ST51 shown in FIG. 16, and the same operation as described above is repeated.

### (Negative Pressure Maintaining Unit)

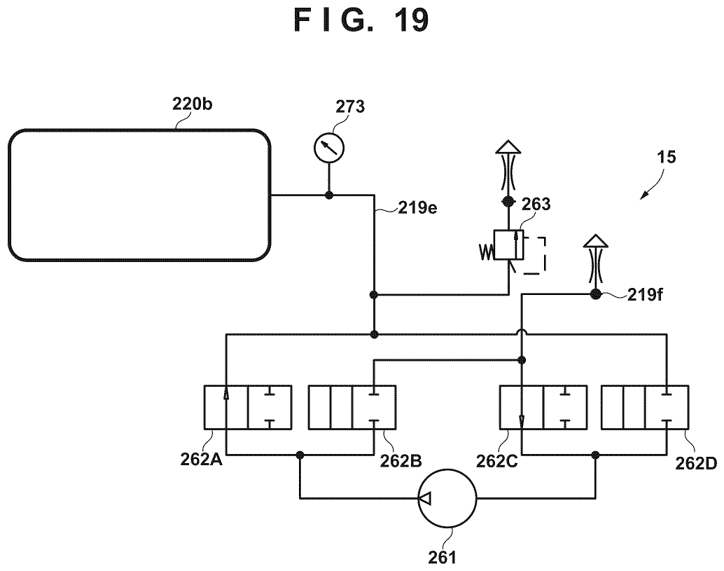

The structure and operation of the negative pressure maintaining unit 250 will be described with reference to FIG. 18. FIG. 18 is an explanatory view of the structure and operation of the negative pressure maintaining unit 250. A state ST101 indicates a state in which the storage amount of the liquid L is large, and a state ST102 indicates a state in which the storage amount of the liquid Lis small.

The negative pressure maintaining unit 250 includes a housing 251 provided with the printhead 11 and forms a printhead module. The housing 251 includes an inflow pipe 251a that forms an inlet in which the liquid L supplied from the intermediate tank 220 flows, and a channel 251b communicating with the inflow pipe 251a. The pipe 10a is connected to the inflow pipe 251a. A filter 253 is provided in the channel 251b, and unnecessary mixed substances are removed when the liquid L flows into the channel 251b and passes through the filter 253.

The housing 251 also includes channels 251c and 251e and a storage portion 250a. A part of the peripheral wall of the storage portion 250a is formed by a diaphragm 252. The storage portion 250a is provided between the printhead and the liquid chamber 220a of the intermediate tank 220 and communicates with the printhead 11 via the channel 251e. The storage portion 250a is a liquid chamber that temporarily stores, before the printhead 11, the liquid L supplied from the liquid chamber 220a at a predetermined negative pressure force, and prevents the liquid L from leaking from the printhead 11.

The diaphragm 252 is a deformation sheet member that is made of a flexible material and partitions the storage portion 250a. A moving plate 256 is adhered to the diaphragm 252. The diaphragm 252 and the moving plate 256 are always biased by an elastic member 257 in a direction of increasing the capacity of the storage portion 250a. The elastic member 257 is a coil spring put between the housing 251 and the moving plate 256 and maintains the storage portion 250a in a negative pressure state by the biasing force of the elastic member 257.

The channel 251c is provided with a limiting valve 254 that limits supply of the liquid L from the channel 251c to the storage portion 250a. The limiting valve 254 is a valve that opens/closes a communicating path 251d between the channel 251c and the storage portion 250a. The limiting valve 254 includes a valve element 254a and an elastic member 254b, and the valve element 254a is always biased in a closing direction by the elastic member 254b. The valve element 254a includes a shaft portion that passes through the communicating path 251d and enters the storage portion 250a.

The operation of the negative pressure maintaining unit 250 will be described. In the state ST101, the limiting valve 254 is closed. In other words, the storage portion 250a is filled with a sufficient amount of liquid L. When the valve element 254a is adhered to the wall portion around the communicating path 251d, flow of the liquid L from the channel 251c to the storage portion 250a is limited. In this state, a force in a direction of expanding the storage portion 250a is applied from the elastic member 257 to the diaphragm 252 via the moving plate 256. In addition, since the limiting valve 254 is closed, the liquid in the storage portion 250a is in a negative pressure state. Thus, when discharging the liquid L from the nozzles of the printhead 11, a meniscus formed in each nozzle can be set to a desirable state (appropriately recessed state). Note that in the state ST101 shown in FIG. 18, the expansion of the diaphragm 252 is expressed in a slightly exaggerated state.

The state ST102 indicates a state in which the limiting valve 254 is opened. In other words, the state in which the limiting valve 254 is opened is a state in which the remaining amount in the storage portion 250a is short and liquid supply from the intermediate tank 220 is waited. If the capacity in the storage portion 250a decreases along with the discharge of the liquid L from the printhead 11, the diaphragm 252 is displaced, against the elastic member 257, to the side of the limiting valve 254. When the moving plate 256 presses the valve element 254a of the limiting valve 254 and the valve element 254a is separated from the wall portion around the communicating path 251d, the liquid L can flow from the channel 251c to the storage portion 250a via the communicating path 251d. Since the liquid L entered from the inflow pipe 251a is pressurized, it passes through the filter 253 and flows into the storage portion 250a via the communicating path 251d.

When the liquid amount in the storage portion 250a increases, the diaphragm 252 gradually expands, and parallelly, the moving plate 256 moves in a direction of separating from the valve element 254a. As a result, the limiting valve 254 is closed, like the state ST101.

In this way, while maintaining the storage portion 250a at the negative pressure, the liquid L is pressurized and supplied from the intermediate tank 220 to the storage portion 250a. FIG. 18 shows the displacement of the diaphragm 252 in an exaggerated state. In fact, the closed state and the open state are repeated with a small moving amount, and the inside of the storage portion 250a can be kept at an almost constant negative pressure.

### (Pressure Adjusting Unit)

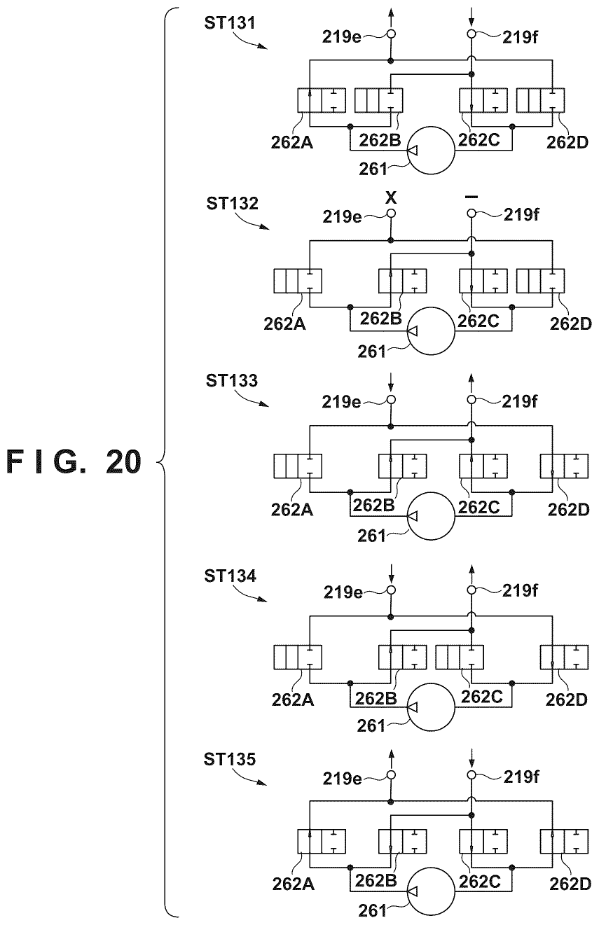

The configuration of the pressure adjusting unit 15 will be described. FIG. 19 is an explanatory view of the pressure adjusting unit 15. The pressure adjusting unit 15 includes an air pump 261, and a plurality of control valves 262A to 262D. The air pump 261 is an electric pump that incorporates a diaphragm, a check valve, and the like and uses a motor as a driving source. Each of the plurality of control valves 262A to 262D is an electric valve that switches the communicating state of the pressure chamber 220b to the air pump 261 or the pipe 219f forming an air communicating path.

In this embodiment, a pressure sensor 273 and a constant pressure valve 263 are provided on the pipe 219e. The pressure sensor 273 detects the pressure of a gas in the pipe 219e, that is, the pressure in the pressure chamber 220b. The constant pressure valve 263 is a valve that maintains the pressure chamber 220b at not more than an upper limit pressure when pressurizing the pressure chamber 220b. When the pressure in the pipe 219e reaches the upper limit pressure, the constant pressure valve 263 is opened to make the pipe 219e communicate with the air. This maintains the pressure chamber 220b at not more than the upper limit pressure.

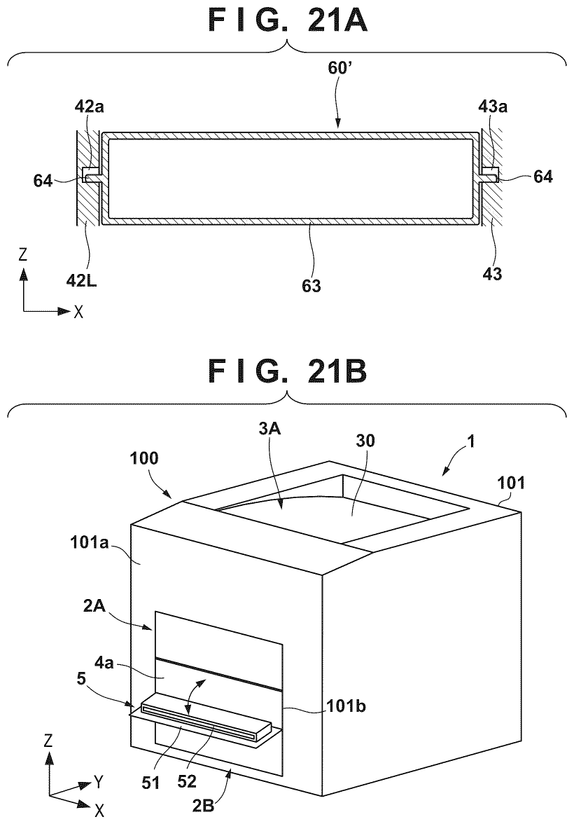

A state ST131 shown in FIG. 20 indicates valve states in a pressurization operation for setting the pressure chamber 220b in a positive pressure state. The control valve 262A is open, the control valve 262B is closed, the control valve 262C is open, and the control valve 262D is closed. When the air pump 261 is driven in the valve states, air is sucked from the side of the pipe 219f, and pressurized air is sent to the pipe 219e. When pressure adjustment is performed by the pressurization operation, the pressure chamber 220b gradually changes from the atmospheric pressure state to a positive pressure. If the pressure in the pipe 219f exceeds the upper limit pressure after a predetermined time, the constant pressure valve 263 operates to make the pressure in the pressure chamber 220b constant.

A state ST132 indicates valve states in a closing operation for maintaining the pressure in the pressure chamber 220b pressurized by the pressurization operation. The control valve 262A is closed, the control valve 262B is open, the control valve 262C is open, and the control valve 262D is closed. In the valve states, the side of the pipe 219e (pressure chamber 220b) is disconnected from the air pump 261 and closed. When the air pump 261 is being driven, air circulates between the control valve 262B, the control valve 262C, and the air pump 261. Hence, air does not flow to the side of the pipe 219f in both the state in which the air pump 261 is operating and the state in which it is stopped.

A state ST133 indicates an air release operation that is performed halfway through the transition to the next pressure reducing operation. This operation is an operation for making the pressure chamber 220b communicate with the air and returning it from the positive pressure state to substantially the atmospheric pressure in order to quickly change the pressure chamber 220b from the positive pressure state to a negative pressure state. In the air release operation, the control valve 262A is closed, the control valve 262B is open, the control valve 262C is open, and the control valve 262D is open. In this case, air enters from the side of the pipe 219e, passes through the control valve 262D and the control valve 262C in this order, and exits to the pipe 219f without passing through the air pump 261.

A state ST134 indicates valve states in a pressure reducing operation for setting the pressure chamber 220b in a negative pressure state. The control valve 262A is closed, the control valve 262B is open, the control valve 262C is closed, and the control valve 262D is open. When the air pump 261 is driven in the valve states, air is sucked from the side of the pipe 219e and discharged to the side of the pipe 219f. When pressure adjustment is performed by the pressure reducing operation in the atmospheric pressure state of the pressure chamber 220b, the pressure chamber 220b gradually changes to a negative pressure. After a predetermined time, the pressure in the pressure chamber 220b becomes constant at a predetermined negative pressure according to the capability of the air pump 261. Note that in this embodiment, no constant pressure valve is provided on the negative pressure side. To limit the pressure to a predetermined negative pressure, a negative pressure side constant pressure valve may be provided in parallel to the constant pressure valve 263.

A state ST135 indicates an air release operation that is performed halfway through the transition to the next pressurization operation (state ST131). This operation is an operation for making the pressure chamber 220b communicate with the air and returning it from the negative pressure to substantially the atmospheric pressure in order to quickly change the inside of the pressure chamber 220b from the negative pressure state to a positive pressure state. In the air release operation, the control valve 262A is open, the control valve 262B is open, the control valve 262C is open, and the control valve 262D is open. In this case, air enters from the side of the pipe 219f, passes through the control valve 262B and the control valve 262A in this order, and enters the pipe 219e without passing through the air pump 261.

### Second Embodiment

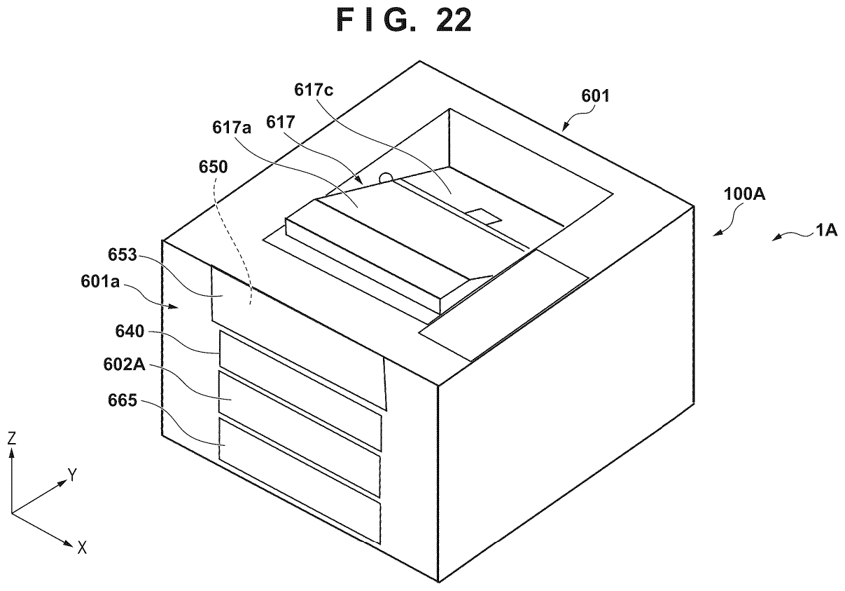

In the first embodiment, a bag-type container has been exemplified as the container 60. However, it may be a bottle-type container. In this case, the tray 6 is not needed. FIG. 21A is a sectional view showing an example in which a bottle-type container 60′ is attached to a storage portion. The container 60′ includes a hollow member 63 that has a rectangular parallelepiped shape and stores a liquid inside. Engaging portions 64 corresponding to the engaging portions 6e of the tray 6 according to the first embodiment are provided on the left and right side portions of the hollow member 63. The example shown in FIG. 21A assumes a case where the container 60′ is attached to a storage portion 4A. The left and right engaging portions 64 engage with an engaging portion 42a of a side wall portion 42L and an engaging portion 43a of a partition wall 43.

### Third Embodiment

In the first embodiment, attachment/detachment to/from the main body 100 has been exemplified as the opening/closing mode of the opening/closing member 5. However, it may rotate. FIG. 21B is a view showing another example of the configuration of an opening/closing member 5. In the example shown in FIG. 21B, the opening/closing member 5 rotates about a rotation shaft in the X direction. Since the opening/closing member 5 is supported by a main body 100 regardless whether it is opened/closed, it is possible to prevent the opening/closing member 5 from being lost or being damaged upon falling.

### Fourth Embodiment

### <Outline of Printing Apparatus>

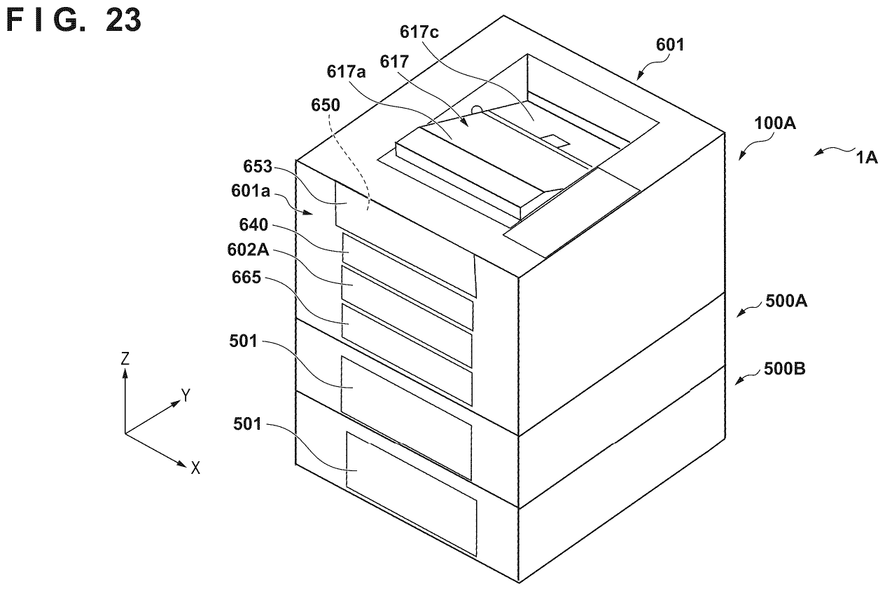

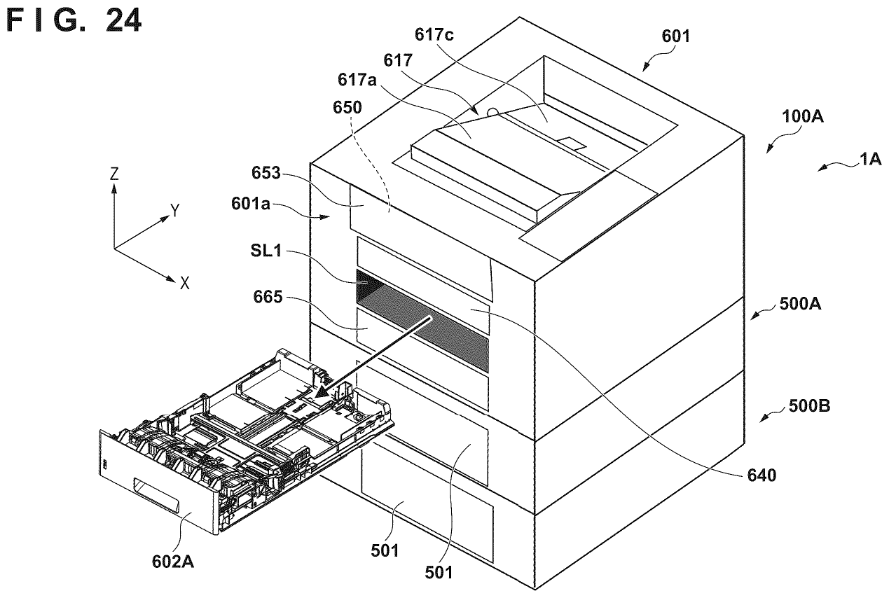

FIG. 22 is a view showing the outer appearance of a printing apparatus 1A according to the embodiment. A plurality of optional devices can be attached to the printing apparatus 1A. FIG. 23 shows a mode in which optional devices 500A and 500B are attached to the printing apparatus 1A. The optional devices 500A and 500B are devices having the same configuration. When referring to the optional devices 500A and 500B collectively or without distinction, these will simply be referred to as optional devices 500. Each optional device 500 includes a storage cassette 501 that stores print media. By adding the optional devices 500, the storage amount of the print media to be used for printing or the types of print media to be used for printing can be increased. The storage cassette 501 is detachably attached to the main body of the optional device 500. In this embodiment, the storage cassette 501 is provided on the front surface of the optional device 500 such that it can be inserted/removed into/from the main body in the Y direction.

In the example shown in FIG. 23, two stages of optional devices 500 are provided under the printing apparatus 1A. However, only one optional device 500 can be attached to the printing apparatus 1A, or three or more stages of optional devices 500 can be attached to the printing apparatus 1A. In addition, the printing apparatus 1A can be used without attaching the optional device 500.

Note that in this embodiment, a case where the present disclosure is applied to a serial type inkjet printing apparatus will be described. However, the present disclosure can also be applied to a printing apparatus of another type.

In drawings to be explained in this embodiment, arrows X, Y, and Z indicate directions crossing each other. The arrows X and Y indicate horizontal directions that are orthogonal to each other, and the arrow Z indicates the up/down direction. The X direction corresponds to the left/right direction (the widthwise direction) of the printing apparatus 1A, and the Y direction corresponds to the front/rear direction (the depth direction) of the printing apparatus 1A. The Z direction corresponds to the height direction of the printing apparatus 1A. Also, the downstream side and the upstream side are defined based on the conveyance direction of a print medium as a reference.

The printing apparatus 1A includes a main body 100A, a detachable unit 640 detachable from the main body 100A, and a storage cassette 602A. The main body 100A includes a housing 601 having a substantially rectangular parallelepiped shape, and the housing 601 forms the outer wall of the printing apparatus 1A. The detachable unit 640 and the storage cassette 602A are attached to a front surface 601a of the housing 601, which forms the front portion of the printing apparatus 1A, such that these can be inserted/removed into/from the main body 100A in the Y direction. The front surface 601a is also provided with a cover 653 that can be opened/closed and cover a feeding unit 650 inside the main body 100A and an opening/closing member 665. The cover 653, the detachable unit 640, the storage cassette 602A, and the opening/closing member 665 are arranged in this order from above in the Z direction.

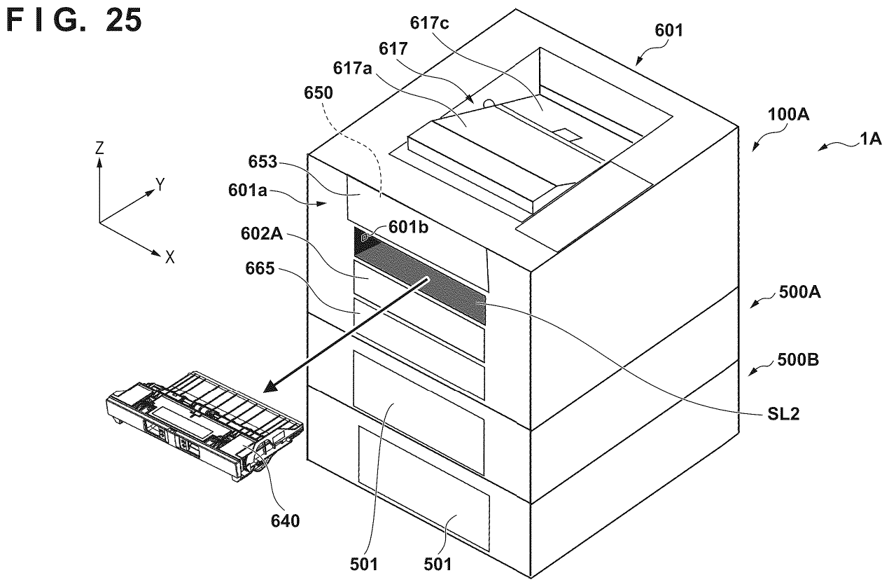

FIG. 24 shows a state in which the storage cassette 602A is extracted from the main body 100A in the −Y direction. The main body 100A has a slot SL1 that opens to the front surface 601a, and the storage cassette 602A is stored in the slot SL1.

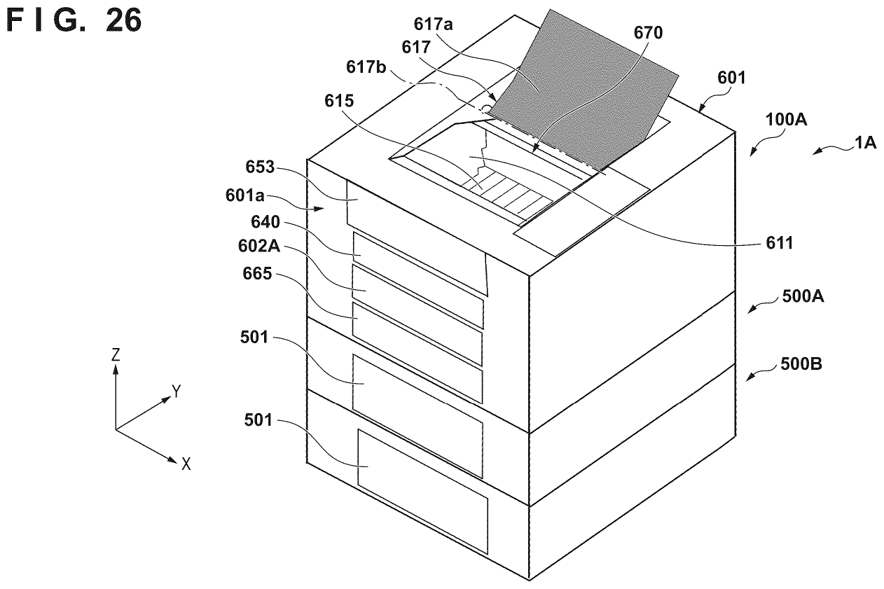

FIG. 25 is a view showing a state in which the detachable unit 640 is detached from the main body 100A in the −Y direction. The main body 100A has a slot SL2 opening to the front surface 601a, and the detachable unit 640 is stored in the slot SL2.

A discharge tray 617 is provided on the upper surface portion of the main body 100A. A printed print medium is discharged to the discharge tray 617 and stacked on the discharge tray 617.

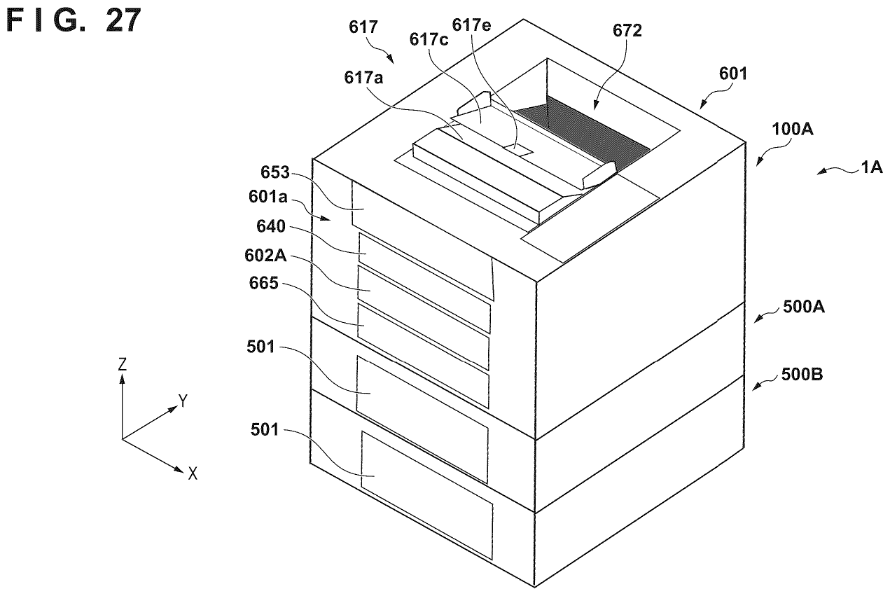

An opening portion 670 that is formed in the upper surface portion of the housing 601 and exposes the inside of the main body 100A of the printing apparatus 1A will be described with reference to FIGS. 23 and 26. The opening portion 670 is opened/closed by an opening/closing member 617a. In this embodiment, the opening/closing member 617a is a plate-shaped tray member that forms a part of the discharge tray 617, and is a rotation member provided to be rotatable about a rotation center axis 617b in the X direction. FIG. 26 shows a state in which the opening/closing member 617a is in an open state and the opening portion 670 is open. When the opening/closing member 617a is set in a closed state, as shown in FIG. 23, the opening portion 670 is closed.

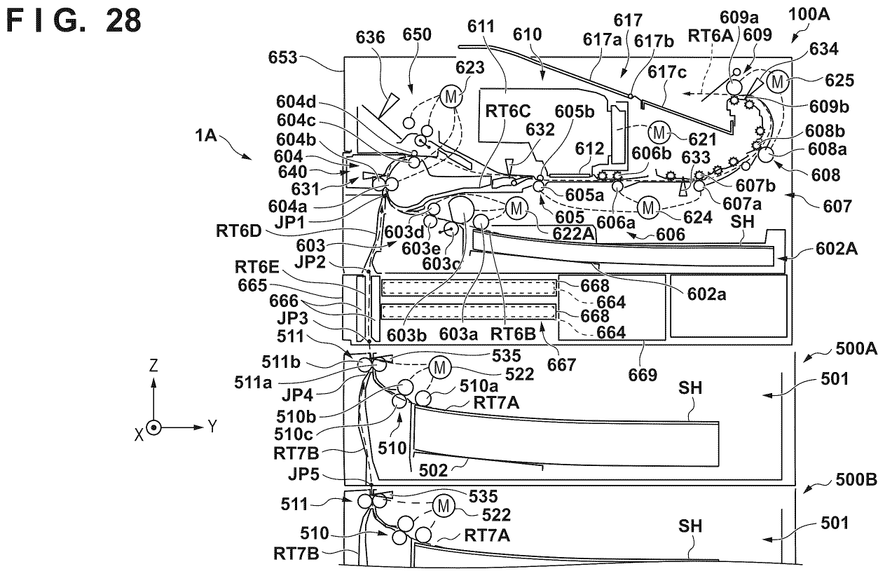

An opening portion 672 that is formed in the upper surface portion of the housing 601 and exposes the inside of the main body 100A of the printing apparatus 1A will be described with reference to FIGS. 23 and 27. The opening portion 672 is located on the far side in the Y direction with respect to the opening portion 670. The opening portion 672 is opened/closed by an opening/closing member 617c. In this embodiment, the opening/closing member 617c is a plate-shaped tray member that forms a part of the discharge tray 617 together with the opening/closing member 617a, and is extracted to the near side. When extracting the opening/closing member 617c, an operator can operate by holding a grip portion 617e. FIG. 27 shows a state in which the opening/closing member 617c is in an open state and the opening portion 672 is open. When the opening/closing member 617c is set in a closed state, as shown in FIG. 23, the opening portion 672 is closed.

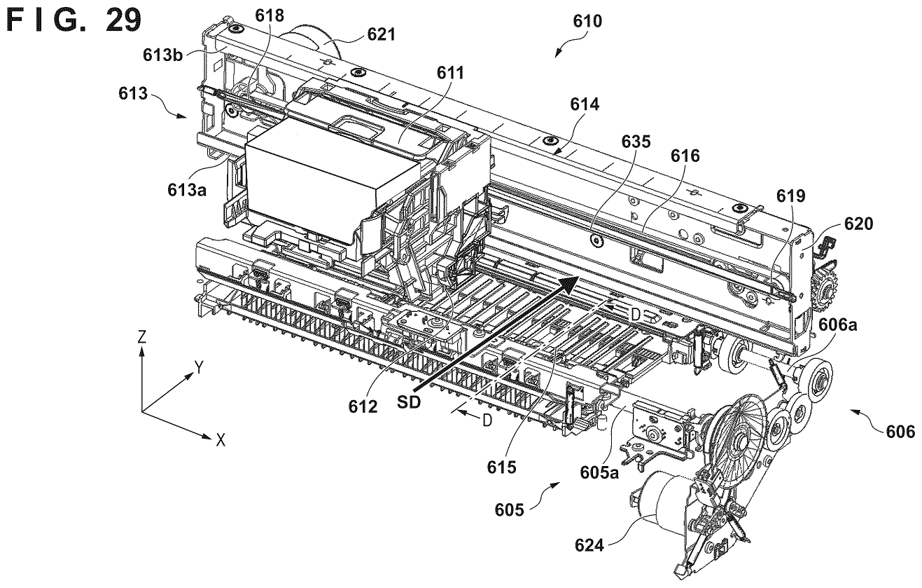

FIG. 28 is a schematic view of the internal structures of the printing apparatus 1A and the optional devices 500. The printing apparatus 1A performs printing on a sheet SH that is a print medium before printing stacked on a feeding tray 602a in the storage cassette 602A. In addition, the printing apparatus 1A discharges the printed sheet SH to the discharge tray 617. The storage cassette 602A can be detached from the main body 100A of the printing apparatus 1A, and the sheet SH can be set on the feeding tray 602a of the detached storage cassette 602A.

Also, the printing apparatus 1A performs printing on the sheet SH that is a print medium before printing stacked on a feeding tray 502 in each optional device 500. In addition, the printing apparatus 1A discharges the printed sheet SH to the discharge tray 617. A storage cassette 501 of each optional device 500 can be detached from the optional device 500, and the sheet SH can be set on the feeding tray 502 of the detached storage cassette 501.

### <Conveyance Path>

The conveyance path of the sheet SH will be described. The printing apparatus 1A includes conveyance paths RT6A to RT6E that guide the conveyance of the sheet SH. The conveyance path RT6A is a main conveyance path formed from a joining point JP1 to the discharge tray 617. The conveyance path RT6B is formed from the feeding tray 602a to the joining point JP1. When printing the sheet SH stored in the storage cassette 602A, the sheet SH is conveyed in the order of conveyance path RT6B→conveyance path RT6A, and printing is performed in the process of conveyance.

The conveyance paths RT6D and RT6E are conveyance paths configured to feed the sheet SH from the optional device 500. The conveyance path RT6D is formed in the Z direction at the front portion of the storage cassette 602A. When the storage cassette 602A is attached to the main body 100A, the conveyance path RT6D is formed from an intermediate point JP2 to the joining point JP1. The conveyance path RT6E is formed in the Z direction at the front portion of the opening/closing member 665. When the opening/closing member 665 is attached to the main body 100A, the conveyance path RT6E is formed from an intermediate point JP3 to the intermediate point JP2.

Each optional device 500 includes conveyance paths RT7A and RT7B that guide the conveyance of the sheet SH. The conveyance path RT7A is a conveyance path formed from the feeding tray 502 to a joining point JP4 in the storage cassette 501 and configured to feed the sheet SH in the optional device 500. The conveyance path RT7B is formed at the front portion of the storage cassette 501 from an intermediate point JP5 to the joining point JP4. The conveyance path RT7B is a conveyance path configured to pass the sheet SH fed from another optional device 500 located on the lower side of the optional device 500. For example, in the example shown in FIG. 28, the conveyance path RT7B of the optional device 500A is a path configured to pass, through the optional device 500A, the sheet SH fed from the optional device 500B.

When printing the sheet SH stored in the optional device 500A, the sheet SH is conveyed in the order of conveyance path RT7A of optional device 500A→conveyance path RT6E of printing apparatus 1A→conveyance path RT6D→conveyance path RT6A, and printing is performed in the process of conveyance.

When printing the sheet SH stored in the optional device 500B, the sheet SH is conveyed in the order of conveyance path RT7A of optional device 500B→conveyance path RT7B of optional device 500A→conveyance path RT6E of printing apparatus 1A→conveyance path RT6D→conveyance path RT6A. Printing is performed in the process of conveyance.

A path configured to invert the sheet SH and convey it to a printhead 612 for double-sided printing will be described next. In this embodiment, after the first surface of the sheet SH is printed by the printhead 612, the sheet SH is conveyed to the conveyance path RT6C, thereby inverting the sheet SH. The conveyance path RT6C is a sub conveyance path formed from the vicinity of a conveyance unit 605 to be described later to the joining point JP1. It is possible to invert the sheet SH with the printed first surface via the conveyance path RT6C and introduce it into the conveyance path RT6A. Then, printing can be performed for the second surface of the sheet SH.

Introduction of the sheet SH into the conveyance path RT6C is performed in the following way. After the trailing edge of the sheet SH reaches the vicinity of the conveyance unit 605 to be described later or exits from the conveyance unit 605, the rollers of at least some of the conveyance units 605 to 609 to be described later are rotated reversely. The sheet SH with the printed first surface can thus be introduced into the conveyance path RT6C. The sheet SH with the printed second surface is discharged to the discharge tray 617.

Note that each conveyance path is formed by path forming members. As an example of the path forming members, FIG. 28 schematically shows a pair of path forming members 666 that form the conveyance path RT6E. The pair of path forming members 666 are arranged to face each other in the Y direction, and the conveyance path RT6E extending in the Z direction is formed between these. Each conveyance path is defined by such path forming members.

### <Conveyance Mechanism>

A configuration for conveying the sheet SH will be described next. The printing apparatus 1A includes a feeding unit 603, a feeding unit 604, and the plurality of conveyance units 605 to 609. The feeding unit 603, the feeding unit 604, and the conveyance units 605 to 609 are arranged in this order from the upstream side to the downstream side in the conveyance direction of the sheet SH in the conveyance path RT6B and the conveyance path RT6A. Image formation (printing) for the sheet SH is performed by a printing unit 610 between the conveyance unit 605 and the conveyance unit 606.

### (Feeding Unit 603)

The sheet SH on the feeding tray 602a is introduced into the conveyance path RT6B and the conveyance path RT6A one by one by the feeding unit 603. The feeding unit 603 is a pickup mechanism that picks up the sheet SH from the feeding tray 602a using a feeding motor 622A as a driving source. The feeding unit 603 includes a feeding roller (pickup roller) 603a, a feeding roller 603b, a separation roller 603c, a feeding roller 603d, and a driven roller 603e that forms a nip with the feeding roller 603d.

The feeding roller 603a contacts the uppermost surface of the sheet SH stacked on the feeding tray 602a and is rotated by the driving force of the feeding motor 622A, thereby starting feeding the sheet SH. The feeding roller 603b that is rotated by the driving force of the feeding motor 622A and the separation roller 603c that forms a nip portion with the feeding roller 603b are arranged on the downstream side of the feeding roller 603a. The separation roller 603c is a roller that includes a torque limiter and has a rotational resistance. If two or more sheets SH enter the nip portion between the feeding roller 603b and the separation roller 603c, the sheet SH is separated one by one by the rotational resistance of the separation roller 603c.

The separated sheet SH is conveyed to the feeding roller 603d and the driven roller 603e on the downstream side. The feeding roller 603d uses the feeding motor 622A as the driving source.

### (Feeding Unit 604)

The feeding unit 604 conveys the sheet SH introduced from the joining point JP1 into the conveyance path RT6A to the conveyance unit 605. The feeding unit 604 includes feeding rollers 604a and 604c. The feeding rollers 604a and 604c are rotors that are rotated by the driving force of a feeding motor 623. The feeding rollers 604a and 604c are in pressure contact with corresponding driven rollers 604b and 604d to form nip portions. The driven rollers 604b and 604d are rotors following the rotation of the feeding rollers 604a and 604c.

The sheet SH is clamped in the nip portion between the feeding roller 604a and the driven roller 604b and the nip portion between the feeding roller 604c and the driven roller 604d and conveyed by the rotation of these.

Note that the feeding rollers 603a, 603b, and 603d are one-way rollers. For this reason, after the leading edge of the sheet SH is conveyed to a position beyond the nip portion of the feeding unit 604, the conveyance can be continued by the feeding unit 604 even if the driving of the feeding unit 603 is stopped.

The sensor 631 is a sensor that detects the sheet SH, and is a sensor that detects passage of the leading edge and the trailing edge of the sheet SH. The detection position of the sensor 631 is set to a position on the downstream side of the nip portion of the feeding unit 604. After passage of the leading edge of the sheet SH is detected, the detection result of the sensor 631 can be used as a trigger for conveyance control to, for example, stop driving of the feeding unit 603 or increase the conveyance speed of the feeding unit 604.

Also, using the sensor 631, the size of the sheet SH can be detected based on the driving amounts of the feeding motor 623 and a conveyance motor 624 from detection of the leading edge of the sheet SH to detection of the trailing edge, and subsequent conveyance control can be switched.

### (Conveyance Unit 605)

The conveyance unit 605 is arranged on the upstream side of the printhead 612. The conveyance unit 605 conveys the sheet SH to the downstream side between the printhead 612 and a platen 615 facing the printhead 612. The conveyance unit 605 includes a conveyance roller 605a, and a driven roller (pinch roller) 605b brought into pressure contact with the conveyance roller 605a by a spring (not shown) or the like. The conveyance roller 605a is a rotor that is rotated by the driving force of the conveyance motor 624, and the driven roller 605b is a rotor that rotates following the rotation of the conveyance roller 605a. The sheet SH is clamped in the nip portion between the conveyance roller 605a and the driven roller 605b, and conveyed by the rotation of the conveyance roller 605a and the driven roller 605b.

A sensor 632 is a sensor that detects the sheet SH, and is a sensor that detects passage of the leading edge and the trailing edge of the sheet SH, like the sensor 631. The sensor 632 is, for example, an optical sensor. Since the sensor 632 is arranged on the upstream side near the conveyance unit 605, the detection result can be used to manage the loop amount of registration of the sheet SH or the positions of the leading edge and the trailing edge of the sheet SH.

### (Conveyance Unit 606)

The conveyance unit 606 is arranged on the downstream side of the printhead 612 and conveys the sheet SH conveyed by the conveyance unit 605 up to the conveyance unit 609 on the downstream side. The conveyance unit 606 includes a conveyance roller 606a, and a spur 606b that is brought into pressure contact with the conveyance roller 606a by a spring (not shown) or the like. The conveyance roller 606a is a rotor that is rotated by the driving force of the conveyance motor 624, and the spur 606b is a rotor that rotates following the rotation of the conveyance roller 606a. In this embodiment, the conveyance unit 605 and the conveyance unit 606 share the driving source (conveyance motor 624).

### (Conveyance Unit 607)

The conveyance unit 607 is arranged on the downstream side of the printhead 612 and the conveyance unit 606 and conveys the sheet SH conveyed by the conveyance unit 606 to the downstream side. The conveyance unit 607 includes a conveyance roller 607a, and a spur 607b that is brought into pressure contact with the conveyance roller 607a by a spring (not shown) or the like. The conveyance roller 607a is a rotor that is rotated by the driving force of the conveyance motor 624, and the spur 607b is a rotor that rotates following the rotation of the conveyance roller 607a. The sheet SH is clamped in the nip portion between the conveyance roller 607a and the spur 607b and conveyed by the rotation of the conveyance roller 607a and the spur 607b.

A sensor 633 is, for example, an optical sensor and detects the sheet SH, like the sensors 631 and 632. The sensor 633 can be used to detect the leading edge and the trailing edge of the sheet SH or detect the presence/absence of the sheet SH in the conveyance path if a jam of the sheet SH occurs in the conveyance path.

### (Conveyance Units 608 and 609)

The conveyance units 608 and 609 are arranged on the downstream side of the printhead 612 and the conveyance units 606 and 607. The conveyance units 608 and 609 are discharging units that discharge the sheet SH conveyed by the conveyance unit 607 to the discharge tray 617. In single-sided printing, the sheet SH discharged to the discharge tray 617 is so-called “face-down discharge” in which an image printed surface faces down. In double-sided printing, the second surface faces down.

The conveyance unit 608 includes a conveyance roller 608a, and a spur 608b that is brought into pressure contact with the conveyance roller 608a by a spring (not shown) or the like. The conveyance roller 608a is a rotor that is rotated by the driving force of a conveyance motor 625, and the spur 608b is a rotor that rotates following the rotation of the conveyance roller 608a. The sheet SH is clamped in the nip portion between the conveyance roller 608a and the spur 608b and conveyed by the rotation of the conveyance roller 608a and the spur 608b.

The conveyance unit 609 includes a conveyance roller 609a, and a spur 609b that is brought into pressure contact with the conveyance roller 609a by a spring (not shown) or the like. The conveyance roller 609a is a rotor that is rotated by the driving force of the same conveyance motor 625 as that for the conveyance unit 608, and the spur 609b is a rotor that rotates following the rotation of the conveyance roller 609a. The sheet SH is clamped in the nip portion between the conveyance roller 609a and the spur 609b and conveyed by the rotation of the conveyance roller 609a and the spur 609b.

In this embodiment, the conveyance unit 608 and the conveyance unit 609 share the driving source (conveyance motor 625). However, the conveyance motor 625 may be eliminated, and the conveyance motor 624 that is the driving source for the conveyance units 605 to 607 may be shared by the conveyance unit 608 and the conveyance unit 609 as well.

Also, in this embodiment, four conveyance units (conveyance units 606 to 609) are used on the downstream side of the printhead 612. However, the number of conveyance units may be decreased in accordance with the conveyance-direction size of the corresponding print medium of the printing apparatus 1A. For example, only the conveyance unit 606 and the conveyance unit 609 may be left, and the conveyance unit 609 may discharge the sheet SH to the discharge tray 617.

A sensor 634 is a sensor that detects the sheet SH, and is a sensor that detects passage of the leading edge and the trailing edge of the sheet SH, like the sensors 631 to 633. The sensor 634 is, for example, an optical sensor. In this embodiment, after the trailing edge of the sheet SH is detected by the sensor 634, discharge is completed (the trailing edge of the sheet SH reaches the discharge tray 617) after a predetermined conveyance amount. Hence, the detection result of the sensor 634 can be used to detect discharge of the sheet SH.

The conveyance mechanism of the sheet SH provided in the optional device 500 will be described next. The sheet SH set on the feeding tray 502 is separated one by one by a feeding unit 510 in the optional device 500 and fed to the conveyance path RT7A. The feeding unit 510 is a pickup mechanism that picks up the sheet SH from the feeding tray 502 using a feeding motor 522 as a driving source. The feeding unit 510 includes a feeding roller (pickup roller) 510a, a feeding roller 510b, and a separation roller 510c.

A feeding unit 511 is located on the downstream side of the feeding unit 510, and includes a feeding roller 511a and a driven roller 511b. The feeding roller 511a is a rotor that is rotated by the driving force of the feeding motor 522, and the driven roller 511b is a rotor that rotates following the rotation of the feeding roller 511a.

The sheet SH is clamped in the nip portion between the feeding roller 511a and the driven roller 511b and conveyed by the rotation of the feeding roller 511a and the driven roller 511b.

The sheet SH conveyed by the feeding unit 511 of the optional device 500A passes through the top face side outlet of the optional device 500A and the intermediate point JP3 that is the conveyance path inlet on the bottom surface of the printing apparatus 1A and enters the conveyance path RT6E. The sheet SH is further conveyed to the joining point JP1 through the conveyance path RT6D.

The sheet SH conveyed by the feeding unit 511 of the optional device 500B passes through the top face side outlet of the optional device 500B and the intermediate point JP5 that is the conveyance path inlet on the bottom surface of the optional device 500A and enters the conveyance path RT7B. The sheet SH further passes through the conveyance path RT7B of the optional device 500A and is conveyed to the joining point JP1 through the conveyance path RT6D by the feeding unit 511 of the optional device 500A.

### <Printing Unit>

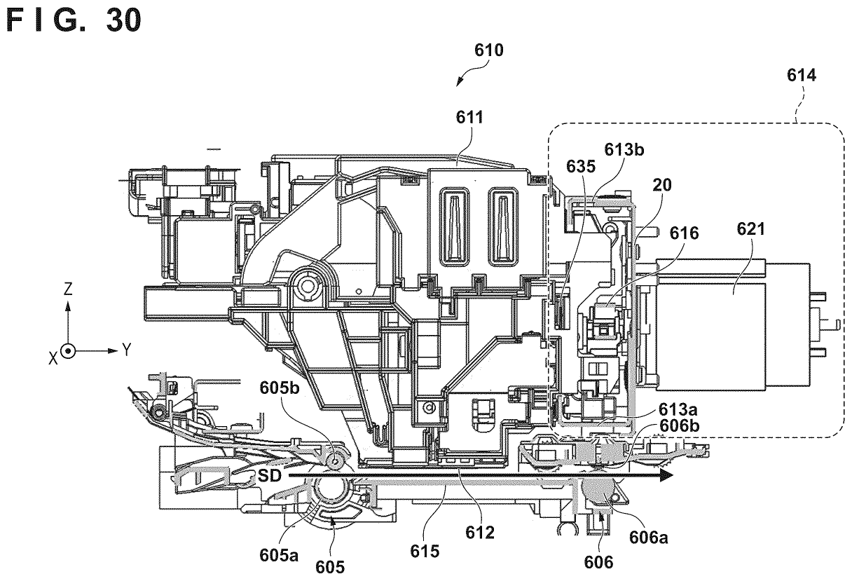

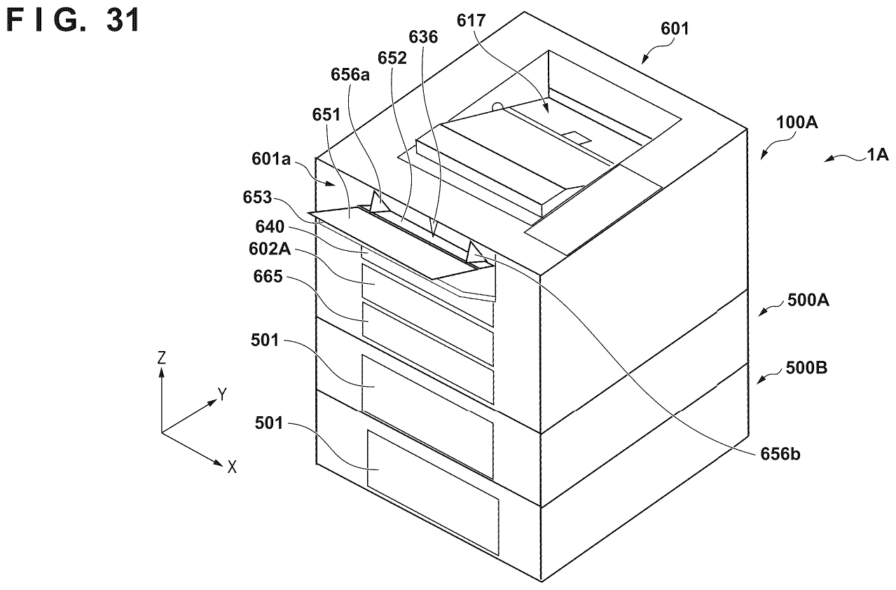

The printing unit 610 according to this embodiment will be described with reference to FIGS. 29 and 30 in addition to FIG. 28. FIG. 29 is a perspective view of the printing unit 610, and FIG. 30 is a sectional view taken along a line D-D in FIG. 29. The printing unit 610 includes the printhead 612, a carriage 611, and a driving unit 614. The printhead 612 discharges liquid ink to the sheet SH, thereby printing an image on the sheet SH. The lower surface of the printhead 612 forms a discharge surface in which a plurality of nozzles for discharging ink are formed.

The ink to be supplied to the printhead 612 is stored in a container 664. The container 664 is supported by a tray 668 and stored in a storage unit 667. The ink in the container 664 is supplied to the printhead 612 via an intermediate tank provided in a replenishing unit 669. The container 664, the tray 668, the storage unit 667, and the replenishing unit 669 have the same configurations as the container 60, the tray 6, the storage unit 4, and the replenishing unit 8 according to the first embodiment.

The opening/closing member 665 is the same member as the opening/closing member 5 described in the first embodiment. The opening/closing member 665 includes the pair of path forming members 666 and forms a conveyance path. When the opening/closing member 665 is detached from the main body 100A, the access path to the storage unit 667 is opened to enable exchange of the container 664.

The platen 615 is arranged to face the printhead 612 (particularly, the discharge surface) between the conveyance unit 605 and the conveyance unit 606. The sheet SH is conveyed in a direction of an arrow SD (+Y direction) between the printhead 612 and the platen 615, and the printhead 612 prints an image.

The printhead 612 is mounted on the carriage 611. The carriage 611 is reciprocally moved in a direction (in this embodiment, the X-axis direction) crossing the direction SD by the driving unit 614.

The driving unit 614 includes a support member 620 extended in the X-axis direction. The support member 620 is a base member that supports the components of the driving unit 614. The support member 620 is provided with a guide member 613 that engages with the carriage 611 and guides the movement of the carriage 611. In this embodiment, the guide member 613 includes a rail member 613a on the lower side and a rail member 613b on the upper side. The rail members 613a and 613b are apart in the Z-axis direction and are extended in the X-axis direction. The rail members 613a and 613b engage with the carriage 611 and guide the movement of the carriage 611. Note that the guide member 613 may be a member having a shaft form.

The rail member 613a supports the carriage 611 in the height (Z) direction and the front/rear (Y) direction. When the height (Z) of the rail member 613a is adjusted with respect to the support member 620, the height (Z position) of the printhead 612 (particularly, the discharge surface) with respect to the platen 615 can be adjusted. The rail member 613b is located above (+Z direction) the rail member 613a, and restricts the position of the carriage 611 about the X-axis. When the rail member 613b is adjusted with respect to the support member 620 in the front/rear (Y) direction, the tilt of the printhead 612 about the X-axis with respect to the platen 615 can be adjusted.

The driving unit 614 according to this embodiment is a belt transmission mechanism using a carriage motor 621 as a driving source. However, the driving unit 614 may be of a mechanism type other than the belt transmission mechanism. The carriage motor 621 is arranged on the opposite side of the carriage 611 in the front/rear (Y) direction across the support member 620. The driving unit 614 includes a driving pulley 618 and a driven pulley 619, which are apart in the X-axis direction, and an endless belt 616 wound around these pulleys. These are arranged between the rail member 613a and the rail member 613b in the height (Z) direction.

The carriage 611 is fixed to the endless belt 616. When the carriage motor 621 rotates the driving pulley 618, the endless belt 616 travels, and the carriage 611 moves. A cord strip 635 is supported by the support member 620. A sensor (not shown) that detects the slit of the cord strip 635 is provided on the carriage 611, and it is therefore possible to specify the position of the carriage 611 in the X-axis direction or adjust the speed based on the detection result of the sensor.

An electrical contact between the printhead 612 and a board (not shown) is provided on the carriage 611. The board (not shown) may be arranged on the downstream side (+Y direction) of the printhead 612 in the conveyance direction and between the carriage 611 and the support member 620.

An image printing operation will be described next. In the process of reciprocal movement of the carriage 611 in the X-axis direction, ink is discharged from the printhead 612 to the sheet SH, thereby printing an image. This operation is called print scanning. The printing operation is performed by alternately repeating a conveyance operation of intermittently conveying the sheet SH in the direction SD by the conveyance unit 605 and print scanning.

### <Front Feeding Mechanism>

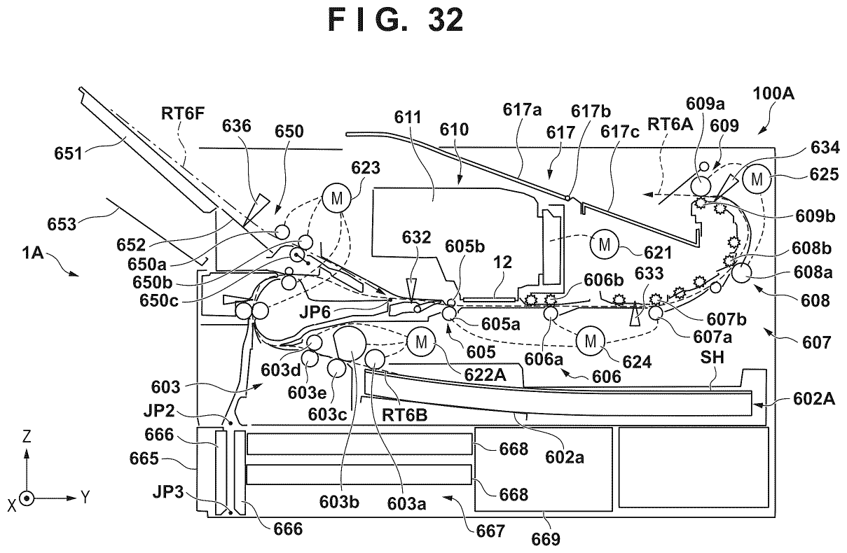

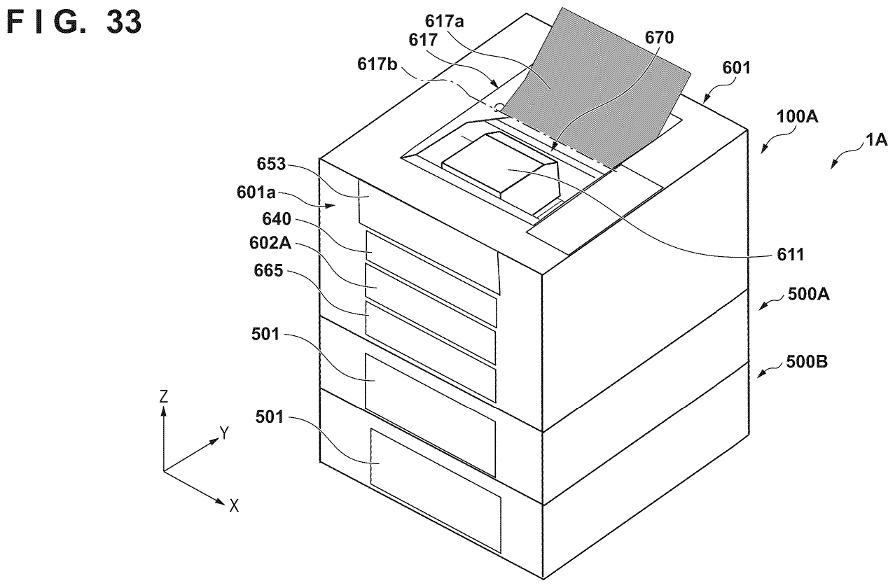

The front feeding mechanism of the printing apparatus 1A will be described with reference to FIGS. 31 and 32. By the front feeding mechanism, the sheet SH can manually be supplied from the front side of the printing apparatus 1A. FIG. 31 is a view showing a state in which the cover 653 and a stacking tray 651 are extracted from the state shown in FIG. 23. FIG. 32 is a schematic view of the internal structure of the printing apparatus 1A, and is a schematic view of a state in which the cover 653 and the stacking tray 651 are extracted.

In this embodiment, in addition to the already described storage cassette 602A, a feeding unit 650 is arranged on the upper side of the storage cassette 602A and the detachable unit 640 in the Z direction (+Z direction) and on the side of the front surface 601a of the printing apparatus 1A. FIG. 23 shows a state in which the stacking tray 651 is closed, and FIG. 31 shows a state in which the stacking tray 651 is opened. In the state in which the stacking tray 651 is closed, a plurality of trays are folded and stored inside. In the state in which the stacking tray 651 is open, the plurality of folded trays are unfolded to such a length that can hold the stacked sheet SH without dropping it.

A feeding tray 652 exists deep in the opened stacking tray 651, and the stacked sheet SH is held by both the stacking tray 651 and the feeding tray 652. There is provided a sensor 636 that detects whether the sheet SH is stacked on the feeding tray 652.

The sensor 636 is a sensor that detects the sheet SH, and is, for example, an optical sensor. The sensor 636 detects the presence/absence of the sheet SH on the feeding tray 652 and can also be formed by, for example, a reflection sensor. In addition, side guides 656a and 656b configured to support the stacked sheet SH in the widthwise direction are attached to the left and right sides of the feeding tray 652. The left and right side guides 656a and 656b are connected by a rack & pinion (not shown). If the user operates one of the side guides, the side guide on the opposite side moves interlocking, and the left and right edges of the sheet SH can be supported.

The arrangement of the feeding unit 650 and the conveyance path RT6F will be described next. The feeding unit 650 includes a feeding roller 650a to be pressed against the sheet SH stacked on the feeding tray 652. A conveyance roller 650b and a separation roller 650c are provided on the downstream side of the feeding roller 650a. The feeding roller 650a and the conveyance roller 650b are driven using the feeding motor 623 as a driving source. The sheet SH set on the feeding tray 652 is picked up by the feeding roller 650a, separated one by one by the nip portion between the conveyance roller 650b and the separation roller 650c, and fed to the conveyance path RT6A. The sheet SH fed from the feeding unit 650 joins the conveyance path RT6A at a joining point JP6, and is conveyed to the conveyance unit 605. After that, the sheet SH is conveyed by the conveyance unit 605, and an image is printed on it by the printhead 612.

### <Layout of Components Around Printhead>

FIGS. 29 and 30 will be referred to. The sheet SH may cause a jam around the printhead 612. The driving unit 614 is a structure having the support member 620 fixed like a wall member on the X-Z plane. Depending on the arrangement of the driving unit 614, the driving unit 614 of the carriage 611 readily becomes an obstacle when considering the accessibility of the operator to the point of jam.

In this embodiment, the driving unit 614 is arranged on the downstream side (+Y direction) in the conveyance direction (direction SD) with respect to the printhead 612. The space on the upstream side of the printhead 612 is wide, and the accessibility of the operator to the upstream side of the printhead 612 is improved. As the form of a jam, the leading edge portion of the sheet SH is often jammed between the printhead 612 and the platen 615. Hence, since it is easy for the operator to work from the upstream side of the printhead 612, a recovery work can be performed more smoothly.

When viewed in the front/rear direction (Y direction) of the printing apparatus 1A, the conveyance unit 605 is arranged on the front side (−Y direction side) with respect to the printhead 612, and the driving unit 614 is arranged on the rear side (+Y direction side) with respect to the printhead 612. As for the installation place of the printing apparatus 1A, in many cases, the space on the front side of the printing apparatus 1A is wide, and the space on the rear side is narrow due to the presence of a wall or the like. In this embodiment, the space on the front side of the printhead 612 is wide. Hence, if a jam occurs, the operator can easily perform the recovery work from the front side of the printing apparatus 1A.

Also, in this embodiment, the feeding unit 604 is arranged on the front side of the conveyance unit 605. Even if a jam occurs between the feeding unit 604 and the conveyance unit 605, the operator can easily perform the recovery work from the front surface 601a of the printing apparatus 1A.

<Structure Associated with Maintenance>

### <Maintenance Around Printhead>

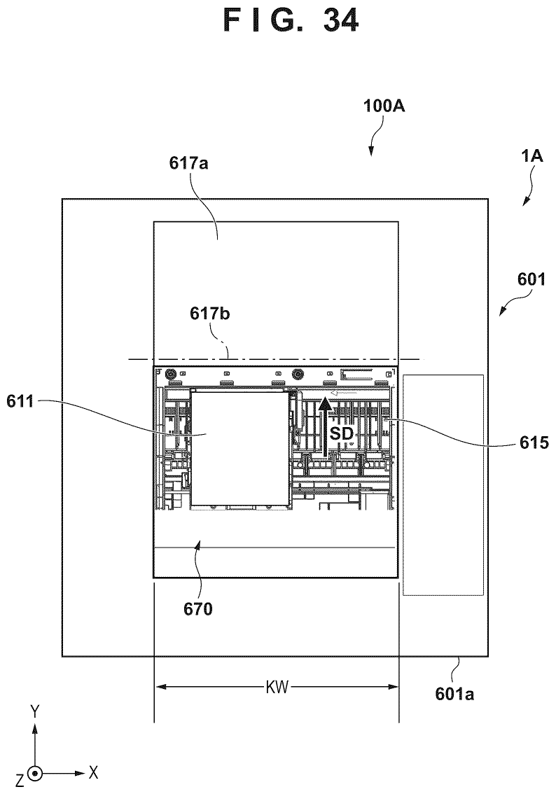

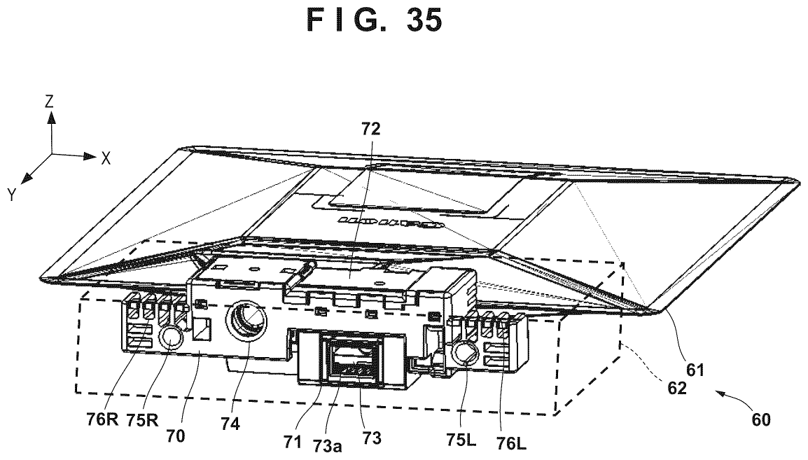

The printing apparatus 1A according to this embodiment has a structure that facilitates maintenance (access) to the printing unit 610. This will be described with reference to FIGS. 26, 27, 33, and 34. FIG. 33 is a view showing the outer appearance of the printing apparatus 1A in which the opening/closing member 617a is in the open state, and FIG. 34 is a plan view of the printing apparatus 1A in which the opening/closing member 617a is in the open state.

Examples of maintenance to the printing unit 610 are the above-described recovery of jam and exchange of the printhead 612.

Of the opening portion 670, a portion on the upstream side (−Y direction side) of the printhead 612 in the conveyance direction (direction SD) is formed to be exposed more than a portion on the downstream side (+Y direction side). The opening/closing member 617a is arranged on the upper side (+Z direction) of the conveyance unit 605. If the opening/closing member 617a is set in the open state, the conveyance unit 605, the carriage 611, the printhead 612, the platen 615, and the like are exposed via the opening portion 670, and the operator can access these. In this embodiment, since the driving unit 614 is arranged on the downstream side (+Y direction side) of the printhead 612 in the conveyance direction, the operator can easily access the conveyance unit 605, the carriage 611, the printhead 612, the platen 615, and the like from the front side of the printing apparatus 1A.

As shown in FIG. 34, defining the width of the opening portion 670 in the X direction as KW, the width KW is larger than the maximum width of the sheets SH supported by the printing apparatus 1A. Hence, if the sheet SH causes a jam, the sheet SH can readily be removed from the opening portion 670.

### Fifth Embodiment

### <Configuration of Container>

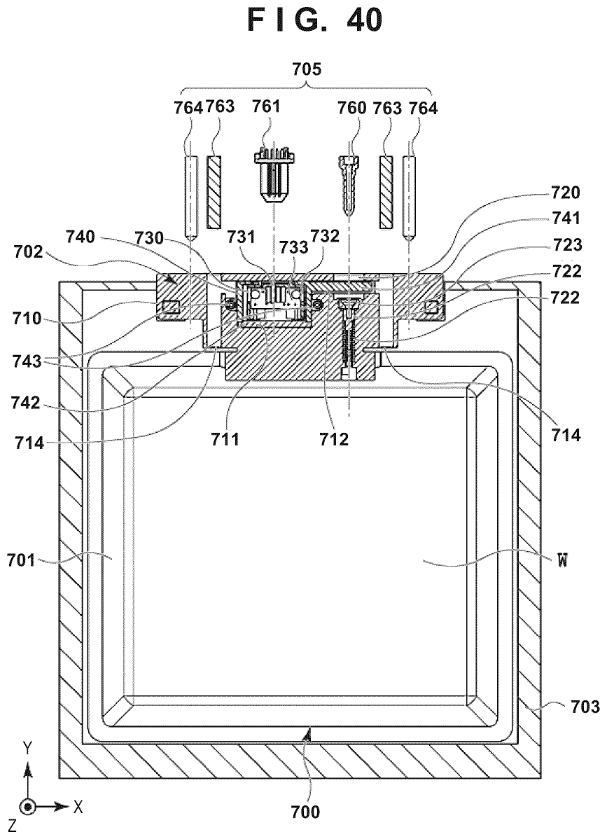

An example of the configuration of a container will be described. FIG. 39 is a perspective view showing the schematic configuration of a container 700. The container 700 is used as an ink pack in combination with a tray 703. In other words, the container 700 according to the fifth embodiment is also called an ink pack. The container 700 is stored/supported in the tray 703 and, in this state, detachably attached to the storage portion 4 of the main body 100. The tray 703 is a storage portion configured to store/support the container 700 (ink pack) in a predetermined posture. The storage portion 4 is an attachment portion of the main body 100 to which the container 700 is detachably attached. A tray slide portion 750 extending the Y direction is formed on a side portion of the tray 703. The tray slide portion 750 engages a slide groove (not shown) formed in the storage portion 4 such that it can slidably move. In a state in which the tray slide portion 750 engages with the slide groove, the user can move the tray 703 storing/supporting the container 700 to the storage portion 4.

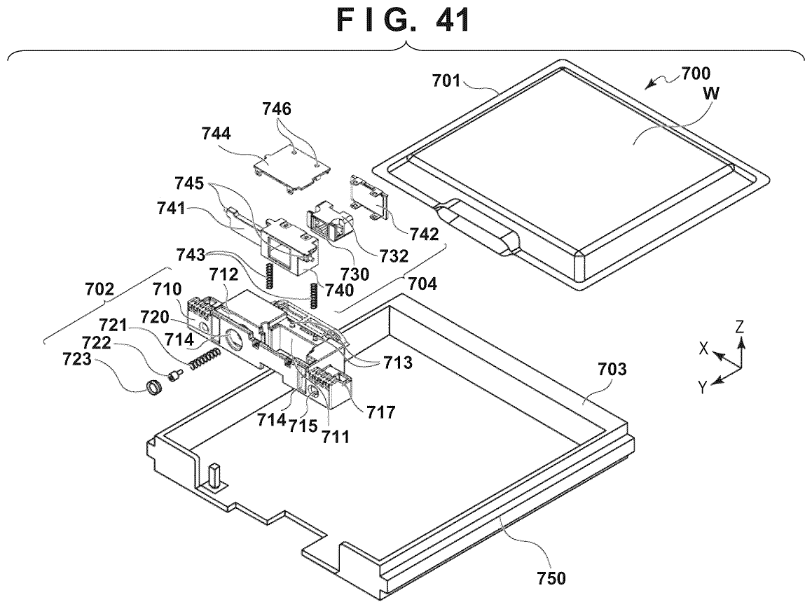

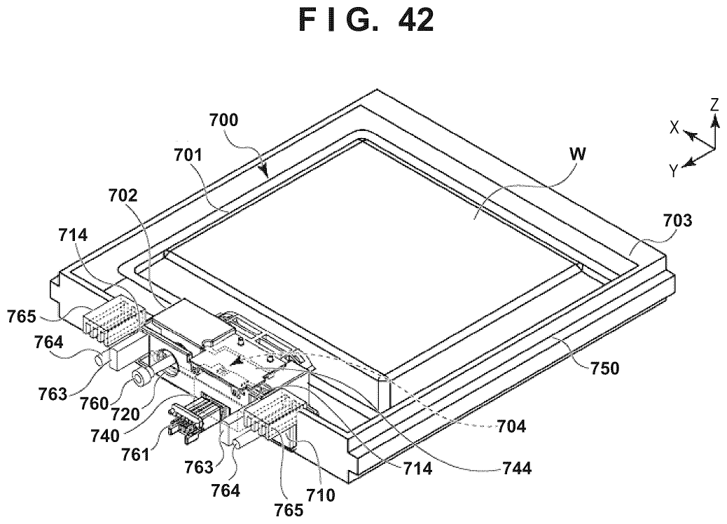

FIG. 39 is a perspective view showing the schematic configuration of the container 700 according to the fifth embodiment. FIG. 40 is a sectional view of the container 700 viewed from the +Z direction. FIG. 41 is an exploded perspective view of the container 700.

The elements of the container 700 will be described with reference to FIGS. 39 to 41. As described above, the container 700 is used as an ink pack in combination with the tray 703. The container 700 includes a liquid storage portion (bag body) 701, a liquid feeding portion 702, and an opening/closing door 704.

The liquid storage portion 701 is formed into a bag shape capable of storing a liquid inside. For example, an ink W (see FIG. 6 to be described later) is stored as a liquid in the liquid storage portion 701. Note that in FIGS. 39 to 43, the ink W is simplified. The liquid storage portion 701 preferably has flexibility such that it can have a flat shape when the ink W is used up. “Having flexibility” in each embodiment means that a member is flexible and bendable.

Any known material can be used as the material of the liquid storage portion 701 if it can store a liquid inside, and the material has flexibility. More specifically, as the material of the liquid storage portion 701, a resin film using a resin such as polyethylene terephthalate (PET), polyamide (PA), polyethylene (PE), or polypropylene (PP) can be used. The material of the resin film used for the liquid storage portion 701 is preferably a resin having a high liquid contact property to the ink W so that the ink W can be stored for a long time. Note that the liquid contact property indicates the stability of a member (resin film) that contacts the liquid (ink). Examples of the liquid contact property in this embodiment are such properties that the resin film used for the liquid storage portion 701 is not degraded by ink and eluted components from the resin film do not change the property of the ink.

A laminated film function-separated in accordance with various kinds of required performance is used for the liquid storage portion 701. For the liquid storage portion 701, a coating film or a deposition film obtained by adding a gas barrier property and water barrier property to a resin film may be used. For the liquid storage portion 701, a laminated film formed by stacking paper or an aluminum foil on a resin film may be used. From the viewpoint of storing a liquid, the material of the liquid storage portion 701 is preferably a material capable of suppressing evaporation of water in the liquid. As the material capable of suppressing evaporation of water in the liquid, an aluminum foil is preferably used. That is, the liquid storage portion 701 having flexibility is preferably formed by stacking an aluminum foil on a resin film. The film thickness of the laminated film used for the liquid storage portion 701 is preferably 100 μm or more and 220 μm or less. Note that a laminated film formed by stacking a plurality of layers need not always be used for the liquid storage portion 701. For example, for an application purpose for which the gas barrier property is not important, a resin film of a single layer may be used for the liquid storage portion 701.

The liquid storage portion 701 preferably has a bag shape. As the manufacturing method of the liquid storage portion 701, a known method can be used. More specifically, two films are overlaid, and the peripheral edge portions of the films are bonded to each other, thereby forming the liquid storage portion 701 having a bag shape. Note that the liquid storage portion 701 is also called a four-side sealed bag. The bag shape of the liquid storage portion 701 formed by such a method can be of either a pillow type or a gazette type.

In accordance with the capacity of the liquid storage portion 701, an appropriate bag size and bag shape are used. For example, the bag shape of the liquid storage portion 701 having a capacity of 1.5 L is a gazette type in which the long side is about 374 mm long, the short side is about 180 mm long, and the width of each gazette portion provided on a side surface in the longitudinal direction is about 46 mm. The bag shape of the liquid storage portion 701 having a capacity of 3.0 L is a gazette type in which the long side is about 374 mm long, the short side is about 240 mm long, and the width of each gazette portion provided on a side surface in the longitudinal direction is about 80 mm.

The liquid feeding portion 702 is provided at one end portion of the liquid storage portion 701. Depending on the bag shape of the liquid storage portion 701, the distance between the liquid feeding portion 702 and the other end portion of the liquid storage portion 701 is long. In a case where a liquid outlet pipe and a spacer member are not arranged in the liquid storage portion 701, if the liquid stored in the liquid storage portion 701 is consumed, portions facing each other in the liquid storage portion 701 may adhere to each other. When the portions facing each other in the liquid storage portion 701 adhere to each other, the channel of the liquid to the liquid feeding portion 702 may be clogged. Hence, in the liquid storage portion 701, a rib portion (not shown) projecting inside the liquid storage portion 701 is preferably formed. Since the rib portion projecting inside the liquid storage portion 701 makes it difficult for the portions facing each other in the liquid storage portion 701 to adhere to each other, it is possible to suppress clogging of the channel of the liquid to the liquid feeding portion 702. Hence, the channel of the liquid to the liquid feeding portion 702 can be ensured, and the liquid stored in the liquid storage portion 701 can completely be used up.

The rib portion is preferably formed by deforming a part of the liquid storage portion 701 by an air pressure method, a press method, a vacuum method, or the like. The rib portion is preferably formed on the upper side of the container 700 in an attachment posture when attached to the main body 100. The rib portion may be formed on the upper and lower sides of the container 700 in the attachment posture when attached to the main body 100. Also, the rib portion is preferably formed to cross a virtual line extended from the center axis of a liquid flow hole 720. If it is possible to ensure the channel of the liquid to the liquid feeding portion 702, the rib portion can be formed at any portion of the liquid storage portion 701.

Note that the structure for ensuring the channel of the liquid to the liquid feeding portion 702 is not limited to the rib portion. For example, to ensure the channel of the liquid to the liquid feeding portion 702, a structure may be arranged in the liquid storage portion 701. To ensure the channel of the liquid to the liquid feeding portion 702, the rigidity may be changed between portions of a film that forms the liquid storage portion 701.

As described above, the liquid feeding portion 702 is provided at one end portion of the liquid storage portion 701. The liquid feeding portion 702 feeds the ink W stored in the liquid storage portion 701 to the outside. The liquid feeding portion 702 includes a spout 710, a valve compression spring 721, a valve 722, and a joint seal (seal member) 723. The spout 710 is formed into a block shape by molding. Note that the spout 710 may be formed not by molding but by cutting or the like. A plurality of components such as the valve compression spring 721, the valve 722, and the joint seal 723 are assembled to the spout 710. The spout 710 with the components assembled thereto is connected to the liquid storage portion 701 by heat welding (thermocompression). The structure of the connecting portion between the spout 710 and the liquid storage portion 701 is an airtight structure. Examples of the material of the spout 710 are resins such as polyethylene and polypropylene. The material of the spout 710 is preferably a resin having a high liquid contact property to the ink W, like the liquid storage portion 701. The material of the spout 710 preferably has a high heat welding property and moldability. When the heat welding property between the components is taken into consideration, the material of the spout 710 is preferably the same as the material of the welding portion in the liquid storage portion 701.

An opening/closing door guide 711, a slit 712, a slot 714, positioning holes 715, and the liquid flow hole (liquid supply opening) 720 are formed inside the spout 710. Groove-shaped mechanical IDs 717 are formed outside the spout 710. An opening/closing door main body 740 and a board holder cover 742 of the opening/closing door 704 are inserted into the opening/closing door guide 711. A liquid flow hole front wall 741 of the opening/closing door 704 is inserted into the slit 712. A cam plate 763 provided on the storage portion 4 can be inserted into the slot 714. A positioning pin 764 provided on the storage portion 4 can be inserted into the positioning hole 715. An ink needle 760 provided on the storage portion 4 can be inserted into the liquid flow hole 720. The mechanical ID 717 can engage with a rib-shaped mechanical ID receiver 765 provided on the storage portion 4.

The cam plates 763, the positioning pins 764, the mechanical ID receivers 765, the ink needle 760, and a connector 761 to be described later form an attachment portion side connecting element 705 configured to connect the liquid feeding portion 702 of the container 700 to the storage portion 4 (attachment portion). The cam plate 763 is a moving force imparting portion configured to give a moving force to the opening/closing door main body 740. The positioning pin 764 is a member configured to perform positioning of the liquid feeding portion 702 with respect to the storage portion 4. The mechanical ID receiver 765 is a member configured to attach the container 700 that should be attached to the storage portion 4. The ink needle 760 is a liquid receiving portion configured to receive the liquid (ink) fed from the liquid feeding portion 702.

The liquid flow hole 720 is a channel communicating with the inside of the liquid storage portion 701 and the outside of the container 700 (liquid storage portion 701) in the spout 710. If the liquid flow hole 720 is connected to the ink needle 760 of the main body 100, the ink W stored in the liquid storage portion 701 is supplied to the main body 100 via the liquid flow hole 720 of the spout 710 and the ink needle 760. The liquid flow hole 720 corresponds to a liquid supply opening that is connected to the ink needle (liquid receiving portion) 760 and can thus supply the liquid stored in the liquid storage portion 701 to the printing apparatus main body. The valve compression spring 721, the valve 722, and the joint seal 723 are inserted into the liquid flow hole 720.

The valve compression spring 721 is formed using a metal such as stainless steel. The material of the valve compression spring 721 is preferably a metal having a high liquid contact property and corrosion resistance to the ink W. The valve 722 is formed into a columnar shape by molding. Note that the valve 722 may be formed not by molding but by cutting or the like. Examples of the material of the valve 722 are resins such as polyethylene and polypropylene. The material of the valve 722 is preferably a resin having a high liquid contact property to the ink W, like the spout 710. The joint seal 723 is formed into a tubular shape using a rubber material such as ethylene propylene diene rubber (EPDM) or hydrogenated nitrile rubber (H-NBR), or thermoplastic elastomer. The material of the joint seal 723 is preferably a resin having a high liquid contact property and corrosion resistance to the ink W.

The valve compression spring 721 gives a biasing force for moving the valve 722 toward the joint seal 723 in the +Y direction. By the biasing force of the valve compression spring 721, the valve 722 contacts the joint seal 723 and closes the channel of the ink W. The joint seal 723 is fixed to the liquid flow hole 720 such that it is not removed from the liquid flow hole 720 even if the biasing force of the valve compression spring 721 acts. The joint seal 723 is fixed to the inner peripheral portion of the liquid flow hole 720 by a fixing method such as rubber lining or adhesion. The joint seal 723 may be fixed to the liquid flow hole 720 by welding a retaining component to the outer peripheral portion of the joint seal 723. In a non-attached state in which the container 700 is not attached to the storage portion 4 of the main body 100, the valve 722 is moved in the +Y direction by the biasing force of the valve compression spring 721, and the channel of the ink W is thus closed. When the valve 722 closes the channel of the ink W, a flow of air into the liquid storage portion 701 and leakage of the ink W from the inside of the liquid storage portion 701 are suppressed. When the container 700 is attached to the storage portion 4, the ink needle 760 of the storage portion 4 abuts against the valve 722, and the valve 722 moves in the −Y direction against the biasing force of the valve compression spring 721, thereby opening the channel of the ink W.

Note that a check valve may be provided on the side of the liquid storage portion 701 with respect to the valve 722 in the liquid flow hole 720. The check valve restricts the flow of the liquid from the outside of the container 700 to the inside of the liquid storage portion 701. This makes it possible to suppress a flow of air into the liquid storage portion 701, unexpected leakage of the ink W, and a backflow of the ink W. A film member that closes the liquid flow hole 720 may be welded to the distal end side (+Y direction side) of the liquid flow hole 720. The film member is broken through by the ink needle 760 when the container 700 is attached to the storage portion 4. This can improve the gas barrier property of the container 700 in the non-attached state. This can also suppress mixing of a foreign substance from the outside of the container 700 into the ink stored in the liquid storage portion 701.

Note that in this embodiment, a half-cut processing (partial cutting) may be formed in the film member. When the half-cut is formed, the film is readily broken by a relatively small force when the film is broken through by the needle. If no half-cut is formed, and the film cannot easily be broken through, the film may be broken such that it is punched out. At this time, a fragment of the film punched through may be sandwiched between the needle and the joint seal, and a gap may be generated in the seal portion. As a result, the ink may leak. Hence, a half-cut is formed, thereby reliably and smoothly breaking the film and suppressing generation of a fragment. This ensures the sealing property in the seal portion and prevent the ink from leaking. Also, since the half-cut is formed by cutting only a part of the thickness of the film, the whole structure of the film is maintained, and the gas barrier property of the liquid container does not lower.

The opening/closing door 704 is a moving member configured to be relatively movable with respect to the spout 710. The opening/closing door 704 includes the opening/closing door main body 740, a circuit board (electrical connecting portion) 730, a board holder 732, and the board holder cover 742. The opening/closing door main body 740 is formed, by molding, into a box shape having opening portions provided in wall portions on the +Y direction sides. Note that the opening/closing door main body 740 may be formed not by molding but by cutting or the like. The opening/closing door main body 740 is preferably formed using a fluorine resin having a high slidability, or a resin such as polyacetal or polyamide. This can reduce the frictional force generated between the opening/closing door main body 740 and the opening/closing door guide 711 of the spout 710. The opening/closing door main body 740 stores the circuit board 730 and the board holder 732 inside.

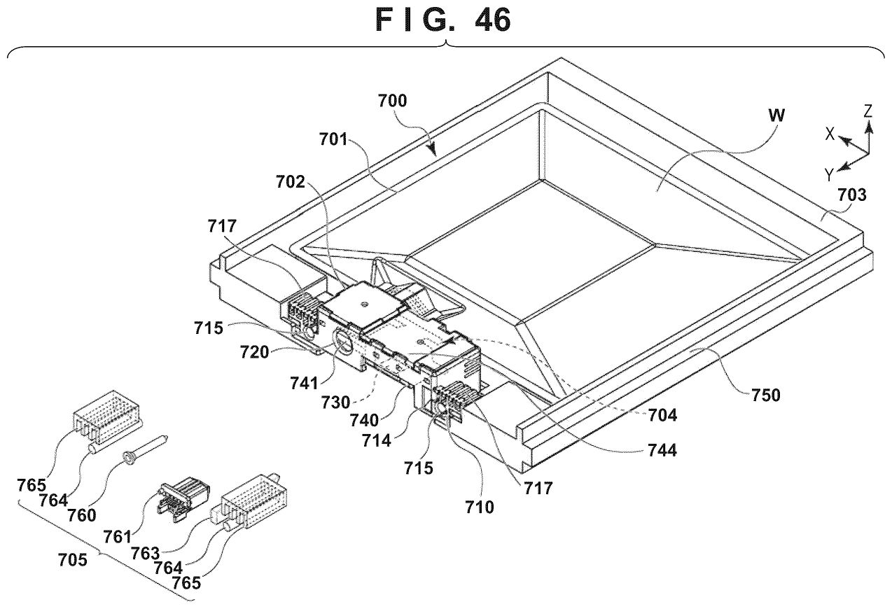

An integrated circuit (IC) that stores information such as the color information, material, and ink amount of the ink W in the container 700 is implemented on the circuit board 730. The circuit board 730 is an electrical connecting portion including a connecting surface 733 provided with a plurality of pad electrodes 731. The pad electrodes 731 of the circuit board 730 are electrically connected to an electrical contact 762 (see FIG. 45 to be described later) of the connector 761 provided on the storage portion 4 in an attached state in which the container 700 is attached to the storage portion 4. The information recorded in the integrated circuit (IC) of the circuit board 730 can thus be read out from the circuit board 730 to the main body 100. The circuit board 730 is assembled to the bottom portion of the board holder 732 by a fixing method such as heat caulking, screw fastening, or adhesion such that the connecting surface 733 faces the +Z direction.

The board holder 732 is formed, by molding, into a box shape having an opening portion provided in a wall portion on the +Y direction side. Note that the board holder 732 may be formed not by molding but by cutting or the like. The board holder 732 supports the circuit board 730 on the bottom portion. The board holder 732 is arranged in the internal space of the opening/closing door main body 740 together with the circuit board 730. The internal space of the opening/closing door main body 740 is formed by the opening/closing door main body 740 and the board holder cover 742.

The board holder cover 742 is formed into a plate shape by molding. Note that the board holder cover 742 may be formed not by molding but by cutting or the like. Like the opening/closing door main body 740, the board holder cover 742 is preferably formed using a fluorine resin having a high slidability, or a resin such as polyacetal or polyamide. The board holder cover 742 is assembled to the wall portion of the opening/closing door main body 740 on the −Y direction side by a fixing method such as fitting using snap fit, heat welding, or adhesion. The board holder cover 742 closes the opening portion of the opening/closing door main body 740 on the −Y direction side and restricts removal of the board holder 732 from the internal space of the opening/closing door main body 740.

A predetermined clearance is formed between the board holder 732 arranged in the internal space of the opening/closing door main body 740 and the opening/closing door main body 740. In the internal space of the opening/closing door main body 740, the board holder 732 can thus move in the range of the clearance. In other words, the arrangement of the board holder 732 with the circuit board 730 assembled thereto can be equalized, and the circuit board 730 is arranged to be relatively movable in the container 700. When attaching the container 700 to the storage portion 4, the circuit board 730 can move to an appropriate position to be connected to the connector 761, and excellent electrical connection between the circuit board 730 and the connector 761 is reliably performed. Hence, the position accuracy of the circuit board 730 with respect to the connector 761 need not be made high, and electrical connection between the circuit board 730 and the connector 761 can stably be performed.

As shown in FIGS. 39 to 41, the opening/closing door main body 740 and the board holder cover 742 of the opening/closing door 704 are inserted into the opening/closing door guide 711 of the spout 710 together with the board holder 732 with the circuit board 730 assembled thereto. Also, the liquid flow hole front wall 741 is formed on a side portion of the opening/closing door main body 740 on the +X direction side. When the opening/closing door main body 740 and the board holder cover 742 are inserted into the opening/closing door guide 711 of the spout 710, the liquid flow hole front wall 741 is inserted into the slit 712 of the spout 710. The liquid flow hole front wall 741 inserted into the slit 712 of the spout 710 can cover the distal end side (+Y direction side) of the liquid flow hole 720. The opening/closing door guide 711 of the spout 710 includes a groove-shaped guide surface that guides the opening/closing door 704 such that it can move in the up/down direction (Z direction). In addition to the opening/closing door 704, opening/closing door compression springs 743 are inserted into the opening/closing door guide 711. A retaining cover 744 is arranged at the top portion of the opening/closing door guide 711. In the non-attached state in which the container 700 is not attached to the storage portion 4 of the main body 100, the opening/closing door main body 740 abuts against the retaining cover 744 by the biasing force of the opening/closing door compression springs 743.

The retaining cover 744 is formed into a plate shape by molding. The retaining cover 744 is fixed to the spout 710 and prevents the opening/closing door main body 740 and the board holder cover 742 from being removed from the opening/closing door guide 711 of the spout 710. The retaining cover 744 is fixed to the spout 710 by a fixing method such as snap fit, heat welding, or screw fastening. For example, the retaining cover 744 may be fixed to the spout 710 by snap fit. In this case, caulking bosses 713 are provided on the spout 710, and caulking holes 746 are provided in the retaining cover 744. The caulking bosses 713 and the caulking holes 746 engage with each other to assemble the retaining cover 744 to the spout 710, and in this state, heat caulking is performed. This can increase the reliability of retaining of the opening/closing door 704 by the retaining cover 744.

In the non-attached state in which the container 700 is not attached to the storage portion 4, the opening/closing door main body 740 abuts against the retaining cover 744 by the biasing force of the opening/closing door compression springs 743, thereby holding the opening/closing door 704 at a predetermined height in the Z direction. In a state in which the opening/closing door 704 is held at the predetermined height in the Z direction, the liquid flow hole front wall 741 of the opening/closing door 704 covers the distal end side (+Y direction side) of the liquid flow hole 720. If a moving force larger than the biasing force of the opening/closing door compression springs 743 acts on the opening/closing door 704 in the −Z direction, the opening/closing door 704 linearly moves in the −Z direction along the opening/closing door guide 711 against the biasing force of the opening/closing door compression springs 743.

As described above, the opening/closing door 704 is a moving member and includes an electrical connecting portion (circuit board 730). Cam follower pins 745 are formed at both side end portions of the opening/closing door main body 740 of the opening/closing door 704. The cam follower pin 745 is a moving force receiving portion capable of receiving the moving force from the cam plate (moving force imparting portion) 763 of the storage portion 4. If the cam follower pins 745 receive the moving force from the cam plates 763, the circuit board 730 moves from a first position that is the initial position to a second position on the −Z direction side with respect to the first position. The distance from the connecting surface 733 of the circuit board 730 at the second position to the liquid flow hole (liquid supply opening) 720 is longer than the distance from the connecting surface 733 of the circuit board 730 at the first position to the liquid flow hole 720.

In a state in which the opening/closing door main body 740 abuts against the retaining cover 744 by the biasing force of the opening/closing door compression springs 743, the circuit board 730 is located at the first position. In other words, in a state in which the liquid flow hole front wall 741 of the opening/closing door 704 covers the distal end side (+Y direction side) of the liquid flow hole 720, the circuit board 730 is located at the first position. In a state in which the liquid flow hole front wall 741 of the opening/closing door 704 does not cover the distal end side of the liquid flow hole 720, the circuit board 730 is located at the second position. The opening/closing door compression spring 743 functions as a biasing member that gives, to the opening/closing door 704, a biasing force for moving the circuit board 730 from the second position to the first position. The biasing member is preferably an elastic member. Also, the elastic member is preferably a coil spring, like the opening/closing door compression spring 743. Note that the opening/closing door compression spring 743 need only have a spring strength capable of raising the opening/closing door 704. The elastic member may be a tensile coil spring, unlike the opening/closing door compression spring 743.

The cam plate 763 that is a moving force imparting portion and the cam follower pin 745 that is a moving force receiving portion form a cam mechanism. For example, the cam plate 763 has a cam shape formed by continuously connecting a plurality of surfaces. When the cam follower pin 745 of the opening/closing door 704 moves while abutting against the plurality of surfaces of the cam shape of the cam plate 763, the circuit board 730 of the opening/closing door 704 moves from the first position to the second position. The plurality of surfaces of the cam shape of the cam plate 763 include a first surface 763a (see FIG. 39) parallel to the attachment direction of the container 700 to the storage portion 4, and a second surface 763b (see FIG. 39) crossing the first surface 763a. For example, the second surface 763b may be a tilting surface tilting by 45° with respect to the first surface 763a. If the tilting angle of the second surface 763b with respect to the first surface 763a is 45° or less, the resistance force when the cam follower pin 745 of the opening/closing door 704 moves while abutting against the second surface 763b can be made small. When the cam follower pin 745 of the opening/closing door 704 moves while abutting against the second surface 763b and the first surface 763a in this order, the circuit board 730 of the opening/closing door 704 moves from the first position to the second position. Thus, the circuit board 730 of the opening/closing door 704 can move to the first position and the second position by a linear motion.

Also, the cam follower pin 745 of the opening/closing door 704 is formed into a columnar shape projecting in the X direction. The portion of the cam follower pin 745 on the distal end side is exposed into the slot 714 of the spout 710. When the cam plate 763 of the storage portion 4 is inserted into the slot 714 of the spout 710, it can contact the cam follower pin 745 exposed into the slot 714. The direction (X direction) in which the cam follower pin 745 projects is a direction crossing the attachment direction (+Y direction) of the container 700 to the storage portion 4, and also is a direction crossing the moving direction (−Z direction) of the circuit board 730 from the first position to the second position.

When the circuit board 730 is at the first position, the liquid flow hole front wall 741 of the opening/closing door 704 covers the liquid flow hole 720. Hence, the liquid flow hole 720 is not opened to the outside. Also, since the spout 710 (opening/closing door guide 711) covers the opening/closing door main body 740 and the opening portion of the board holder 732 on the +Y direction side, the circuit board 730 is not opened to the outside. In this way, when the circuit board 730 is at the first position, electrical connection between the liquid flow hole 720 and the ink needle 760 is restricted, and electrical connection between the circuit board 730 and the connector 761 is restricted. Since access to the liquid flow hole 720 and the circuit board 730 is thus restricted, it is possible to reduce the possibility that, for example, the user erroneously touches the liquid flow hole 720, and the user's hand gets stained by the ink in the liquid flow hole 720. It is possible to reduce the possibility that the user erroneously moves the valve 722 of the liquid flow hole 720 to cause ink leakage and the ink adheres to the circuit board 730, resulting in a short circuit between the plurality of pad electrodes 731. It is possible to reduce the possibility that the user erroneously touches the circuit board 730 and the sebum of the user's hand adheres to the pad electrodes 731, resulting in a contact failure.

When attaching the container 700 to the storage portion 4, the opening/closing door 704 moves in the −Z direction along the opening/closing door guide 711 of the spout 710, and the circuit board 730 of the opening/closing door 704 thus moves from the first position to the second position. When the circuit board 730 is at the second position, the liquid flow hole front wall 741 of the opening/closing door 704 does not cover the liquid flow hole 720 and, therefore, the liquid flow hole 720 is opened to the outside. Also, since the spout 710 (opening/closing door guide 711) does not cover the opening/closing door main body 740 and the opening portion of the board holder 732 on the +Y direction side, the circuit board 730 is opened to the outside. In this way, when the circuit board 730 is at the second position, connection between the liquid flow hole 720 and the ink needle 760 is possible, and electrical connection between the circuit board 730 and the connector 761 is possible.

When detaching (separating) the container 700 from the storage portion 4, the opening/closing door 704 moves in the +Z direction by the biasing force of the opening/closing door compression spring 743, and the circuit board 730 of the opening/closing door 704 thus returns from the second position to the first position. Thus, only in the state in which the container 700 is attached to the storage portion 4, the liquid flow hole 720 and the circuit board 730 are opened to the outside. For this reason, even if the ink leaks from the liquid flow hole 720 at the time of attachment/detachment of the container 700, it is possible to reduce the possibility that the ink adheres to the user's hand or the circuit board 730.

The schematic configuration of the container 700 has been described above. Note that a filter may be provided in accordance with the property of the ink in the liquid flow hole 720 of the liquid feeding portion 702 on the side of the liquid storage portion 701. A suction nozzle for reducing sedimentation of a pigment contained in the ink may be provided in the liquid flow hole 720 on the side of the liquid storage portion 701.

### <Attachment Portion Side Connecting Element>

The attachment portion side connecting element 705 in the storage portion 4 will be described next. As described above, the cam plates 763, the positioning pins 764, the mechanical ID receivers 765, the ink needle 760, and the connector 761 form the attachment portion side connecting element 705. The ink needle 760 forms the ink channel of each color.

When attaching the container 700 to the storage portion 4, the connector 761 is electrically connected to the circuit board 730 provided on the container 700. In a state in which the circuit board 730 and the connector 761 are electrically connected, information is read out from the integrated circuit (IC) of the circuit board 730 and transmitted to a printing apparatus side control unit.

Also, when attaching the container 700 to the storage portion 4, the cam plates 763 engage with the cam follower pins 745 provided on the opening/closing door 704 of the container 700 to move the opening/closing door 704 in the Z direction. The positioning pins 764 engage with the positioning holes 715 formed in the spout 710 of the container 700. The mechanical ID receivers 765 engage with the mechanical IDs 717 formed on the spout 710 of the container 700.

### <Attachment of Container>

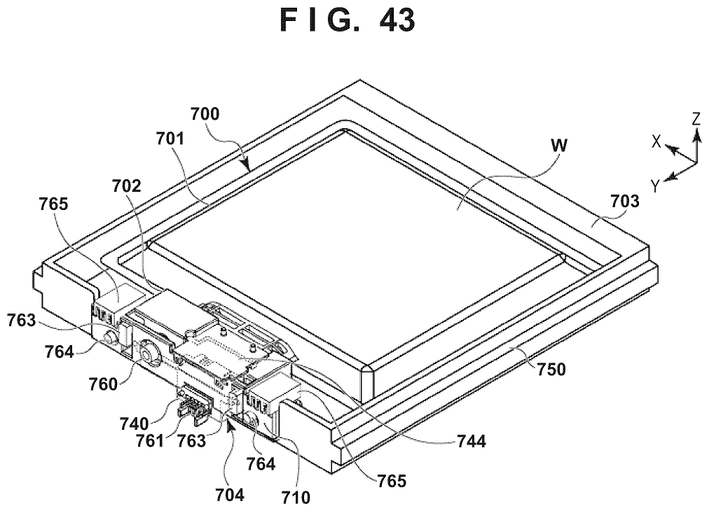

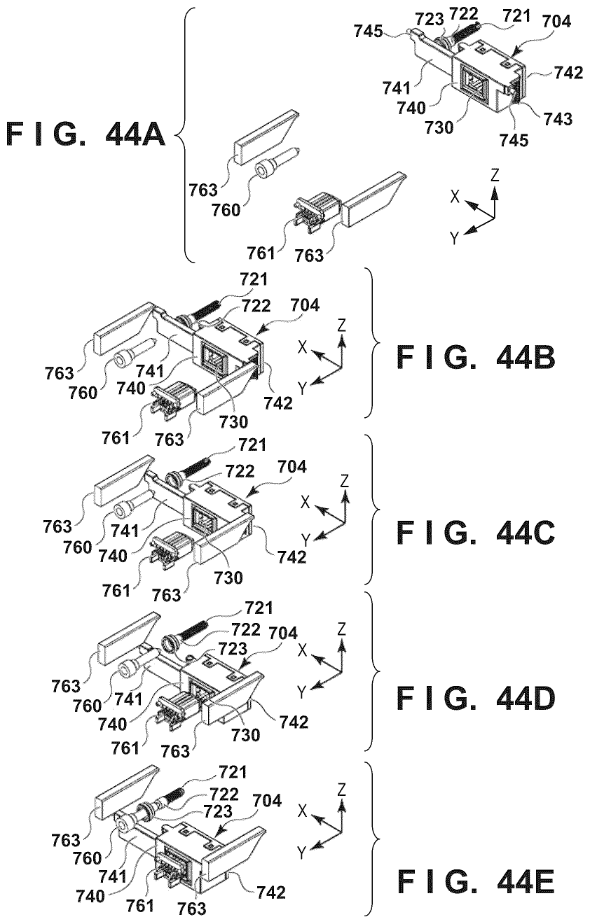

A series of operations when attaching the container 700 to the storage portion 4 will be described next. FIG. 39 is a perspective view showing a state before the container 700 is attached to the storage portion 4. FIG. 42 is a perspective view showing a halfway state in which the container 700 is being attached to the storage portion 4. FIG. 43 is a perspective view showing a state in which the container 700 is attached to the storage portion 4. Note that FIG. 7 is also a perspective view showing a state in which the container 700 is separated from the storage portion 4. FIG. 42 is also a perspective view showing a halfway state in which the container 700 is being separated from the storage portion 4. FIG. 43 is also a perspective view showing a state before the container 700 is separated from the storage portion 4.

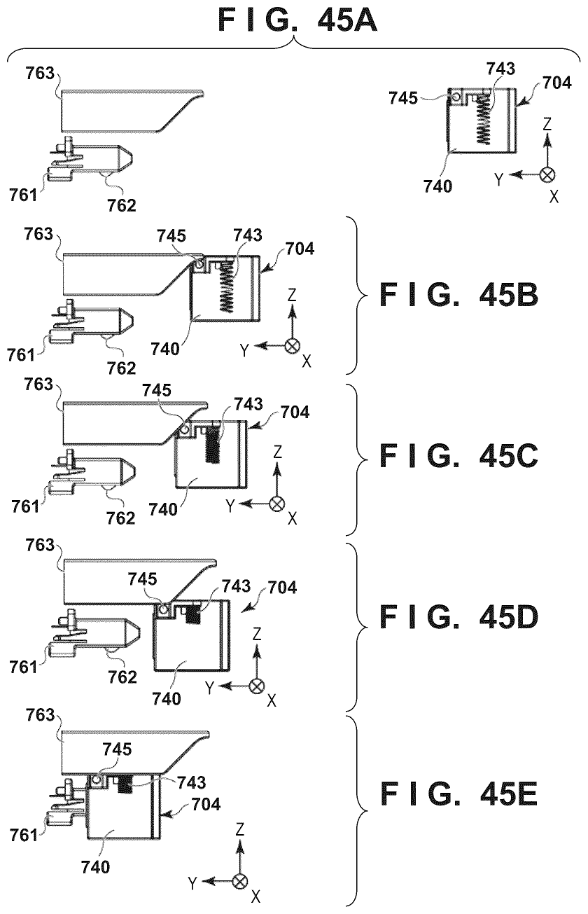

FIGS. 44A to 44E are perspective views showing the operation of the opening/closing door 704 when attaching the container 700 to the storage portion 4. FIG. 44A is a perspective view showing the opening/closing door 704 before the container 700 is attached to the storage portion 4. FIGS. 44B, 44C, and 44D are perspective views showing the opening/closing door 704 halfway through the attachment of the container 700 to the storage portion 4. FIG. 44E is a perspective view showing the opening/closing door 704 after the container 700 is attached to the storage portion 4.

FIGS. 45A to 45E are side views showing the operation of the opening/closing door 704 when attaching the container 700 to the storage portion 4. FIG. 45A is a side view showing the opening/closing door 704 before the container 700 is attached to the storage portion 4. FIGS. 45B, 45C, and 45D are side views showing the opening/closing door 704 halfway through the attachment of the container 700 to the storage portion 4. FIG. 45E is a side view showing the opening/closing door 704 after the container 700 is attached to the storage portion 4.

FIGS. 39, 44A, and 45A show a state before the container 700 is attached to the storage portion 4, that is, a non-attached state in which the container 700 is not attached to the storage portion 4. In the non-attached state, the valve 722 of the container 700 moves in the +Y direction and abuts against the joint seal 723 by the biasing force of the valve compression spring 721, thereby closing the liquid flow hole 720. When the liquid flow hole 720 is closed by the valve 722, a flow of air into the liquid storage portion 701 and leakage of the ink W from the inside of the liquid storage portion 701 are suppressed. In the non-attached state, the opening/closing door 704 (opening/closing door main body 740) of the container 700 abuts against the retaining cover 744 by the biasing force of the opening/closing door compression springs 743 and is thus held at a predetermined height in the Z direction. In a state in which the opening/closing door 704 is held at the predetermined height in the Z direction, the liquid flow hole front wall 741 of the opening/closing door 704 covers the distal end side (+Y direction side) of the liquid flow hole 720. In addition, the spout 710 (opening/closing door guide 711) covers the opening/closing door main body 740 and the opening portion of the board holder 732 on the +Y direction side. Since access to the liquid flow hole 720 and the circuit board 730 is thus restricted, it is possible to reduce the possibility that, for example, the user erroneously touches the liquid flow hole 720, and the user's hand gets stained by the ink in the liquid flow hole 720. It is possible to reduce the possibility that the user erroneously moves the valve 722 of the liquid flow hole 720 to cause ink leakage and the ink adheres to the circuit board 730, resulting in a short circuit between the plurality of pad electrodes 731. It is possible to reduce the possibility that the user erroneously touches the circuit board 730 and the sebum of the user's hand adheres to the pad electrodes 731, resulting in a contact failure.

FIG. 42 shows a halfway state in which the container 700 is being attached to the storage portion 4, that is, a halfway state of attachment of the container 700. FIGS. 44B to 44D show the process of attaching the container 700 to the storage portion 4 in this order. FIGS. 45B to 45D show the process of attaching the container 700 to the storage portion 4 in this order. In the halfway state of attachment of the container 700, the user moves the tray 703 that stores/supports the container 700 in the +Y direction toward the storage portion 4. In the halfway state of attachment of the container 700, the cam plates 763 of the storage portion 4 are inserted into the slots 714 formed in the spout 710 of the container 700 (see FIG. 42). At this time, the cam plates 763 engage with the cam follower pins 745 provided on the opening/closing door 704 of the container 700 (see FIGS. 44B and 45B). When the cam follower pin 745 receives a reaction force (moving force) from the cam plate 763, the opening/closing door 704 linearly moves in the −Z direction along the opening/closing door guide 711 of the spout 710, and the circuit board 730 of the opening/closing door 704 thus moves from the first position to the second position. Also, when the opening/closing door 704 moves in the −Z direction, the liquid flow hole front wall 741 of the opening/closing door 704 moves to the −Z direction side with respect to the liquid flow hole 720, and does not cover the liquid flow hole 720 any more (see FIGS. 44C and 44D and FIGS. 45C and 45D). Hence, the liquid flow hole 720 is opened to the outside. Also, when the opening/closing door 704 moves in the −Z direction, the opening/closing door main body 740 and the opening portion of the board holder 732 on the +Y direction side move to the −Z direction side with respect to the spout 710 (opening/closing door guide 711) and the tray 703, and are not covered with the spout 710 any more. Hence, the circuit board 730 is opened to the outside. Here, the circuit board 730 moves in the direction of separating from the liquid flow hole 720 together with the opening/closing door main body 740. Hence, even if the ink leaks from the liquid flow hole 720, it is possible to reduce the possibility that the ink adheres to the circuit board 730.

In the halfway state of attachment of the container 700, the positioning pins 764 of the storage portion 4 engage with the positioning holes 715 of the container 700, and the mechanical ID receivers 765 of the storage portion 4 engage with the mechanical IDs 717 of the container 700. In the halfway state of attachment of the container 700, the ink needle 760 of the storage portion 4 is not connected to the liquid flow hole 720 of the container 700. In the halfway state of attachment of the container 700, the connector 761 of the storage portion 4 is not electrically connected to the circuit board 730 of the container 700.

FIGS. 43, 44E, and 45E show an attached state in which the container 700 is attached to the storage portion 4. The user further moves the tray 703 that stores/supports the container 700 from the halfway state of attachment in the +Y direction. At this time, the ink needle 760 of the storage portion 4 is inserted into the liquid flow hole 720 of the container 700 while keeping airtightness to the outside by the joint seal 723. Then, the ink needle 760 of the storage portion 4 abuts against the valve 722, and the valve 722 moves in the −Y direction against the biasing force of the valve compression spring 721, thereby opening the channel of the ink W. Thus, an ink channel is formed between the main body 100 (printhead) and the container 700. In addition, the connector 761 of the storage portion 4 is inserted into the internal space of the board holder 732 from the opening/closing door main body 740 and the opening portion of the board holder 732 on the +Y direction side. The electrical contact 762 of the connector 761 contacts the pad electrodes 731 of the circuit board 730 and is electrically connected to these. The information recorded in the integrated circuit (IC) of the circuit board 730 can thus be read out from the circuit board 730 to the printing apparatus side control unit. In this way, the container 700 is attached to the storage portion 4.

In the state in which the container 700 is attached to the storage portion 4, the circuit board 730 is electrically connected to the electrical contact 762 of the connector 761 at the second position. Here, the electrical contact 762 of the connector 761 is located on the side of the liquid flow hole 720 with respect to the circuit board 730. The connecting surface 733 of the circuit board 730 at the second position is directed to the center in the up/down-direction of the container 700 in an attachment posture attached to the storage portion 4. Also, the connecting surface 733 of the circuit board 730 at the second position is directed, with respect to the circuit board 730, to the inside in the up/down direction of the container 700 in the attachment posture. In other words, the connecting surface 733 of the circuit board 730 at the second position is directed to the side of the liquid flow hole 720 (liquid supply opening side). “Directed to the side of the liquid flow hole 720 (liquid supply opening side)” in each embodiment means “directed to the side of the same height position (+Z direction side) as the liquid flow hole 720”. It is therefore possible to insert the connector 761 into the space (the internal space of the board holder 732) provided between the connecting surface 733 of the circuit board 730 and the liquid flow hole 720 and electrically connect the electrical contact 762 of the connector 761 to the pad electrodes 731 of the circuit board 730. Hence, the electrical contact 762 of the connector 761 can be arranged on the surface of the connector 761 on the opposite side of the liquid flow hole 720. For this reason, even if the ink leaks from the liquid flow hole 720 at the time of attachment/detachment of the container 700, it is possible to reduce the possibility that the ink adheres to the electrical contact 762 of the connector 761.

When detaching the container 700 from the storage portion 4, the user moves the tray 703 that stores/supports the container 700 from the storage portion 4 in the −Y direction. The connection between the ink needle 760 of the storage portion 4 and the liquid flow hole 720 of the container 700 is thus canceled. The valve 722 of the container 700 moves in the +Y direction by the biasing force of the valve compression spring 721 and abuts against the joint seal 723, thereby closing the liquid flow hole 720. Also, the electrical connection between the connector 761 of the storage portion 4 and the circuit board 730 of the container 700 is canceled. The engagement between the positioning pins 764 of the storage portion 4 and the positioning holes 715 of the container 700 is canceled, and the engagement between the mechanical ID receivers 765 of the storage portion 4 and the mechanical IDs 717 of the container 700 is canceled. Then, the engagement between the cam plates 763 of the storage portion 4 and the cam follower pins 745 of the container 700 is canceled. The opening/closing door 704 of the container 700 abuts against the retaining cover 744 by the biasing force of the opening/closing door compression springs 743 and is thus held at a predetermined height in the Z direction. In this way, the state returns to the state before the container 700 is attached to the storage portion 4. Thus, only in the state in which the container 700 is attached to the storage portion 4, the liquid flow hole 720 and the circuit board 730 are opened to the outside. For this reason, even if the ink leaks from the liquid flow hole 720 at the time of attachment/detachment of the container 700, it is possible to reduce the possibility that the ink adheres to the user's hand or the circuit board 730.

As described above, in this embodiment, when attaching the container 700 to the storage portion 4, the circuit board (electrical connecting portion) 730 moves to the second position, and the pad electrodes 731 of the circuit board 730 are electrically connected to the electrical contact 762 of the connector 761. In addition, the connecting surface 733 of the circuit board 730 at the second position is directed to the side of the liquid flow hole 720 (liquid supply opening side). Hence, as described above, the electrical contact 762 of the connector 761 can be arranged on the surface of the connector 761 on the opposite side of the liquid flow hole 720. For this reason, even if the ink leaks from the liquid flow hole 720 at the time of attachment/detachment of the container 700, it is possible to reduce the possibility that the ink adheres to the electrical contact 762 of the connector 761.

Also, in this embodiment, the connecting surface 733 of the circuit board 730 at the second position is directed to the center in the up/down-direction of the container 700 in the attachment posture attached to the storage portion 4. Hence, as described above, the electrical contact 762 of the connector 761 can be arranged on the surface of the connector 761 on the opposite side of the liquid flow hole 720. For this reason, even if the ink leaks from the liquid flow hole 720 at the time of attachment/detachment of the container 700, it is possible to reduce the possibility that the ink adheres to the electrical contact 762 of the connector 761.

In this embodiment, when the circuit board (electrical connecting portion) 730 is at the first position, connection between the liquid flow hole (liquid supply opening) 720 and the ink needle (liquid receiving portion) 760 is restricted. On the other hand, when the circuit board 730 is at the second position, the liquid flow hole 720 and the ink needle 760 can be connected. Thus, only in the state in which the container 700 is attached to the storage portion 4, the liquid flow hole 720 and the circuit board 730 are opened to the outside. For this reason, even if the ink leaks from the liquid flow hole 720 at the time of attachment/detachment of the container 700, it is possible to reduce the possibility that the ink adheres to the user's hand or the circuit board 730.

In this embodiment, when the circuit board (electrical connecting portion) 730 is at the first position, the liquid flow hole (liquid supply opening) 720 is covered. On the other hand, when the circuit board 730 is at the second position, the liquid flow hole 720 is not covered. Thus, only in the state in which the container 700 is attached to the storage portion 4, the liquid flow hole 720 and the circuit board 730 are opened to the outside. For this reason, even if the ink leaks from the liquid flow hole 720 at the time of attachment/detachment of the container 700, it is possible to reduce the possibility that the ink adheres to the user's hand or the circuit board 730.

In this embodiment, in a state in which the container 700 is attached to the storage portion 4, the circuit board (electrical connecting portion) 730 is electrically connected to the electrical contact 762 of the connector 761 at the second position. The electrical contact 762 of the connector 761 is located on the side of the liquid flow hole (liquid supply opening) 720 with respect to the circuit board 730. Hence, as described above, the electrical contact 762 of the connector 761 can be arranged on the surface of the connector 761 on the opposite side of the liquid flow hole 720. For this reason, even if the ink leaks from the liquid flow hole 720 at the time of attachment/detachment of the container 700, it is possible to reduce the possibility that the ink adheres to the electrical contact 762 of the connector 761.

In this embodiment, the connecting surface 733 of the circuit board 730 at the second position is directed, with respect to the circuit board 730, to the inside in the up/down direction of the container 700 in the attachment posture attached to the storage portion 4. Hence, as described above, the electrical contact 762 of the connector 761 can be arranged on the surface of the connector 761 on the opposite side of the liquid flow hole 720. For this reason, even if the ink leaks from the liquid flow hole 720 at the time of attachment/detachment of the container 700, it is possible to reduce the possibility that the ink adheres to the electrical contact 762 of the connector 761. The conventional technique can be further developed in this way.

In the above-described fifth embodiment, the cam follower pin 745 that is a moving force receiving portion is integrated with the opening/closing door main body 740. However, the present disclosure is not limited to this. For example, a bearing such as a sliding bearing or a rolling bearing may be assembled as the moving force receiving portion to the opening/closing door main body 740. This can reduce the frictional force generated between the opening/closing door main body 740 and the cam plate 763.

In the above-described fifth embodiment, the cam plate 763 that is a moving force imparting portion and the cam follower pin 745 that is a moving force receiving portion form a cam mechanism. However, the present disclosure is not limited to this. For example, as the cam mechanism, a cam groove may be formed in the opening/closing door main body 740, and a cam follower may be provided on the storage portion 4. Also, in place of the cam mechanism, a moving force imparting portion and a moving force receiving portion may form a gear mechanism such as a rack & pinion. In place of a mechanism using a force generated when attaching the container 700 to the storage portion 4, a driving device that directly drives the opening/closing door 704 may be provided. Note that the driving device may be a pneumatic driving device or an electric driving device.

### Sixth Embodiment

The sixth embodiment will be described next. Since individual members in the sixth embodiment have the same configurations as in the above-described fifth embodiment, the same reference numerals as in the above-described fifth embodiment denote the same members. In the sixth embodiment, portions different from the fifth embodiment will mainly be described. In the sixth embodiment, a description of portions common to the fifth embodiment will sometimes be omitted. The circuit board 730 of the opening/closing door 704 according to the fifth embodiment moves from the first position to the second position by a linear motion. A circuit board 730 of an opening/closing door 704 according to the sixth embodiment moves from the first position to the second position by a rotary motion such that it draws a part of an arc. Since the moving amount of the opening/closing door 704 (circuit board 730) by the rotary motion is larger than the moving amount of the opening/closing door 704 (circuit board 730) by the linear motion, the effect of opening/closing movement of the opening/closing door 704 can readily be obtained.

### <Configuration of Container>

A container 700 according to the sixth embodiment will be described next. The container 700 according to the sixth embodiment is used as an ink pack in combination with a tray 703, as in the fifth embodiment. The container 700 is stored/supported in the tray 703 and, in this state, detachably attached to the storage portion 4 of the main body 100. The tray 703 is a storage portion configured to store/support the container 700 (ink pack) in a predetermined posture. The storage portion 4 is an attachment portion of the main body 100 to which the container 700 is detachably attached.

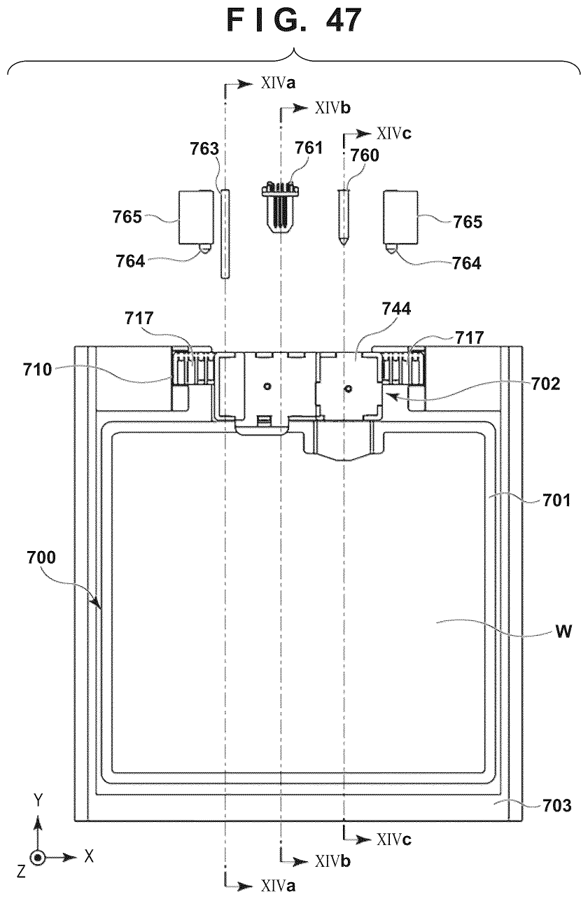

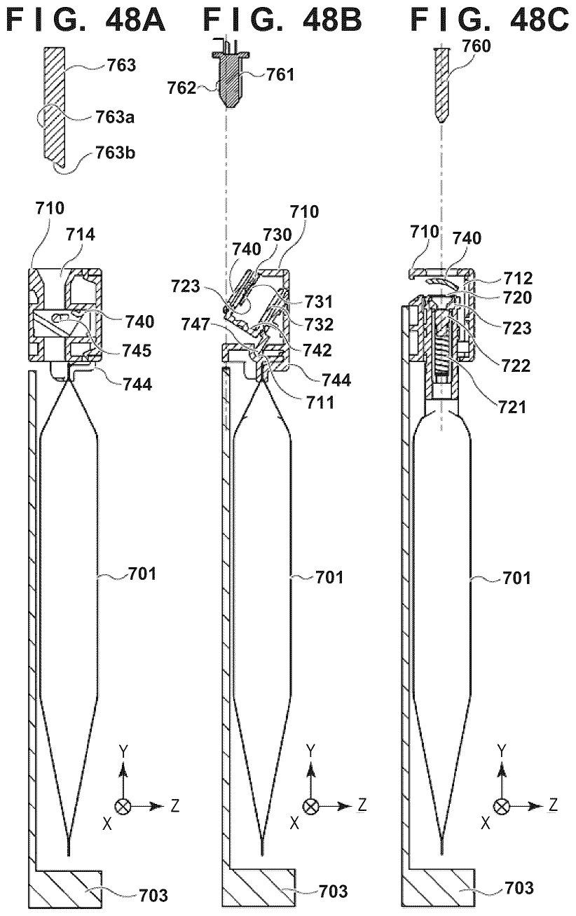

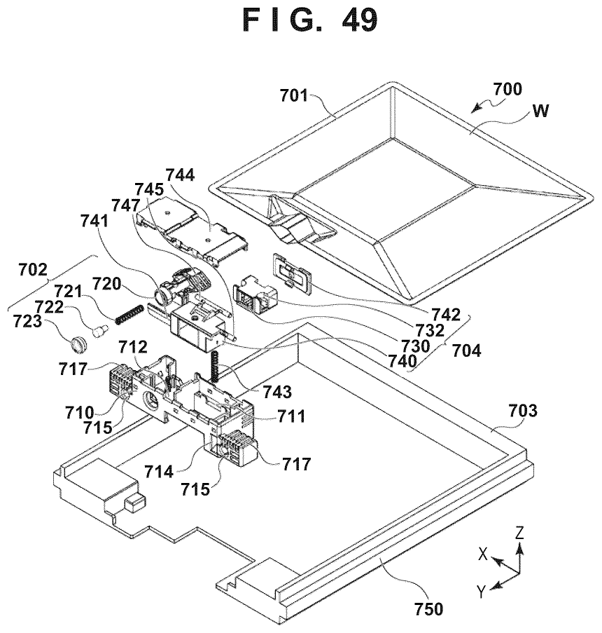

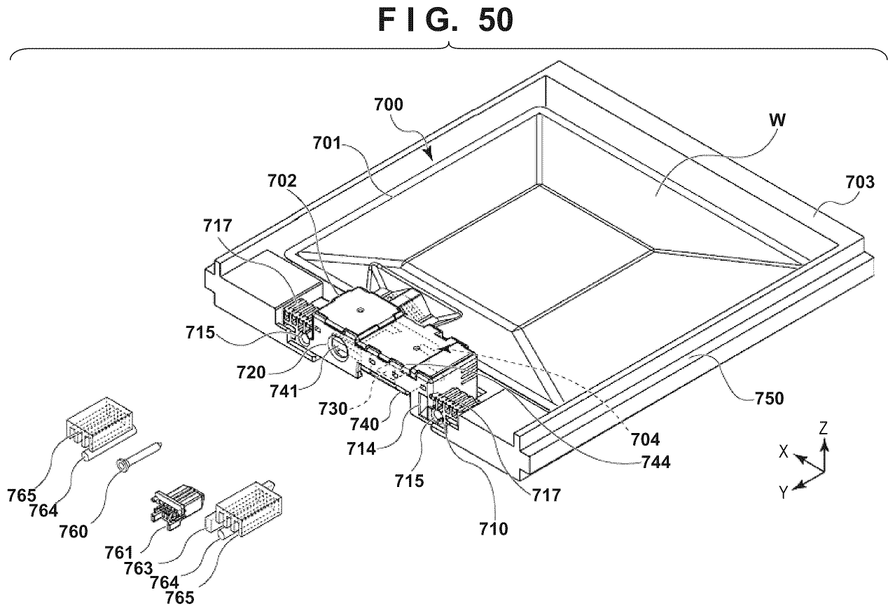

FIG. 46 is a perspective view showing the schematic configuration of the container 700 according to the sixth embodiment. FIG. 47 is a sectional view of the container 700 viewed from the +Z direction. FIGS. 48A to 48C are sectional views of the container 700 viewed from the −X direction. FIG. 48A is a sectional view taken along a line XIVa-XIVa in FIG. 47. FIG. 48B is a sectional view taken along a line XIVb-XIVb in FIG. 47. FIG. 48C is a sectional view taken along a line XIVc-XIVc in FIG. 47. FIG. 49 is an exploded perspective view of the container 700.

The elements of the container 700 according to the sixth embodiment will be described with reference to FIGS. 46 to 49. Like the container 700 according to the fifth embodiment, the container 700 according to the sixth embodiment includes a liquid storage portion (bag body) 701, a liquid feeding portion 702, and the opening/closing door 704. Note that in FIGS. 46, 47, and 49 to 52, the ink W is simplified.

The liquid feeding portion 702 according to sixth embodiment includes a spout 710, a valve compression spring 721, a valve 722, and a joint seal (seal member) 723. The valve compression spring 721, the valve 722, and the joint seal 723 according to the sixth embodiment are formed like the valve compression spring 721, the valve 722, and the joint seal 723 according to the fifth embodiment. The spout 710 according to the sixth embodiment is formed like the spout 710 according to the fifth embodiment except for the shape of an opening/closing door guide 711.

The opening/closing door guide 711, a slit 712, a slot 714, positioning holes 715, and a liquid flow hole (liquid supply opening) 720 are formed inside the spout 710. Groove-shaped mechanical IDs 717 are formed outside the spout 710. The slit 712, the slot 714, the positioning holes 715, the liquid flow hole 720, and the mechanical IDs 717 according to the sixth embodiment are formed like the slit 712, the slot 714, the positioning holes 715, the liquid flow hole 720, and the mechanical IDs 717 according to the fifth embodiment.

An opening/closing door main body 740, a board holder cover 742, and a rotation shaft 747 of the opening/closing door 704 are inserted into the opening/closing door guide 711. The opening/closing door guide 711 according to the fifth embodiment includes a groove-shaped guide surface that guides the opening/closing door 704 such that it can move in the up/down direction (Z direction). On the other hand, the opening/closing door guide 711 according to the sixth embodiment includes a guide surface having a semicircular shape in a sectional view with respect to an axis extending in the X direction as the center. When assembling the opening/closing door 704 to the spout 710, the rotation shaft 747 of the opening/closing door 704 engages with a shaft engaging portion (not shown) of the opening/closing door guide 711. The opening/closing door 704 can thus rotationally move about the rotation shaft 747 in the opening/closing door guide 711 and the slit 712 of the spout 710.

The opening/closing door 704 according to the sixth embodiment includes the opening/closing door main body 740, a circuit board (electrical connecting portion) 730, a board holder 732, and the board holder cover 742. The opening/closing door main body 740 according to the sixth embodiment is formed like the opening/closing door main body 740 according to the fifth embodiment except for the rotation shaft 747. The opening/closing door main body 740 stores the circuit board 730 and the board holder 732 inside. The circuit board 730 and the board holder 732 according to the sixth embodiment are formed like the circuit board 730 and the board holder 732 according to the fifth embodiment. The board holder cover 742 according to the sixth embodiment is formed like the board holder cover 742 according to the fifth embodiment.

The opening/closing door main body 740 and the board holder cover 742 of the opening/closing door 704 are inserted into the opening/closing door guide 711 of the spout 710 together with the board holder 732 with the circuit board 730 assembled thereto. The rotation shaft 747 extending the X direction is formed on the top portion of the opening/closing door main body 740. When the opening/closing door main body 740 and the board holder cover 742 are inserted into the opening/closing door guide 711 of the spout 710, the rotation shaft 747 engages with the shaft engaging portion (not shown) of the opening/closing door guide 711. Also, a liquid flow hole front wall 741 is formed on a side portion of the opening/closing door main body 740 on the +X direction side. When the opening/closing door main body 740 and the board holder cover 742 are inserted into the opening/closing door guide 711 of the spout 710, the liquid flow hole front wall 741 is inserted into the slit 712 of the spout 710. The liquid flow hole front wall 741 inserted into the slit 712 of the spout 710 can cover the distal end side (+Y direction side) of the liquid flow hole 720. In addition to the opening/closing door 704, an opening/closing door compression spring 743 is inserted into the opening/closing door guide 711. A retaining cover 744 is arranged at the top portion of the opening/closing door guide 711. The retaining cover 744 according to the sixth embodiment is formed like the retaining cover 744 according to the fifth embodiment. Also, a cam follower pin 745 according to the sixth embodiment is formed at the side end portion of the opening/closing door main body 740 of the opening/closing door 704 on one side (−X direction side).

In a non-attached state in which the container 700 is not attached to the storage portion 4, the opening/closing door main body 740 abuts against the retaining cover 744 by the biasing force of the opening/closing door compression spring 743, thereby holding the opening/closing door 704 at a predetermined height in the Z direction. In a state in which the opening/closing door 704 is held at the predetermined height in the Z direction, the liquid flow hole front wall 741 of the opening/closing door 704 covers the distal end side (+Y direction side) of the liquid flow hole 720. If a moving force larger than the biasing force of the opening/closing door compression spring 743 acts on the opening/closing door 704 in the −Z direction, the opening/closing door 704 rotationally moves to the −Z direction side along the opening/closing door guide 711 against the biasing force of the opening/closing door compression spring 743.

An attachment portion side connecting element 705 (a cam plate 763, positioning pins 764, mechanical ID receivers 765, an ink needle 760, and a connector 761) according to the sixth embodiment is formed like the attachment portion side connecting element 705 according to the fifth embodiment. Note that a plurality of surfaces of the cam shape of the cam plate 763 according to the sixth embodiment include a first surface 763a (see FIG. 48A) parallel to the attachment direction of the container 700 to the storage portion 4, and a second surface 763b (see FIG. 48A) crossing the first surface 763a. The second surface 763b may be a tilting surface tilting with respect to the first surface 763a. Also, the shape of the tilting surface of the second surface 763b may be a concave surface shape that is curved such that it can engage with the cam follower pin 745 of the opening/closing door 704. When the cam follower pin 745 of the opening/closing door 704 moves while abutting against the second surface 763b and the first surface 763a in this order, the circuit board 730 of the opening/closing door 704 rotationally moves from the first position to the second position.

### <Attachment of Container>

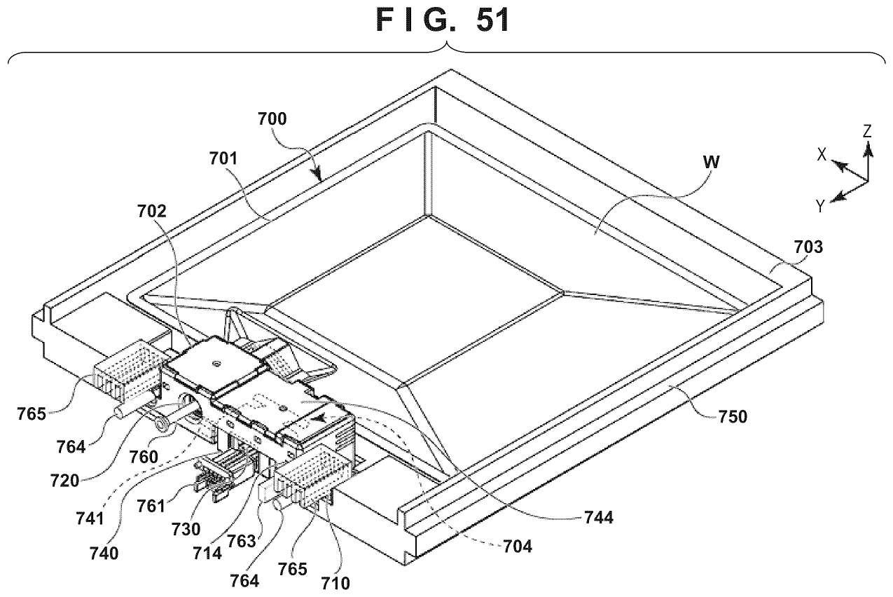

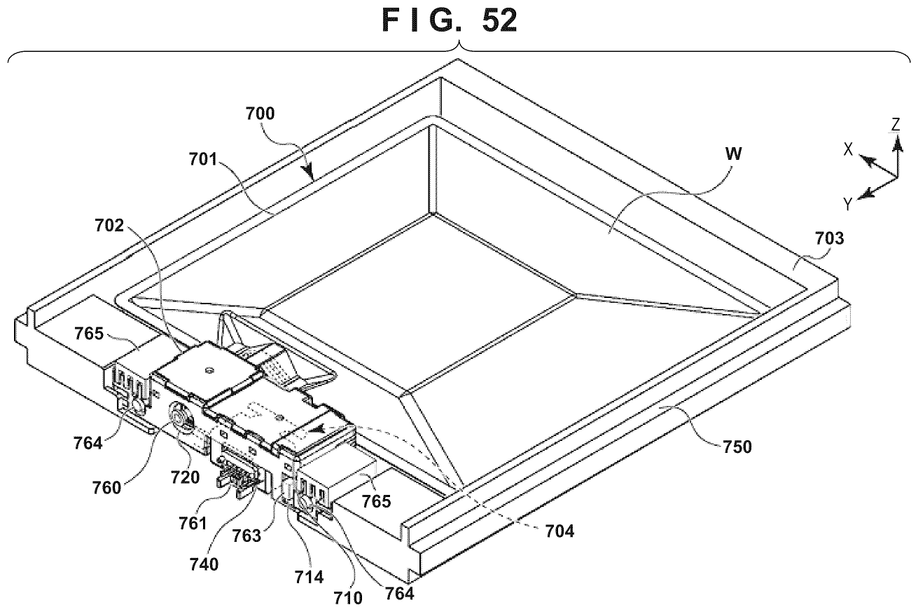

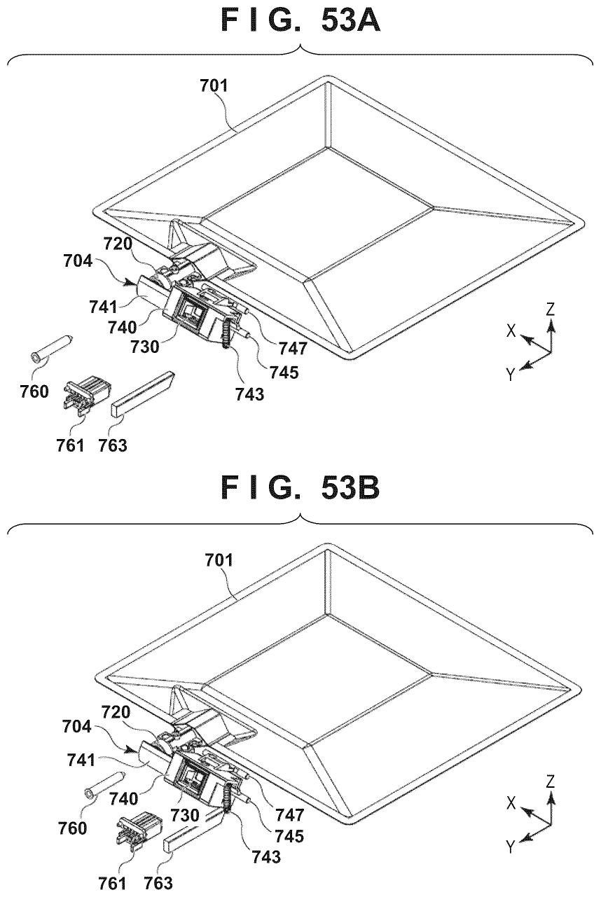

A series of operations when attaching the container 700 according to the sixth embodiment to the storage portion 4 will be described next. FIG. 50 is a perspective view showing a state before the container 700 is attached to the storage portion 4. FIG. 51 is a perspective view showing a halfway state in which the container 700 is being attached to the storage portion 4. FIG. 52 is a perspective view showing a state in which the container 700 is attached to the storage portion 4. Note that FIG. 50 is also a perspective view showing a state in which the container 700 is separated from the storage portion 4. FIG. 51 is also a perspective view showing a halfway state in which the container 700 is being separated from the storage portion 4. FIG. 52 is also a perspective view showing a state before the container 700 is separated from the storage portion 4.

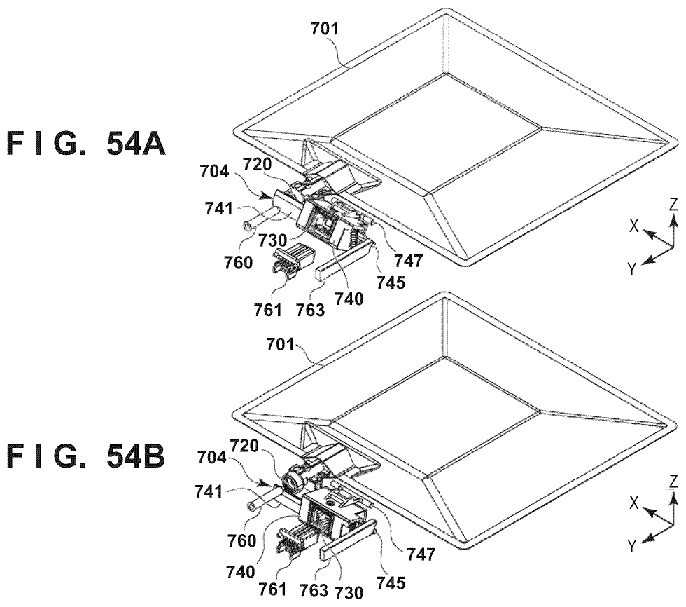

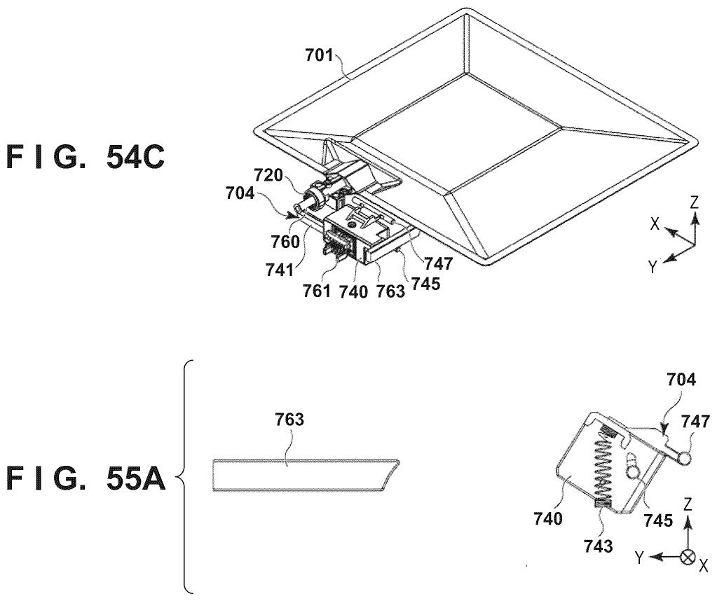

FIGS. 53A and 53B are perspective views showing the operation of the opening/closing door 704 when attaching the container 700 to the storage portion 4. FIG. 53A is a perspective view showing the opening/closing door 704 before the container 700 is attached to the storage portion 4. FIG. 53B is a perspective view showing the opening/closing door 704 halfway through the attachment of the container 700 to the storage portion 4. FIGS. 54A to 54C are perspective views showing the operation of the opening/closing door 704 when attaching the container 700 to the storage portion 4. FIGS. 54A and 54B are perspective views showing the opening/closing door 704 halfway through the attachment of the container 700 to the storage portion 4. FIG. 54C is a perspective view showing the opening/closing door 704 after the container 700 is attached to the storage portion 4.

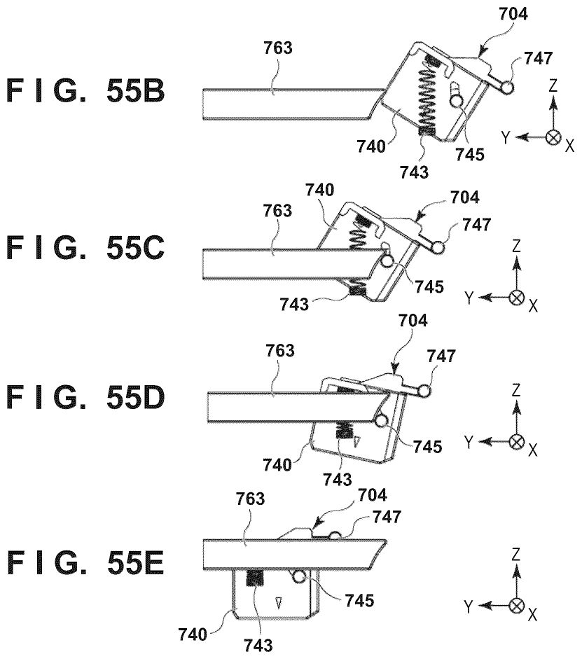

FIGS. 55A to 55E are side views showing the operation of the opening/closing door 704 when attaching the container 700 to the storage portion 4. FIG. 55A is a side view showing the opening/closing door 704 before the container 700 is attached to the storage portion 4. FIGS. 55B, 55C, and 55D are side views showing the opening/closing door 704 halfway through the attachment of the container 700 to the storage portion 4. FIG. 55E is a side view showing the opening/closing door 704 after the container 700 is attached to the storage portion 4.

FIGS. 50, 53A, and 55A show a state before the container 700 is attached to the storage portion 4, that is, a non-attached state in which the container 700 is not attached to the storage portion 4. In the non-attached state, the valve 722 of the container 700 moves in the +Y direction and abuts against the joint seal 723 by the biasing force of the valve compression spring 721, thereby closing the liquid flow hole 720. When the liquid flow hole 720 is closed by the valve 722, a flow of air into the liquid storage portion 701 and leakage of the ink W from the inside of the liquid storage portion 701 are suppressed. In the non-attached state, the opening/closing door 704 (opening/closing door main body 740) of the container 700 abuts against the retaining cover 744 by the biasing force of the opening/closing door compression spring 743 and is thus held at a predetermined height in the Z direction. In a state in which the opening/closing door 704 is held at the predetermined height in the Z direction, the liquid flow hole front wall 741 of the opening/closing door 704 covers the distal end side (+Y direction side) of the liquid flow hole 720. In addition, the spout 710 (opening/closing door guide 711) covers the opening/closing door main body 740 and the opening portion of the board holder 732 on the +Y direction side. Since access to the liquid flow hole 720 and the circuit board 730 is thus restricted, it is possible to reduce the possibility that, for example, the user erroneously touches the liquid flow hole 720, and the user's hand gets stained by the ink in the liquid flow hole 720. It is possible to reduce the possibility that the user erroneously moves the valve 722 of the liquid flow hole 720 to cause ink leakage and the ink adheres to the circuit board 730, resulting in a short circuit between a plurality of pad electrodes 731. It is possible to reduce the possibility that the user erroneously touches the circuit board 730 and the sebum of the user's hand adheres to the pad electrodes 731, resulting in a contact failure.

FIG. 51 shows a halfway state in which the container 700 is being attached to the storage portion 4, that is, a halfway state of attachment of the container 700. FIGS. 53B, 54A, and 54B show the process of attaching the container 700 to the storage portion 4 in this order. FIGS. 55B to 55D show the process of attaching the container 700 to the storage portion 4 in this order. In the halfway state of attachment of the container 700, the user moves the tray 703 that stores/supports the container 700 in the +Y direction toward the storage portion 4. In the halfway state of attachment of the container 700, the cam plate 763 of the storage portion 4 is inserted into the slot 714 formed in the spout 710 of the container 700 (see FIG. 51). At this time, the cam plate 763 engages with the cam follower pin 745 provided on the opening/closing door 704 of the container 700 (see FIGS. 53B, 54A, 55B, and 55C). When the cam follower pin 745 receives a reaction force (moving force) from the cam plate 763, the opening/closing door 704 rotationally moves to the −Z direction side along the opening/closing door guide 711 of the spout 710, and the circuit board 730 of the opening/closing door 704 thus rotationally moves from the first position to the second position. Also, when the opening/closing door 704 rotationally moves to the −Z direction side, the liquid flow hole front wall 741 of the opening/closing door 704 rotationally moves to the −Z direction side with respect to the liquid flow hole 720, and does not cover the liquid flow hole 720 any more (see FIGS. 54B and 55D). Hence, the liquid flow hole 720 is opened to the outside. Also, when the opening/closing door 704 rotationally moves to the −Z direction side, the opening/closing door main body 740 and the opening portion of the board holder 732 on the +Y direction side rotationally move to the −Z direction side with respect to the spout 710 (opening/closing door guide 711), and are not covered with the spout 710 any more. Hence, the circuit board 730 is opened to the outside. Here, the circuit board 730 moves in the direction of separating from the liquid flow hole 720 together with the opening/closing door main body 740. Hence, even if the ink leaks from the liquid flow hole 720, it is possible to reduce the possibility that the ink adheres to the circuit board 730.

In the halfway state of attachment of the container 700, the positioning pins 764 of the storage portion 4 engage with the positioning holes 715 of the container 700 first, and next, the mechanical ID receivers 765 of the storage portion 4 engage with the mechanical IDs 717 of the container 700. In the halfway state of attachment of the container 700, the ink needle 760 of the storage portion 4 is not connected to the liquid flow hole 720 of the container 700. In the halfway state of attachment of the container 700, the connector 761 of the storage portion 4 is not electrically connected to the circuit board 730 of the container 700.

When attaching the container 700 according to this embodiment, as the procedure of attaching the container 700 to the apparatus main body, first, the positioning pins 764 on the main body side are inserted into the positioning holes 715 of the spout 710. The position of the spout 710 is thus defined at a predetermined position in the X and Z directions, and the posture of the spout 710 is stably held.

Next, the mechanical ID portions provided on the side of the spout 710 and the main body side are fitted. Since the position of the spout 710 is accurately defined by the fitting between the positioning pins 764 and the positioning holes 715, even if a gap is small with respect to the fitting portion of the mechanical ID portions, smooth insertion is possible.

After that, the ink needle 760 is connected to the liquid flow hole 720 of the container 700 to form an ink channel. At this time, since the position of the spout 710 is accurately defined by the fitting between the positioning pins 764 and the positioning holes 715, the coaxiality between the needle 760 and the liquid flow hole 720 is ensured, and the joint seal 723 is evenly compressed in the radial direction to increase the sealing property, thereby suppressing ink leakage caused by uneven deformation of the rubber seal.

Furthermore, after the ink needle 760 is sufficiently inserted to the side of the container 700, and the ink channel is reliably formed, electrical connecting portions on the main body side and the tank side are connected. With this order configuration, it is possible to prevent electrical connection from being completed in a state in which formation of the ink channel is insufficient, that is, in a so-called “half-inserted” state. It is therefore possible to electrically appropriately detect the attached state, prevent ink leakage, and ensure a reliable attached state.

FIGS. 52, 54C, and 55E show an attached state in which the container 700 is attached to the storage portion 4. The user further moves the tray 703 that stores/supports the container 700 from the halfway state of attachment in the +Y direction. At this time, the ink needle 760 of the storage portion 4 is inserted into the liquid flow hole 720 of the container 700 while keeping airtightness to the outside by the joint seal 723. Then, the ink needle 760 of the storage portion 4 abuts against the valve 722, and the valve 722 moves in the −Y direction against the biasing force of the valve compression spring 721, thereby opening the channel of the ink W. Thus, an ink channel is formed. In addition, the connector 761 of the storage portion 4 is inserted into the internal space of the board holder 732 from the opening/closing door main body 740 and the opening portion of the board holder 732 on the +Y direction side. The electrical contact 762 of the connector 761 contacts the pad electrodes 731 of the circuit board 730 and is electrically connected to these. Information recorded in the integrated circuit (IC) of the circuit board 730 can thus be read out from the circuit board 730 to the printing apparatus side control unit. In this way, the container 700 is attached to the storage portion 4. Note that the connector 761 is preferably arranged such that it intercepts a line that connects the center of the liquid flow hole 720 and the center of the pad electrodes 731 of the circuit board 730 in a state in which the container 700 is attached to the storage portion 4.

In the state in which the container 700 is attached to the storage portion 4, the circuit board 730 is electrically connected to the electrical contact 762 of the connector 761 at the second position. Here, the electrical contact 762 of the connector 761 is located on the side of the liquid flow hole 720 with respect to the circuit board 730. A connecting surface 733 of the circuit board 730 at the second position is directed to the center in the up/down-direction of the container 700 in an attachment posture attached to the storage portion 4. Also, the connecting surface 733 of the circuit board 730 at the second position is directed, with respect to the circuit board 730, to the inside in the up/down direction of the container 700 in the attachment posture. In other words, the connecting surface 733 of the circuit board 730 at the second position is directed to the side of the liquid flow hole 720 (liquid supply opening side). It is therefore possible to insert the connector 761 into the space (the internal space of the board holder 732) provided between the connecting surface 733 of the circuit board 730 and the liquid flow hole 720 and electrically connect the electrical contact 762 of the connector 761 to the pad electrodes 731 of the circuit board 730. Hence, the electrical contact 762 of the connector 761 can be arranged on the surface of the connector 761 on the opposite side of the liquid flow hole 720. For this reason, even if the ink leaks from the liquid flow hole 720 at the time of attachment/detachment of the container 700, it is possible to reduce the possibility that the ink adheres to the electrical contact 762 of the connector 761.

When detaching the container 700 from the storage portion 4, the user moves the tray 703 that stores/supports the container 700 from the storage portion 4 in the −Y direction. The connection between the ink needle 760 of the storage portion 4 and the liquid flow hole 720 of the container 700 is thus canceled. The valve 722 of the container 700 moves in the +Y direction by the biasing force of the valve compression spring 721 and abuts against the joint seal 723, thereby closing the liquid flow hole 720. Also, the electrical connection between the connector 761 of the storage portion 4 and the circuit board 730 of the container 700 is canceled. The engagement between the positioning pins 764 of the storage portion 4 and the positioning holes 715 of the container 700 is canceled, and the engagement between the mechanical ID receivers 765 of the storage portion 4 and the mechanical IDs 717 of the container 700 is canceled. Then, the engagement between the cam plate 763 of the storage portion 4 and the cam follower pin 745 of the container 700 is canceled. The opening/closing door 704 of the container 700 abuts against the retaining cover 744 by the biasing force of the opening/closing door compression spring 743 and is thus held at a predetermined height in the Z direction. In this way, the state returns to the state before the container 700 is attached to the storage portion 4. Thus, only in the state in which the container 700 is attached to the storage portion 4, the liquid flow hole 720 and the circuit board 730 are opened to the outside. For this reason, even if the ink leaks from the liquid flow hole 720 at the time of attachment/detachment of the container 700, it is possible to reduce the possibility that the ink adheres to the user's hand or the circuit board 730.

In the attachment structure of the container 700 according to this embodiment, as described above, the opening/closing door 704 moves downward when attaching the container 700 to the main body.

That is, when the cam plate 763 is inserted into the slot 714 formed in the spout 710, the cam follower pin 745 located at the distal end of the slot 714 is pressed downward along the cam plate 763.

Before attachment, the cam follower pin 745 is supported while being biased upward by the opening/closing door compression spring 743. The opening/closing door 704 that is integrated with the cam follower pin 745 moves downward interlocking with the motion of the cam follower pin 745.

Also, when the cam follower pin 745 is moving along the first surface (lower surface) 763a of the cam plate 763, the upward biasing force of the opening/closing door compression spring 743 is received by the whole cam plate 763 via the first surface (lower surface) 763a of the cam plate. At this time, since the cam plate 763 is inserted into the slot 714 but only guided, the play is large. Since the biasing force is received only by the cam plate 763, the side of the liquid storage portion 701 is never raised upward. It is therefore possible to effectively prevent a failure that the liquid storage portion 701 is raised upward and interferes with the attachment portion, and attachment is incomplete.

In the above-described sixth embodiment, the cam follower pin 745 that is a moving force receiving portion is integrated with the opening/closing door main body 740. However, the present disclosure is not limited to this. For example, a bearing such as a sliding bearing or a rolling bearing may be assembled as the moving force receiving portion to the opening/closing door main body 740. This can reduce the frictional force generated between the opening/closing door main body 740 and the cam plate 763.

In the above-described sixth embodiment, the cam plate 763 that is a moving force imparting portion and the cam follower pin 745 that is a moving force receiving portion form a cam mechanism. However, the present disclosure is not limited to this. For example, as the cam mechanism, a cam groove may be formed in the opening/closing door main body 740, and a cam follower may be provided on the storage portion 4. In place of a mechanism using a force generated when attaching the container 700 to the storage portion 4, a driving device that directly drives the opening/closing door 704 may be provided. Note that the driving device may be a pneumatic driving device or an electric driving device.

In a configuration in which the container 700 according to this embodiment is attached to the storage portion 4 in the form exemplified in FIG. 38, the length and installation position of a partition plate 44a are designed sufficiently considering the moving range and the operation locus of the opening/closing door 704 of the container 700 of the upper stage. An end portion (front guide) 44b of the partition plate 44a in the Y direction is designed in such a dimensional relationship that the end portion 44b does not physically interfere with the opening/closing door 704 even when the container 700 is attached to the storage portion 4 and the opening/closing door 704 accordingly moves to the second position. More specifically, the position of the end portion 44b of the partition plate 44a is designed such that it does not interfere with the operation locus of the outer shape of the opening/closing door main body 740 in the rotational movement of the opening/closing door 704 about the rotation shaft 747 shown in FIG. 55.

Also, in a state in which the container 700 is stored in the storage portion 4 of the upper stage, the electrical contact 762 of the connector 761 of the upper stage, which is provided at the distal end of the container 700 in the +Y direction, is located on the far side with respect to the end portion 44b and also located on the lower side (−Z direction) of the partition plate 44a. It is therefore possible to stably perform electrical connection at a predetermined position without interference of the electrical contact 762 with the partition plate 44a.

With this configuration, in addition to interference avoidance between the members, it is possible to effectively implement structural stabilization or position stabilization of the container 700 without increasing the size of the entire apparatus in the height direction (Z direction).

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-157736, filed Sep. 11, 2024, and No. 2025-104036, filed Jun. 19, 2025, which are hereby incorporated by reference herein in their entirety.

What is claimed is:

1. A printing apparatus comprising:
a first storage portion configured to store a first container that stores a liquid to be supplied to a printhead that discharges the liquid to a print medium;
a second storage portion configured to store a second container that stores a liquid to be supplied to the printhead;
a first intermediate tank configured to, between the printhead and the first container, store the liquid to be supplied from the first container to the printhead; and
a second intermediate tank configured to, between the printhead and the second container, store the liquid to be supplied from the second container to the printhead,
wherein the first storage portion and the second storage portion are arranged in a height direction of the printing apparatus,
the first intermediate tank and the second intermediate tank are arranged in a first direction crossing the height direction, and
the first storage portion and the second storage portion, and the first intermediate tank and the second intermediate tank are arranged in a second direction crossing the height direction and the first direction.

2. The printing apparatus according to claim 1, wherein
the first direction is a widthwise direction of the printing apparatus, and
the second direction is a depth direction of the printing apparatus.

3. The printing apparatus according to claim 2, wherein
the first storage portion and the second storage portion are arranged in the depth direction on a front side of the first intermediate tank and the second intermediate tank.

4. The printing apparatus according to claim 3, wherein
the first storage portion includes a first inlet through which the first container can be detachably attached to the first storage portion in the depth direction, and
the second storage portion includes a second inlet through which the second container can be detachably attached to the second storage portion in the depth direction.

5. The printing apparatus according to claim 2, wherein
the first storage portion and the second storage portion are arranged in a first width range in the widthwise direction,
the first intermediate tank and the second intermediate tank are arranged in a second width range in the widthwise direction, and
at least a part of the second width range overlaps the first width range.

6. The printing apparatus according to claim 2, wherein
the first storage portion and the second storage portion are arranged in a first height range in the height direction,
the first intermediate tank and the second intermediate tank are arranged in a second height range in the height direction, and
at least a part of the second height range overlaps the first height range.

7. The printing apparatus according to claim 1, wherein
each of the first container and the second container is a bag-shaped container having flexibility,
the first container is stored in the first storage portion with being supported by a first tray, and
the second container is stored in the second storage portion with being supported by a second tray.

8. The printing apparatus according to claim 7, wherein
the first tray can be detachably attached to the first storage portion,
the second tray can be detachably attached to the second storage portion,
the first storage portion includes a first engaging portion configured to engage with the first tray, and
the second storage portion includes a second engaging portion configured to engage with the second tray.

9. The printing apparatus according to claim 3, wherein
each of the first container and the second container is a bag-shaped container having flexibility,
the first container is stored in the first storage portion with being supported by a first tray, and
the second container is stored in the second storage portion with supported by a second tray,
the first tray can be detachably attached to the first storage portion in the depth direction,
the second tray can be detachably attached to the second storage portion in the depth direction,
the first storage portion includes:
a first groove portion located on one side of the first tray in the widthwise direction and extended in the depth direction; and
a second groove portion located on the other side of the first tray in the widthwise direction and extended in the depth direction,
the first tray includes:
a first convex portion configured to engage with the first groove portion; and
a second convex portion configured to engage with the second groove portion,
the second storage portion includes:
a third groove portion located on one side of the second tray in the widthwise direction and extended in the depth direction; and
a fourth groove portion located on the other side of the second tray in the widthwise direction and extended in the depth direction, and
the second tray includes:
a third convex portion configured to engage with the third groove portion; and
a fourth convex portion configured to engage with the fourth groove portion.

10. The printing apparatus according to claim 3, wherein
the first container can be detachably attached to the first storage portion in the depth direction,
the second container can be detachably attached to the second storage portion in the depth direction,
the first storage portion includes a first engaging portion configured to engage with the first container, and
the second storage portion includes a second engaging portion configured to engage with the second container.

11. The printing apparatus according to claim 3, wherein
the first container can be detachably attached to the first storage portion in the depth direction,
the second container can be detachably attached to the second storage portion in the depth direction,
the first storage portion includes:
a first groove portion located on one side of the first container in the widthwise direction and extended in the depth direction; and
a second groove portion located on the other side of the first container in the widthwise direction and extended in the depth direction,
the first container includes:
a first convex portion configured to engage with the first groove portion; and
a second convex portion configured to engage with the second groove portion,
the second storage portion includes:
a third groove portion located on one side of the second container in the widthwise direction and extended in the depth direction; and
a fourth groove portion located on the other side of the second container in the widthwise direction and extended in the depth direction, and
the second container includes:
a third convex portion configured to engage with the third groove portion; and
a fourth convex portion configured to engage with the fourth groove portion.

12. The printing apparatus according to claim 1, wherein
each of the first intermediate tank and the second intermediate tank comprises:
a liquid chamber configured to store the liquid;
a pressure chamber adjacent to the liquid chamber; and
a wall member configured to partition between the liquid chamber and the pressure chamber and change a capacity of the liquid chamber by being displaced in accordance with a pressure in the pressure chamber.

13. The printing apparatus according to claim 12, further comprising a pressure adjusting unit configured to adjust the pressure in the pressure chamber.

14. A printing apparatus comprising:
a storage unit including a plurality of storage portions each configured to store a container that stores a liquid to be supplied to a printhead that discharges the liquid to a print medium; and
a plurality of intermediate tanks each provided in correspondence with one of the storage portions and configured to, between the printhead and the container, store the liquid to be supplied from the container to the printhead,
wherein the plurality of storage portions are arranged in a plurality of stages in a height direction of the printing apparatus,
the plurality of intermediate tanks are arranged in a first direction crossing the height direction, and
the storage unit and the plurality of intermediate tanks are arranged in a second direction crossing the height direction and the first direction.

15. The printing apparatus according to claim 1, wherein
the first container includes a third connecting portion connected to a first connecting portion provided in the first storage portion,
the second container includes a fourth connecting portion connected to a second connecting portion provided in the second storage portion,
each of the third connecting portion and the fourth connecting portion includes a projecting portion projecting downward,
an electrical connecting portion is provided on the projecting portion, and
for each of the third connecting portion and the fourth connecting portion, a concave portion is formed in an upper portion of the electrical connecting portion.

16. The printing apparatus according to claim 15, wherein
the first storage portion is arranged on an upper side of the second storage portion, and
the projecting portion of the first container is fitted in the concave portion of the second container.

17. The printing apparatus according to claim 1, wherein the first container includes a third connecting portion configured to be connected to a first connecting portion provided in the first storage portion,
the second container includes a fourth connecting portion configured to be connected to a second connecting portion provided in the second storage portion,
each of the third connecting portion and fourth connecting portion includes: a communicating portion configured to allow a liquid in a container to flow through; and an electrical connecting portion, and
for each of the third connecting portion and the fourth connecting portion, when a distance between a center of the communicating portion and a lower surface of the electrical connecting portion is referred to as z1, and a distance between a center of the communicating portion and an upper surface located above the electrical connecting portion is referred to as z2, a relationship of z1>z2 is satisfied.

18. The printing apparatus according to claim 17, wherein the first storage portion is located on a upper side of the second storage portion, and
when a distance between a lower surface of the electrical connecting portion of the third connecting portion and a center of the communicating portion of the fourth connecting portion is referred to as z3, a relationship of z1>z3>z2 is satisfied.
